(19) United States
(12) Patent Application Publication
(10) Pub. No.: US 2024/0354553 A1
(43) Pub. Date: Oct. 24, 2024

(54) METHOD AND DATA PROCESSING SYSTEM FOR LOSSY IMAGE OR VIDEO ENCODING, TRANSMISSION AND DECODING

(71) Applicant: DEEP RENDER LTD, London (GB)

(72) Inventors: Chris FINLAY, London (GB); Jan XU, London (GB); Christiain BESENBRUCH, London (GB); Arsalan ZAFAR, London (GB)

(21) Appl. No.: 18/294,785

(22) PCT Filed: Aug. 3, 2022
(86) PCT No.: PCT/EP2022/071858

§ 371 Date: Feb. 2, 2024

(30) Foreign Application Priority Data
Aug. 3, 2021 (GB) 2111188.5

(51) Int. Cl. G06N 3/0455; G06N 3/08; G06T 5/20; H04N 19/119; H04N 19/182; H04N 19/91

(52) U.S. Cl. CPC G06N 3/0455; G06N 3/08; G06T 5/20; H04N 19/119; H04N 19/182; H04N 19/91

(57) ABSTRACT

A method for lossy image and video encoding, transmission and decoding, the method comprising the steps of: receiving an input image at a first computer system; encoding the input image using a first trained neural network to produce a latent representation; performing a quantization process on the latent representation to produce a quantized latent, wherein the sizes of the bins used in the quantization process are based on the input image; transmitting the quantized latent to a second computer system; decoding the quantized latent using a second trained neural network to produce an output image, wherein the output image is an approximation of the input image.

This invention relates to a method and system for lossy image or video encoding, transmission and decoding, a method, apparatus, computer program and computer readable storage medium for lossy image or video encoding and transmission, and a method, apparatus, computer program and computer readable storage medium for lossy image or video receipt and decoding.

There is increasing demand from users of communications networks for images and video content. Demand is increasing not just for the number of images viewed, and for the playing time of video; demand is also increasing for higher resolution content. This places increasing demand on communications networks and increases their energy use because of the larger amount of data being transmitted.

To reduce the impact of these issues, image and video content is compressed for transmission across the network. The compression of image and video content can be lossless or lossy compression. In lossless compression, the image or video is compressed such that all of the original information in the content can be recovered on decompression. However, when using lossless compression there is a limit to the reduction in data quantity that can be achieved. In lossy compression, some information is lost from the image or video during the compression process. Known compression techniques attempt to minimise the apparent loss of information by the removal of information that results in changes to the decompressed image or video that is not particularly noticeable to the human visual system.

Artificial intelligence (AI) based compression techniques achieve compression and decompression of images and videos through the use of trained neural networks in the compression and decompression process. Typically, during training of the neutral networks, the difference between the original image and video and the compressed and decompressed image and video is analyzed and the parameters of the neural networks are modified to reduce this difference while minimizing the data required to transmit the content. However, AI based compression methods may achieve poor compression results in terms of the appearance of the compressed image or video or the amount of information required to be transmitted.

According to the present invention there is provided a method for lossy image and video encoding, transmission and decoding, the method comprising the steps of: receiving an input image at a first computer system; encoding the input image using a first trained neural network to produce a latent representation; performing a quantization process on the latent representation to produce a quantized latent, wherein the sizes of the bins used in the quantization process are based on the input image; transmitting the quantized latent to a second computer system; decoding the quantized latent using a second trained neural network to produce an output image, wherein the output image is an approximation of the input image.

The sizes of the bins may be different between at least two of the pixels of the latent representation.

The sizes of the bins may be different between at least two channels of the latent representation.

A bin size may be assigned to each pixel of the latent representation.

The quantisation process may comprise performing an operation on the value of each pixel of the latent representation corresponding to the bin size assigned to that pixel.

The quantisation process may comprise subtracting a mean value of the latent representation from each pixel of the latent representation.

The quantisation process may comprise a rounding function.

The sizes of the bins used to decode the quantized latent may be based on previously decoded pixels of the quantized latent.

The quantisation process may comprise a third trained neural network.

The third trained neural network may receive at least one previously decoded pixel of the quantized latent as an input.

The method may further comprising the steps of: encoding the latent representation using a fourth trained neural network to produce a hyper-latent representation; performing a quantization process on the hyper-latent representation to produce a quantized hyper-latent; transmitting the quantized hyper-latent to the second computer system; and decoding the quantized hyper-latent using a fifth trained neural network to obtain the sizes of the bins; wherein the decoding of the quantized latent uses the obtained sizes of the bins.

The output of the fifth trained neural network may be processed by a further function to obtain the sizes of the bins.

The further function may be a sixth trained neural network.

The sizes of the bins used in the quantization process of the hyper-latent representation may be based on the input image.

The method may further comprise the step of identifying at least one region of interest of the input image; and reducing the size of the bins used in the quantisation process for at least one corresponding pixel of the latent representation in the identified region of interest.

The method may further comprise the step of identifying at least one region of interest of the input image; wherein a different quantisation process is used for at least one corresponding pixel of the latent representation in the identified region of interest.

The at least on region of interest may be identified by a seventh trained neural network.

The location of the one or more regions of interest may be stored in a binary mask; and the binary mask may be used to obtain the sizes of the bins.

According to the present invention there is provided a method of training one or more neural networks, the one or more neural networks being for use in lossy image or video encoding, transmission and decoding, the method comprising the steps of: receiving an input image at a first computer system; encoding the input image using a first neural network to produce a latent representation; performing a quantization process on the latent representation to produce a quantized latent, wherein the sizes of the bins used in the quantization process are based on the input image; decoding the quantized latent using a second neural network to produce an output image, wherein the output image is an approximation of the input image; determining a quantity based on a difference between the output image and the input image; updating the parameters of the first neural network and the second neural network based on the determined quantity; and repeating the above steps using a first set of input images to produce a first trained neural network and a second trained neural network.

The method may further comprise the steps of: encoding the latent representation using a third neural network to produce a hyper-latent representation; performing a quantization process on the hyper-latent representation to produce a quantized hyper-latent; transmitting the quantized hyper-latent to the second computer system; and decoding the quantized hyper-latent using a fourth neural network to obtain the sizes of the bins; wherein the decoding of the quantized latent uses the obtained bin sizes; and the parameters of the third neural network and the fourth neural network are additionally updated based on the determined quantity to obtain a third trained neural network and a fourth trained neural network.

The quantisation process may comprise a first quantisation approximation.

The determined quantity may be additionally based on a rate associated with the quantized latent; a second quantisation approximation may be used to determine the rate associated with the quantized latent; and the second quantisation approximation may be different to the first quantisation approximation.

The determined quantity may comprise a loss function and the step of updating of the parameters of the neural networks may comprise the steps of: evaluating a gradient of the loss function; and back-propagating the gradient of the loss function through the neural networks; wherein a third quantisation approximation is used during back-propagation of the gradient of the loss function; and the third quantisation approximation is the same approximation as the first quantisation approximation.

The parameters of the neural networks may be additionally updated based on a distribution of the sizes of the bins.

At least one parameter of the distribution may be learned.

The distribution may be an inverse gamma distribution.

The distribution may be determined by a fifth neural network.

According to the present invention there is provided a method for lossy image or video encoding and transmission, the method comprising the steps of: receiving an input image at a first computer system; encoding the input image using a first trained neural network to produce a latent representation; performing a quantization process on the latent representation to produce a quantized latent, wherein the sizes of the bins used in the quantization process are based on the input image; and transmitting the quantized latent.

According to the present invention there is provided a method for lossy image or video receipt and decoding, the method comprising the steps of: receiving the quantized latent transmitted according to the method above at a second computer system; decoding the quantized latent using a second trained neural network to produce an output image, wherein the output image is an approximation of the input image.

According to the present invention there is provided a method of training one or more neural networks, the one or more neural networks being for use in lossy image or video encoding, transmission and decoding, the method comprising the steps of: receiving an input image at a first computer system; encoding the input image using a first neural network to produce a latent representation; performing a quantization process on the latent representation to produce a quantized latent; decoding the quantized latent using a second neural network to produce an output image, wherein the output image is an approximation of the input image; determining a quantity based on a difference between the output image and the input image; updating the parameters of the first neural network and the second neural network based on the determined quantity; and repeating the above steps using a plurality of sets of input images to produce a first trained neural network and a second trained neural network; wherein at least one of the plurality of sets of input images comprises a first proportion of images including a particular feature; and at least one other of the plurality of sets of input images comprises a second proportion of images including the particular feature, wherein the second proportion is different to the first proportion.

The first proportion may be all of the images of the set of input images.

The particular feature may be of one of the following: a human face, an animal face, text, eyes, lips, a logo, a car, flowers and a pattern.

Each of the plurality of sets of input images may be used an equal number of times during the repetition of the method steps.

The difference between the output image and the input image may be at least partially determined by a neural network acting as a discriminator.

A separate neural network acting as a discriminator may be used for each set of the plurality of sets of input images.

The parameters of one or more of the neural networks acting as discriminators may be updated for a first number of training steps; and one or more other of the neural networks acting as discriminators may be updated for a second number of training steps, wherein the second number is lower than the first number.

The determined quantity may be additionally based on a rate associated with the quantized latent; the updating of the parameters for at least one of the plurality of sets of input images may use a first weighting for the rate associated with the quantized latent; and the updating of the parameters for at least one other of the plurality of sets of input images may use a second weighting for the rate associated with the quantized latent, wherein the second weighting is different to the first weighting.

The difference between the output image and the input image may be at least partially determined using a plurality of perceptual metrics; the updating of the parameters for at least one of the plurality of sets of input images may use a first set of weightings for the plurality of perceptual metrics; and the updating of the parameters for at least one other of the plurality of sets of input images may use a second set of weightings for the plurality of perceptual metrics, wherein the second set of weightings is different to the first set of weightings.

The input image may be a modified image in which one or more regions of interest have been identified by a third trained neural network and other regions of the image have been masked.

The regions of interest may be regions comprising one or more of the following features: human faces, animal faces, text, eyes, lips, logos, cars, flowers and patterns.

The location of the areas of the one or more regions of interest may be stored in a binary mask.

The binary mask may be an additional input to the first neural network.

According to the present invention there is provided a method for lossy image and video encoding, transmission and decoding, the method comprising the steps of: receiving an input image at a first computer system; encoding the input image using a first trained neural network to produce a latent representation; performing a quantization process on the latent representation to produce a quantized latent; transmitting the quantized latent to a second computer system; and decoding the quantized latent using a second trained neural network to produce an output image, wherein the output image is an approximation of the input image; wherein the first trained neural network and the second trained neural network have been trained according to the method above.

According to the present invention there is provided a method for lossy image or video encoding and transmission, the method comprising the steps of: receiving an input image at a first computer system; encoding the input image using a first trained neural network to produce a latent representation; performing a quantization process on the latent representation to produce a quantized latent; and transmitting the quantized latent; wherein the first trained neural network has been trained according to the method above.

According to the present invention there is provided a method for lossy image or video receipt and decoding, the method comprising the steps of: receiving the quantized latent according to the method of claim 48 at a second computer system; and decoding the quantized latent using a second trained neural network to produce an output image, wherein the output image is an approximation of the input image; wherein the second trained neural network has been trained according to the method above.

According to the present invention there is provided a method of training one or more neural networks, the one or more neural networks being for use in lossy image or video encoding, transmission and decoding, the method comprising the steps of: receiving an input image at a first computer system; encoding the input image using a first neural network to produce a latent representation; performing a quantization process on the latent representation to produce a quantized latent; decoding the quantized latent using a second neural network to produce an output image, wherein the output image is an approximation of the input image; determining a quantity based on a rate associated with the quantized latent, wherein the evaluation of the rate comprises the step of interpolation of a discrete probability mass function; updating the parameters of the first neural network and the second neural network based on the determined quantity; and repeating the above steps using a plurality of sets of input images to produce a first trained neural network and a second trained neural network.

At least one parameter of the discrete probability mass function may be additionally updated based on the evaluated rate.

The method may further comprise the steps of: encoding the latent representation using a third neural network to produce a hyper-latent representation; performing a quantization process on the hyper-latent representation to produce a quantized hyper-latent; and decoding the quantized hyper-latent using a fourth neural network to obtain at least one parameter of the discrete probability mass function; wherein the parameters of the third neural network and the fourth neural network are additionally updated based on the determined quantity to obtain a third trained neural network and a fourth trained neural network.

The interpolation may comprise at least one of the following: piecewise constant interpolation, nearest neighbour interpolation, linear interpolation, polynomial interpolation, spline interpolation, piecewise cubic interpolation, gaussian processes and kriging.

The discrete probability mass function may be a categorical distribution.

The categorical distribution may be parameterized by at least one vector.

The categorical distribution may be obtained by a soft-max projection of the vector.

The discrete probability mass function may be parameterized by at least a mean parameter and a scale parameter.

The discrete probability mass function may be multivariate.

The discrete probability mass function may comprise a plurality of points; a first adjacent pair of points of the plurality of points may have a first spacing; and a second adjacent pair of points of the plurality of points may have a second spacing, wherein the second spacing is different to the first spacing.

The discrete probability mass function may comprises a plurality of points; a first adjacent pair of points of the plurality of points may have a first spacing; and a second adjacent pair of points of the plurality of points may have a second spacing, wherein the second spacing is equal to the first spacing.

At least one of the first spacing and the second spacing may be obtained using the fourth neural network.

At least one of the first spacing and the second spacing may be obtained based on the value of at least one pixel of the latent representation.

According to the present invention there is provided a method for lossy image and video encoding, transmission and decoding, the method comprising the steps of: receiving an input image at a first computer system; encoding the input image using a first trained neural network to produce a latent representation; performing a quantization process on the latent representation to produce a quantized latent; transmitting the quantized latent to a second computer system; and decoding the quantized latent using a second trained neural network to produce an output image, wherein the output image is an approximation of the input image; wherein the first trained neural network and the second trained neural network have been trained according to the method above.

According to the present invention there is provided a method for lossy image or video encoding and transmission, the method comprising the steps of: receiving an input image at a first computer system; encoding the input image using a first trained neural network to produce a latent representation; performing a quantization process on the latent representation to produce a quantized latent; and transmitting the quantized latent; wherein the first trained neural network has been trained according to the method above.

According to the present invention there is provided a method for lossy image or video receipt and decoding, the method comprising the steps of: receiving the quantized latent according to the method above at a second computer system; and decoding the quantized latent using a second trained neural network to produce an output image, wherein the output image is an approximation of the input image; wherein the second trained neural network has been trained according to the method above.

According to the present invention there is provided a method for lossy image and video encoding, transmission and decoding, the method comprising the steps of: receiving an input image at a first computer system; encoding the input image using a first trained neural network to produce a latent representation; performing a first operation on the latent representation to obtain a residual latent; transmitting the residual latent to a second computer system; performing a second operation on the latent residual to obtain a retrieved latent representation, wherein the second operation comprises performing an operation on previously obtained pixels of the retrieved latent; and decoding the retrieved latent representation using a second trained neural network to produce an output image, wherein the output image is an approximation of the input image.

The operation on previously obtained pixels of the retrieved latent may be performed for each pixel of the retrieved latent for which previously obtained pixels have been obtained.

At least one of the first operation and the second operation may comprise the solving of an implicit equation system.

The first operation may comprise a quantisation operation.

The operation performed on previously obtained pixels of the retrieved latent may comprise a matrix operation.

The matrix defining the matrix operation may be sparse.

The matrix defining the matrix operation may have zero values corresponding to pixels of the retrieved latent that have not been obtained when the matrix operation is performed.

The matrix defining the matrix operation may be lower triangular.

The second operation may comprise a standard forward substitution.

The operation performed on previously obtained pixels of the retrieved latent may comprise a third trained neural network.

The method may further comprise the steps of: encoding the latent representation using a fourth trained neural network to produce a hyper-latent representation; transmitting the quantized hyper-latent to the second computer system; and decoding the quantized hyper-latent using a fifth trained neural network, wherein the operation performed on previously obtained pixels of the retrieved latent is based on the output of the fifth trained neural network.

The decoding of the quantized hyper-latent using the fifth trained neural network may additionally produces a mean parameter; and the implicit equation system may additionally comprise the mean parameter.

According to the present invention there is provided a method of training one or more neural networks, the one or more neural networks being for use in lossy image or video encoding, transmission and decoding, the method comprising the steps of: receiving an input image at a first computer system; encoding the input image using a first neural network to produce a latent representation; performing a first operation on the latent representation to obtain a residual latent; performing a second operation on the latent residual to obtain a retrieved latent representation, wherein the second operation comprises performing an operation on previously obtained pixels of the retrieved latent; decoding the quantized latent using a second neural network to produce an output image, wherein the output image is an approximation of the input image; determining a quantity based on a difference between the output image and the input image; updating the parameters of the first neural network and the second neural network based on the determined quantity; and repeating the above steps using a first set of input images to produce a first trained neural network and a second trained neural network.

The operation performed on previously obtained pixels of the retrieved latent may comprise a matrix operation.

The parameters of a matrix defining the matrix operation may be additionally updated based on the determined quantity.

The operation performed on previously obtained pixels of the retrieved latent may comprise a third neural network; and the parameters of the third neural network may be additionally updated based on the determined quantity to produce a third trained neural network.

The method may further comprise the steps of: encoding the latent representation using a fourth neural network to produce a hyper-latent representation; performing a quantization process on the hyper-latent representation to produce a quantized hyper-latent; transmitting the quantized hyper-latent to the second computer system; and decoding the quantized hyper-latent using a fifth neural network, wherein the operation performed on previously obtained pixels of the retrieved latent is based on the output of the fifth trained neural network; wherein the parameters of the fourth neural network and the fifth neural network are additionally updated based on the determined quantity to produce a fourth trained neural network and a fifth trained neural network.

According to the present invention there is provided a method for lossy image or video encoding and transmission, the method comprising the steps of: receiving an input image at a first computer system; encoding the input image using a first trained neural network to produce a latent representation; performing a first operation on the latent representation to obtain a residual latent; transmitting the residual latent.

According to the present invention there is provided a method for lossy image or video receipt and decoding, the method comprising the steps of: receiving the residual latent transmitted according to the method above at a second computer system; performing a second operation on the latent residual to obtain a retrieved latent representation, wherein the second operation comprises performing an operation on previously obtained pixels of the retrieved latent; and decoding the retrieved latent representation using a second trained neural network to produce an output image, wherein the output image is an approximation of the input image.

According to the present invention there is provided a method of training one or more neural networks, the one or more neural networks being for use in lossy image or video encoding, transmission and decoding, the method comprising the steps of: receiving an input image at a first computer system; encoding the input image using a first neural network to produce a latent representation; entropy encoding the latent representation; transmitting the entropy encoded latent representation to a second computer system; entropy decoding the entropy encoded latent representation; and decoding the latent representation using a second neural network to produce an output image, wherein the output image is an approximation of the input image; determining a quantity based on a difference between the output image and the input image; updating the parameters of the first neural network and the second neural network based on the determined quantity; and repeating the above steps using a first set of input images to produce a first trained neural network and a second trained neural network; wherein the entropy decoding of the entropy encoded latent representation is performed pixel by pixel; and the order of the pixel by pixel decoding is additionally updated based on the determined quantity.

The order of the pixel by pixel decoding may be based on the latent representation.

The entropy decoding of the entropy encoded latent may comprise an operation based on previously decoded pixels.

The determining of the order of the pixel by pixel decoding may comprise ordering a plurality of the pixels of the latent representation in a directed acyclic graph.

The determining of the order of the pixel by pixel decoding may comprise operating on the latent representation with a plurality of adjacency matrices.

The determining of the order of the pixel by pixel decoding may comprise dividing the latent representation into a plurality of sub-images.

The plurality of sub-images may be obtained by convolving the latent representation with a plurality of binary mask kernels.

The determining of the order of the pixel by pixel decoding may comprise ranking a plurality of pixels of the latent representation based on the magnitude of a quantity associated with each pixel.

The quantity associated with each pixel may be the location or scale parameter associated with that pixel.

The quantity associated with each pixel may be additionally updated based on the evaluated difference.

The determining of the order of the pixel by pixel decoding may comprise a wavelet decomposition of a plurality of pixels of the latent representation.

The order of the pixel by pixel decoding may be based on the frequency components of the wavelet decomposition associated with the plurality of pixels.

The method may further comprise the steps of: encoding the latent representation using a fourth trained neural network to produce a hyper-latent representation; transmitting the hyper-latent to the second computer system; and decoding the hyper-latent using a fifth trained neural network, wherein the order of the pixel by pixel decoding is based on the output of the fifth trained neural network.

According to the present invention there is provided a method for lossy image and video encoding, transmission and decoding, the method comprising the steps of: receiving an input image at a first computer system; encoding the input image using a first trained neural network to produce a latent representation; entropy encoding the latent representation; transmitting the entropy encoded latent representation to a second computer system; entropy decoding the entropy encoded latent representation; and decoding the latent representation using a second trained neural network to produce an output image, wherein the output image is an approximation of the input image; wherein the first trained neural network and the second trained neural network have been trained according to the method above.

According to the present invention there is provided a method for lossy image or video encoding and transmission, the method comprising the steps of: receiving an input image at a first computer system; encoding the input image using a first trained neural network to produce a latent representation; entropy encoding the latent representation; and transmitting the entropy encoded latent representation; wherein the first trained neural network has been trained according to the method above.

According to the present invention there is provided a method for lossy image or video receipt and decoding, the method comprising the steps of: receiving the entropy encoded latent representation transmitted according to the method of above at a second computer system; and decoding the latent representation using a second trained neural network to produce an output image, wherein the output image is an approximation of the input image; wherein the second trained neural network has been trained according to the method above.

According to the present invention there is provided a method of training one or more neural networks, the one or more neural networks being for use in lossy image or video encoding, transmission and decoding, the method comprising the steps of: receiving an input image at a first computer system; encoding the input image using a first neural network to produce a latent representation; decoding the latent representation using a second neural network to produce an output image, wherein the output image is an approximation of the input image; determining a quantity based on a difference between the output image and the input image and a rate associated with the latent representation, wherein a first weighting is applied to the difference between the output image and the input image and a second weighting is applied to the rate associated with the latent representation when determining the quantity; updating the parameters of the first neural network and the second neural network based on the determined quantity; and repeating the above steps using a first set of input images to produce a first trained neural network and a second trained neural network; wherein, after at least one of the repeats of the above steps, at least one of the first weighting and the second weighting is additionally updated based on a further quantity, the further quantity based on at least one of the difference between the output image and the input image and the rate associated with the latent representation.

At least one of the difference between the output image and the input image and the rate associated with the latent representation may be recorded for each repeat of the steps; and the further quantity may be based on at least one of a plurality of the previously recorded differences between the output image and the input image and a plurality of the previously recorded rates associated with the latent representation.

The further quantity may be based on an average of the plurality of the previously recorded differences or rates.

The average may be at least one of the following: the arithmetic mean, the median, the geometric mean, the harmonic mean, the exponential moving average, the smoothed moving average and the linear weighted moving average.

Outlier values may be removed from the plurality of the previously recorded differences or rates before determining the further quantity.

The outlier values may only be removed for an initial predetermined number of repeats of the steps.

The rate associated with the latent representation may be calculated using a first method when determining the quantity and a second method when determining the further quantity, wherein the first method is different to the second method.

At least one repeat of the steps may be performed using an input image from a second set of input images; and the parameters of the first neural network and the second neural network may not be updated when an input image from a second set of input images is used.

The determined quantity may be additionally based on the output of a neural network acting as a discriminator.

According to the present invention there is provided a method of training one or more neural networks, the one or more neural networks being for use in lossy video encoding, transmission and decoding, the method comprising the steps of: receiving an input video at a first computer system; encoding a plurality of frames of the input video using a first neural network to produce a plurality of latent representations; decoding the plurality of latent representations using a second neural network to produce a plurality of frames of an output video, wherein the output video is an approximation of the input video; determining a quantity based on a difference between the output video and the input video and a rate associated with the plurality of latent representations, wherein a first weighting is applied to the difference between the output video and the input video and a second weighting is applied to the rate associated with the plurality of latent representations; updating the parameters of the first neural network and the second neural network based on the determined quantity; and repeating the above steps using a plurality of input videos to produce a first trained neural network and a second trained neural network; wherein, after at least one of the repeats of the above steps, at least one of the first weighting and the second weighting is additionally updated based on a further quantity, the further quantity based on at least one of the difference between the output video and the input video and the rate associated with the plurality of latent representations.

The input video may comprise at least one I-frame and a plurality of P-frames.

The quantity may be based on a plurality of first weightings or second weightings, each of the weightings corresponding to one of the plurality of frames of the input video.

After at least one of the repeats of the steps, at least one of the plurality of weightings may be additionally updated based on an additional quantity associated with each weighting.

Each additional quantity may be based on a predetermined target value of the difference between the output frame and the input frame or the rate associated with the latent representation.

The additional quantity associated with the I-frame may have a first target value and at least one additional quantity associated with a P-frame may have a second target value, wherein the second target value is different to the first target value.

Each additional quantity associated with a P-frame may have the same target value.

The plurality of first weightings or second weightings may be initially set to zero.

According to the present invention there is provided a method for lossy image and video encoding, transmission and decoding, the method comprising the steps of: receiving an input image at a first computer system; encoding the input image using a first trained neural network to produce a latent representation; performing a quantization process on the latent representation to produce a quantized latent; transmitting the quantized latent to a second computer system; and decoding the quantized latent using a second trained neural network to produce an output image, wherein the output image is an approximation of the input image; wherein the first trained neural network and the second trained neural network have been trained according to the method above.

According to the present invention there is provided a method for lossy image or video encoding and transmission, the method comprising the steps of: receiving an input image or video at a first computer system; encoding the input image or video using a first trained neural network to produce a latent representation; and transmitting the latent representation; wherein the first trained neural network has been trained according to the method above.

According to the present invention there is provided a method for lossy image or video receipt and decoding, the method comprising the steps of: receiving the latent representation according to the method of above at a second computer system; and decoding the latent representation using a second trained neural network to produce an output image or video, wherein the output image or video is an approximation of the input image or video; wherein the second trained neural network has been trained according to the method above.

According to the present invention there is provided a method for lossy image or video encoding, transmission and decoding, the method comprising the steps of: receiving an input image at a first computer system; encoding the input image using a first trained neural network to produce a latent representation; performing a quantization process on the latent representation to produce a quantized latent; entropy encoding the quantized latent using a probability distribution, wherein the probability distribution is defined using a tensor network; transmitting the entropy encoded quantized latent to a second computer system; entropy decoding the entropy encoded quantized latent using the probability distribution to retrieve the quantized latent; and decoding the quantized latent using a second trained neural network to produce an output image, wherein the output image is an approximation of the input image.

The probability distribution may be defined by a Hermitian operator operating on the quantized latent, wherein the Hermitian operator is defined by the tensor network.

The tensor network may comprise a non-orthonormal core tensor and one or more orthonormal tensors.

The method may further comprise the steps of: encoding the latent representation using a third trained neural network to produce a hyper-latent representation; performing a quantization process on the hyper-latent representation to produce a quantized hyper-latent; transmitting the quantized hyper-latent to the second computer system; and decoding the quantized hyper-latent using a fourth trained neural network; wherein the output of the fourth trained neural network is one or more parameters of the tensor network.

The tensor network may comprise a non-orthonormal core tensor and one or more orthonormal tensors; and the output of the fourth trained neural network may be one or more parameters of the non-orthonormal core tensor.

One or more parameters of the tensor network may be calculated using one or more pixels of the latent representation.

The probability distribution may be associated with a sub-set of the pixels of the latent representation.

The probability distribution may be associated with a channel of the latent representation.

The tensor network may be at least one of the following factorisations: Tensor Tree, Locally Purified State, Born Machine, Matrix Product State and Projected Entangled Pair State.

According to the present invention there is provided a method of training one or more networks, the one or more networks being for use in lossy image or video encoding, transmission and decoding, the method comprising the steps of: receiving a first input image; encoding the first input image using a first neural network to produce a latent representation; performing a quantization process on the latent representation to produce a quantized latent; entropy encoding the quantized latent using a probability distribution, wherein the probability distribution is defined using a tensor network; entropy decoding the entropy encoded quantized latent using the probability distribution to retrieve the quantized latent; decoding the quantized latent using a second neural network to produce an output image, wherein the output image is an approximation of the input image; determining a quantity based on a difference between the output image and the input image; updating the parameters of the first neural network and the second neural network based on the determined quantity; and repeating the above steps using a plurality of input images to produce a first trained neural network and a second trained neural network.

One or more of the parameters of the tensor network may be additionally updated based on the determined quantity.

The tensor network may comprise a non-orthonormal core tensor and one or more orthonormal tensors; and the parameters of all of the tensors of the tensor network except for the non-orthonormal core tensor may be updated based on the determined quantity.

The tensor network may be calculated using the latent representation.

The tensor network may be calculated based on a linear interpolation of the latent representation.

The determined quantity may be additionally based on the entropy of the tensor network.

According to the present invention there is provided a method for lossy image or video encoding and transmission, the method comprising the steps of: receiving an input image at a first computer system; encoding the input image using a first trained neural network to produce a latent representation; performing a quantization process on the latent representation to produce a quantized latent; entropy encoding the quantized latent using a probability distribution, wherein the probability distribution is defined using a tensor network; and transmitting the entropy encoded quantized latent.

According to the present invention there is provided a method for lossy image or video receipt and decoding, the method comprising the steps of: receiving an entropy encoded quantized latent transmitted according to the method above at a second computer system; entropy decoding the entropy encoded quantized latent using the probability distribution to retrieve the quantized latent; and decoding the quantized latent using a second trained neural network to produce an output image, wherein the output image is an approximation of the input image.

According to the present invention there is provided method for lossy image and video encoding, transmission and decoding, the method comprising the steps of: receiving an input image at a first computer system; encoding the input image using a first trained neural network to produce a latent representation; encoding the latent representation using a second trained neural network to produce a hyperlatent representation; encoding the hyperlatent representation using a third trained neural network to produce a hyperhyperlatent representation; transmitting the latent, hyperlatent and hyperhyperlatent representation to a second computer system; decoding the hyperhyperlatent representation using a fourth trained neural network; decoding the hyperlatent representation using the output of the fourth trained neural network and a fifth trained neural network; and decoding the latent representation using the output of the fifth trained neural network and a sixth trained neural network to produce an output image, wherein the output image is an approximation of the input image.

The method may further comprising the steps of determining the rate of the input image; wherein, if the determined rate satisfies a predetermined condition, the step of encoding the hyperlatent representation and decoding the hyperhyperlatent representation is not performed.

The predetermined condition may be that the rate is less than a predetermined value.

According to the present invention there is provided method of training one or more networks, the one or more networks being for use in lossy image or video encoding, transmission and decoding, the method comprising the steps of: receiving an input image at a first computer system; encoding the input image using a first neural network to produce a latent representation; encoding the latent representation using a second neural network to produce a hyperlatent representation; encoding the hyperlatent representation using a third neural network to produce a hyperhyperlatent representation; decoding the hyperhyperlatent representation using a fourth neural network; decoding the hyperlatent representation using the output of the fourth neural network and a fifth neural network; and decoding the latent representation using the output of the fifth neural network and a sixth neural network to produce an output image, wherein the output image is an approximation of the input image; determining a quantity based on a difference between the output image and the input image; updating the parameters of the third and fourth neural networks based on the determined quantity; and repeating the above steps using a plurality of input images to produce a third and fourth trained neural network.

The parameters of the first, second, fifth and sixth neural network may not be updated in at least one of the repeats of the steps.

The method may further comprise the step of determining the rate of the input image; wherein, if the determined rate satisfies a predetermined condition, the parameters of the first, second, fifth and sixth neural network are not updated in that repeat of the steps.

The predetermined condition may be that the rate is less than a predetermined value.

The parameters of the first, second, fifth and sixth neural network may not be updated after a predetermined number of repeats of the steps.

The parameters of the first, second, fifth and sixth neural network may additionally be updated based on the determined quantity to produce a first, second, fifth and sixth trained neural network.

At least one of the following operations may be performed on at least one of the plurality of input images before performing the other steps: an upsampling, a smoothing filter and a random crop.

According to the present invention there is provided method for lossy image or video encoding and transmission, the method comprising the steps of: receiving an input image at a first computer system; encoding the input image using a first trained neural network to produce a latent representation; encoding the latent representation using a second trained neural network to produce a hyperlatent representation; encoding the hyperlatent representation using a third trained neural network to produce a hyperhyperlatent representation; transmitting the latent, hyperlatent and hyperhyperlatent representation.

According to the present invention there is provided method for lossy image or video receipt and decoding, the method comprising the steps of: receiving the latent, hyperlatent and hyperhyperlatent representation transmitted according to the method above at a second computer system; decoding the hyperhyperlatent representation using a fourth trained neural network; decoding the hyperlatent representation using the output of the fourth trained neural network and a fifth trained neural network; and decoding the latent representation using the output of the fifth trained neural network and a sixth trained neural network to produce an output image, wherein the output image is an approximation of the input image.

According to the present invention there is provided a data processing system configured to perform any of the methods above.

According to the present invention there is provided a data processing apparatus configured to perform any of the methods above.

According to the present invention there is provided a computer program comprising instructions which, when the program is executed by a computer, cause the computer to carry out any of the methods above.

According to the present invention there is provided a computer-readable storage medium comprising instructions which, when executed by a computer, cause the computer to carry out any of the methods above.

Aspects of the invention will now be described by way of examples, with reference to the following figures in which:

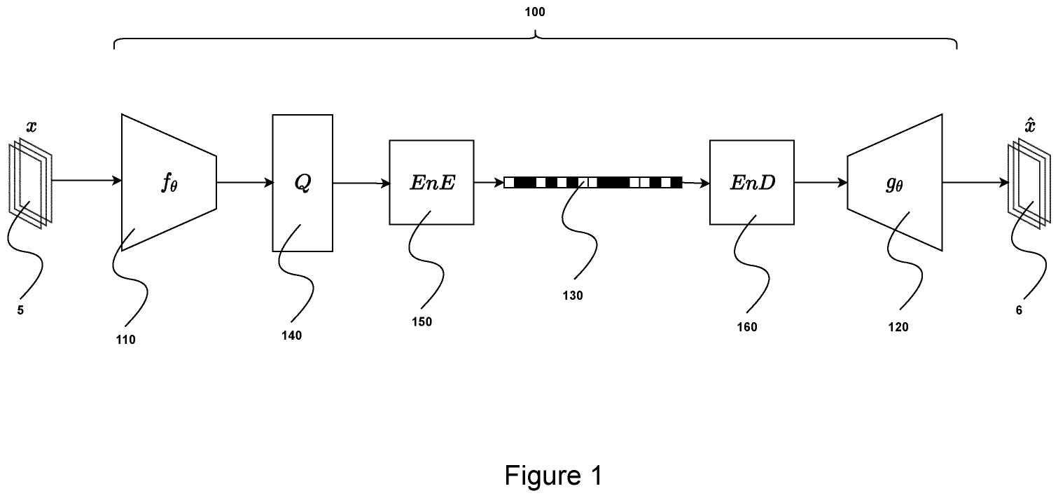

FIG. 1 illustrates an example of an image or video compression, transmission and decompression pipeline.

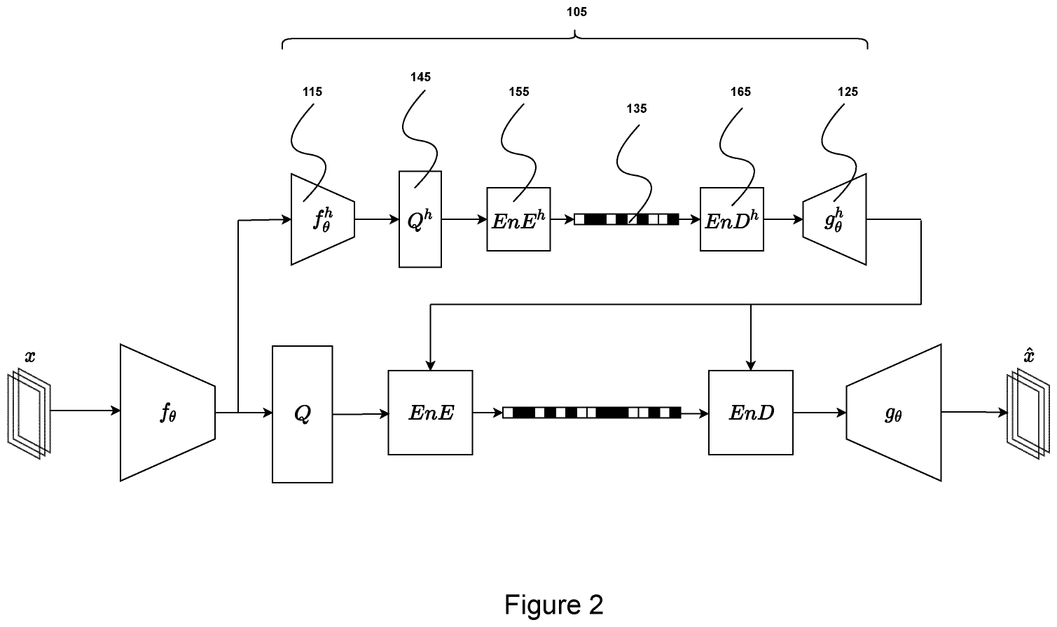

FIG. 2 illustrates a further example of an image or video compression, transmission and decompression pipeline including a hyper-network.

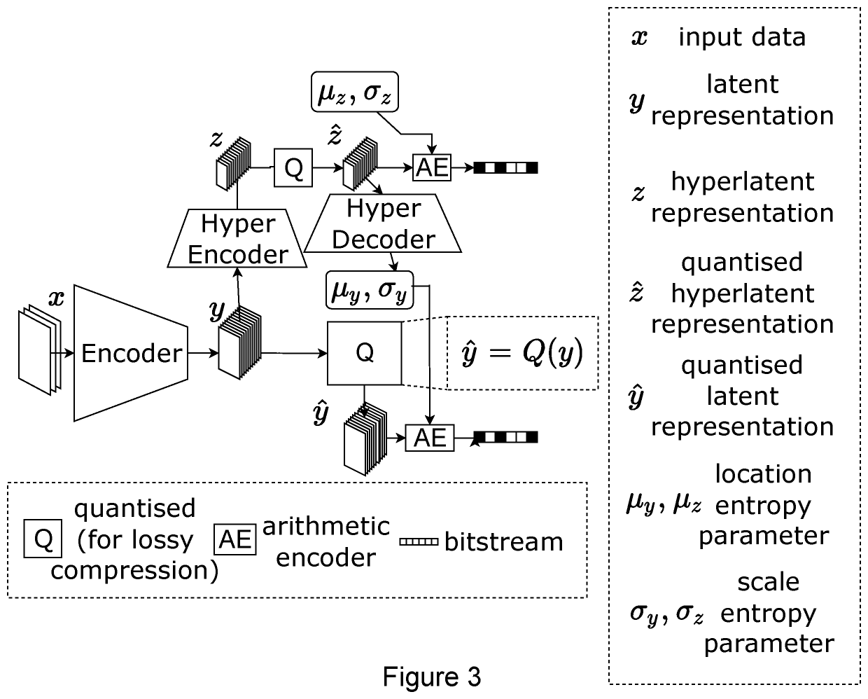

FIG. 3 illustrates a schematic of an example encoding phase of an AI-based compression algorithm, for video and image compression.

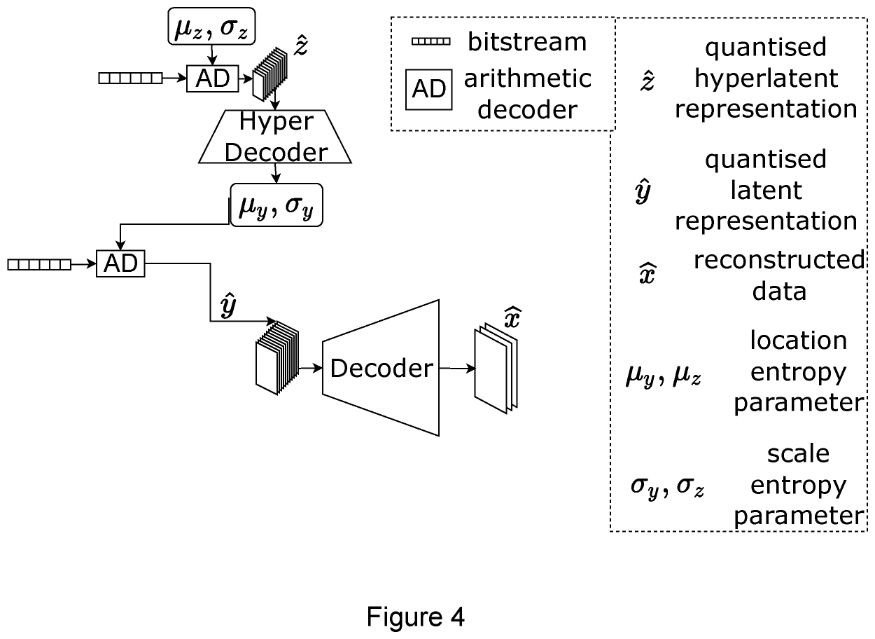

FIG. 4 illustrates an example decoding phase of an AI-based compression algorithm, for video and image compression.

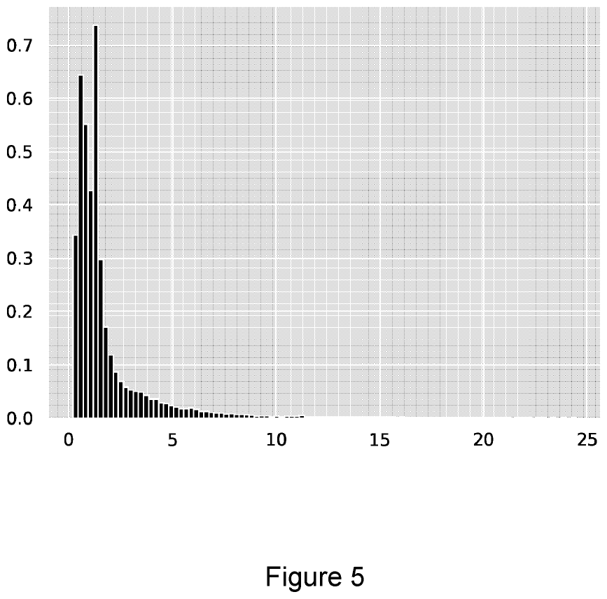

FIG. 5 illustrates an example of a distribution of values for quantisation bin sizes that can be learned while training the AI-based compression pipeline.

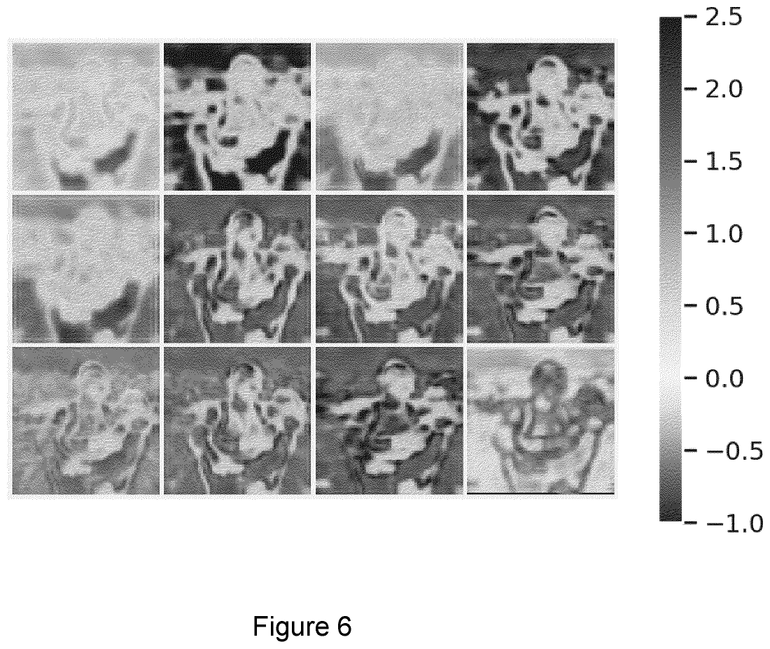

FIG. 6 illustrates a heatmap indicating how the sizes of learned quantisation bins vary for a given image, across latent channels.

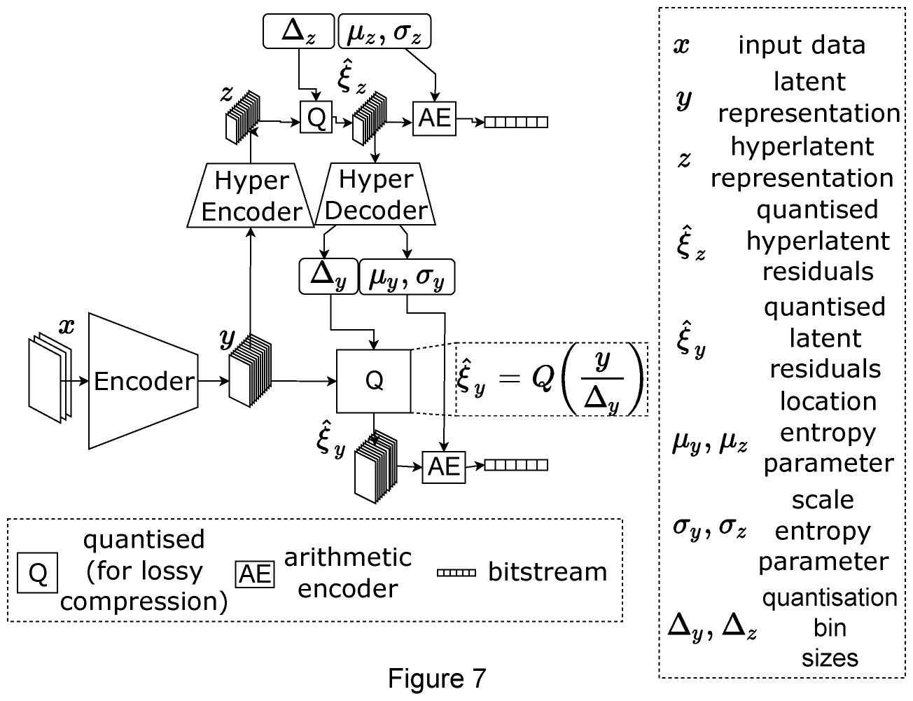

FIG. 7 illustrates a schematic of an example encoding phase of an AI-based compression algorithm utilizing a hyperprior and learned quantisation bin sizes, for video and image compression.

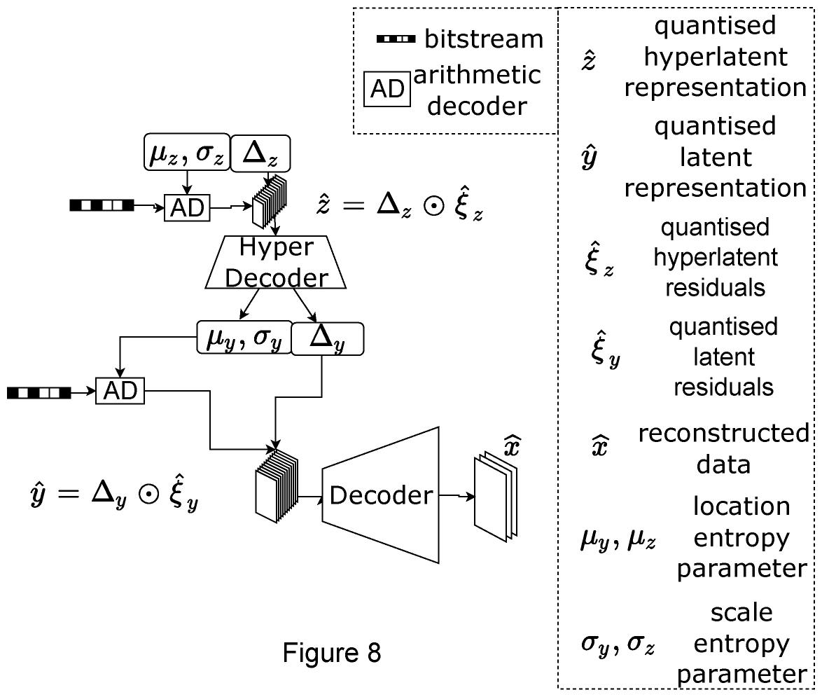

FIG. 8 illustrates a schematic of an example decoding phase of an AI-based compression algorithm utilizing a hyperprior and learned quantisation bin sizes, for video and image compression.

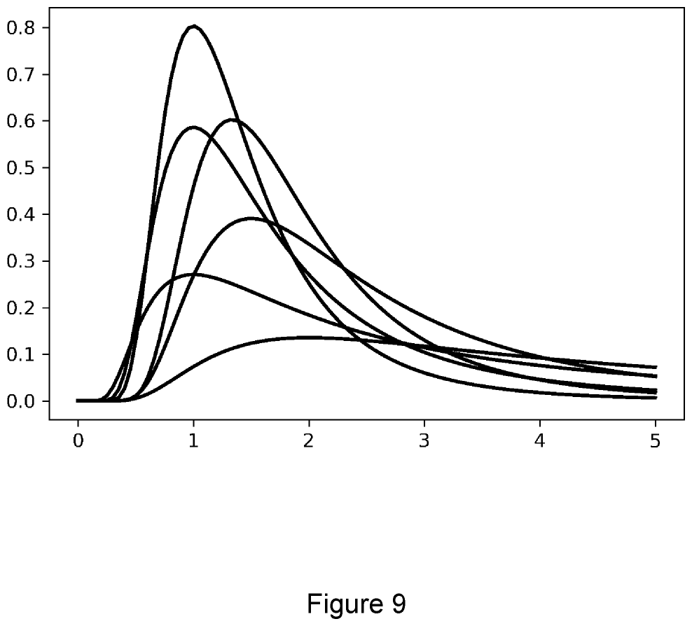

FIG. 9 illustrates several examples of the inverse gamma distribution.

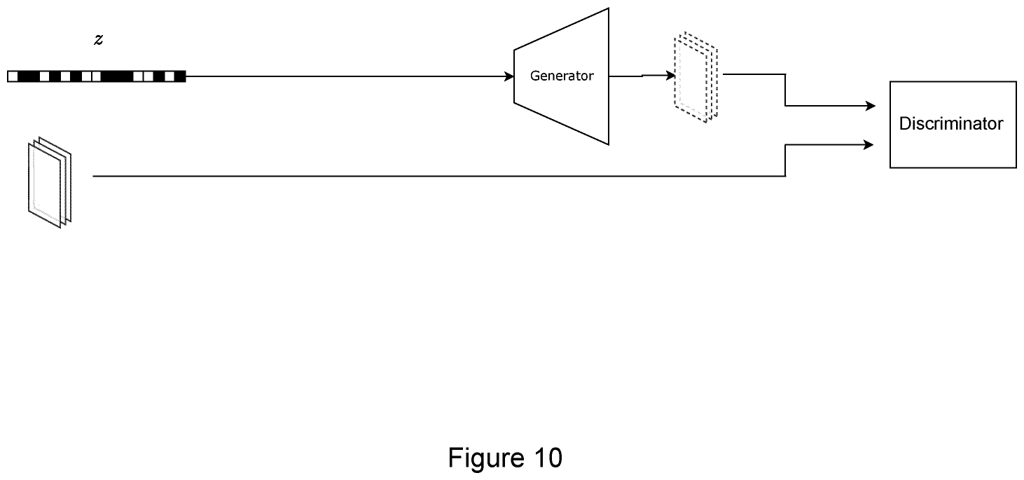

FIG. 10 illustrates an example overview of the architecture of a GAN.

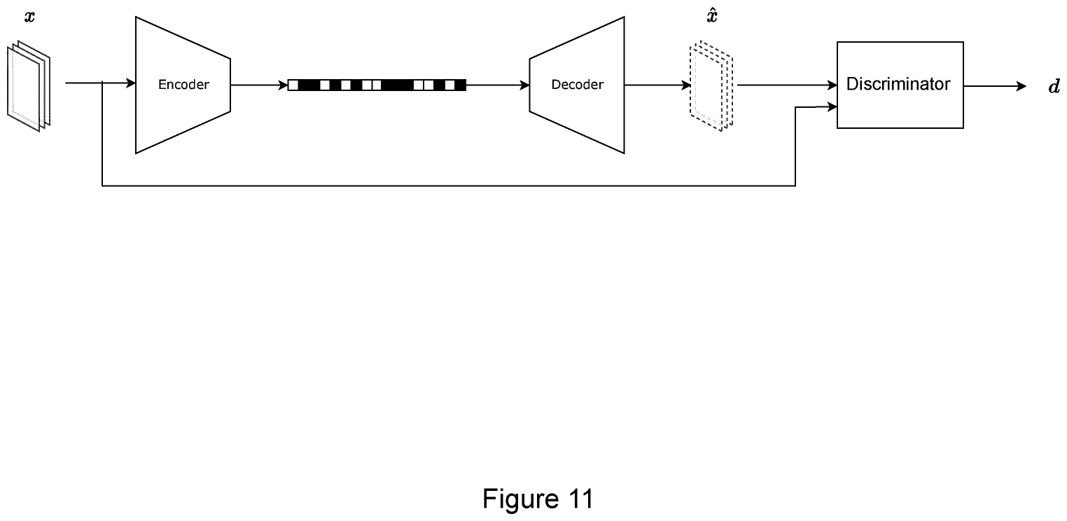

FIG. 11 illustrates an example of a standard generative adversarial compression pipeline.

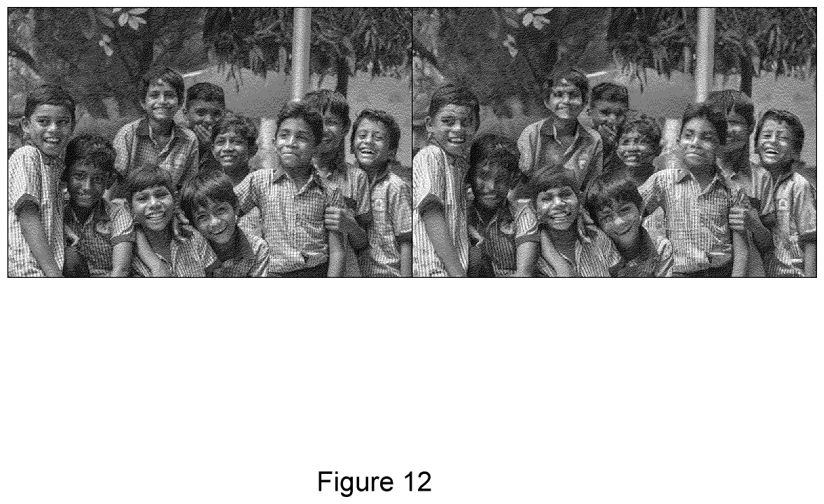

FIG. 12 illustrates an example of a failure mode of an architecture that combines GANs with autoencoders.

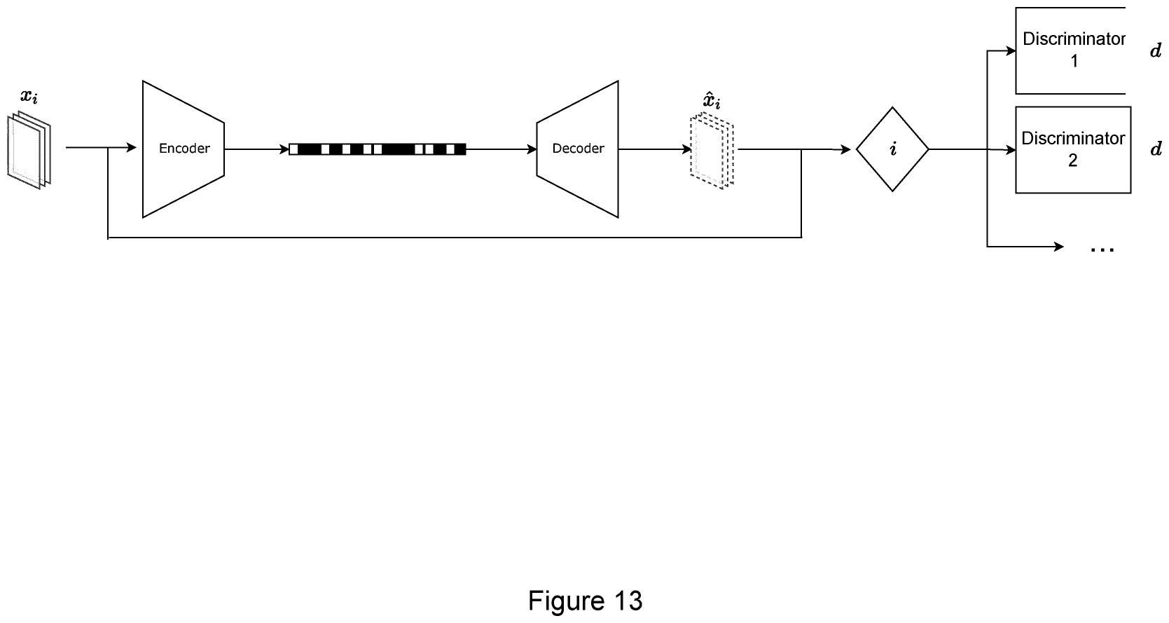

FIG. 13 illustrates an example of a compression pipeline with multi-discriminator cGAN training with dataset biasing.

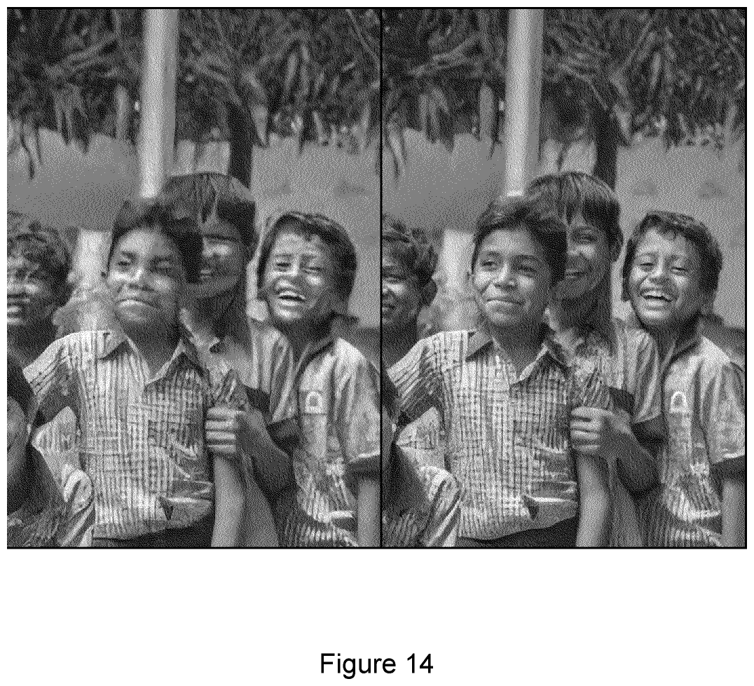

FIG. 14 illustrates a comparison between the reconstructions of the same generative model trained to the same bitrate with and without a multi-discriminant dataset biasing scheme.

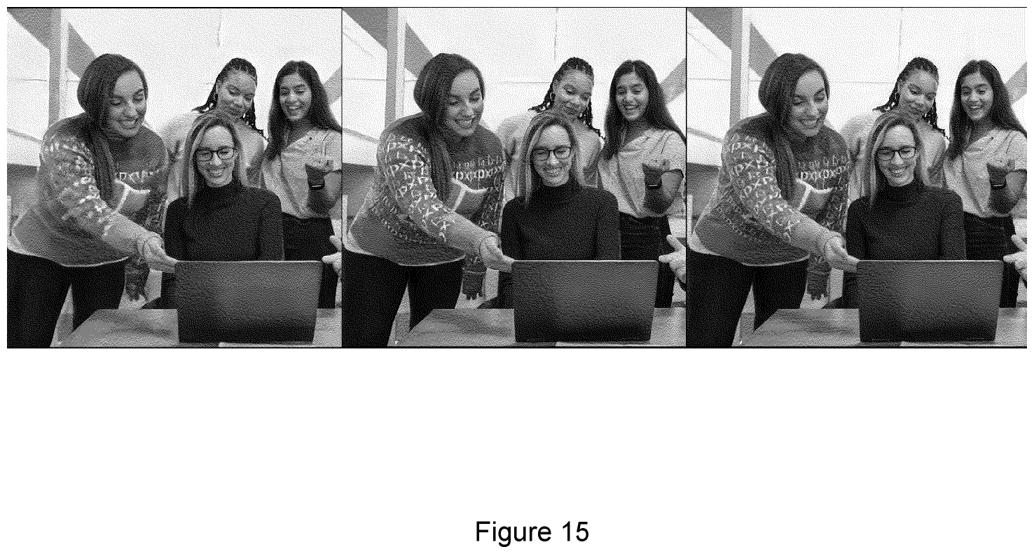

FIG. 15 illustrates an example of the results of bitrate adjusted dataset biasing.

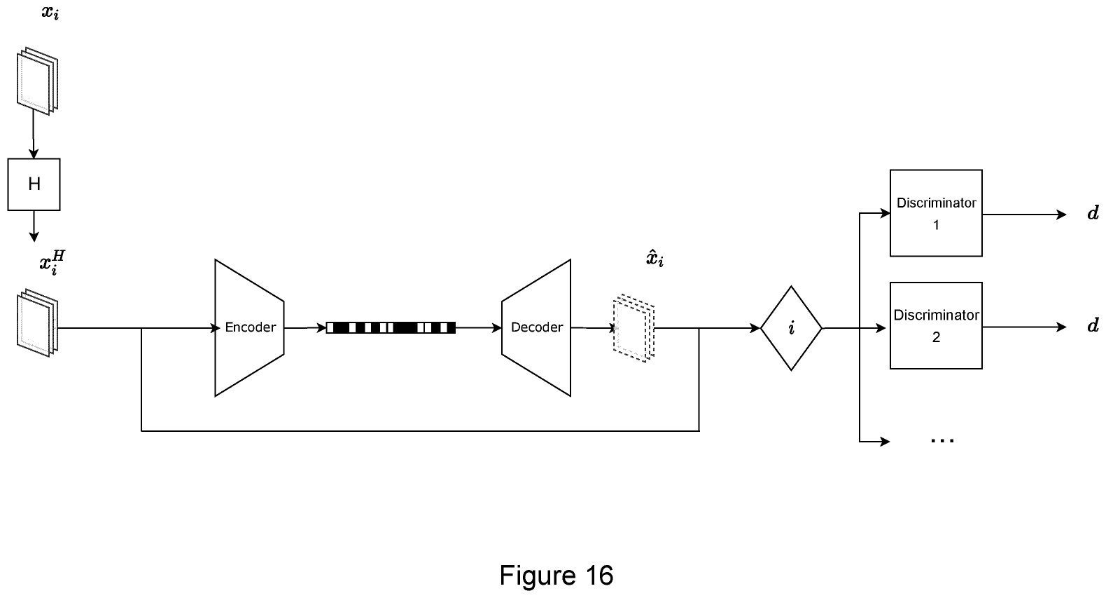

FIG. 16 illustrates an example of an AI based compression pipeline.

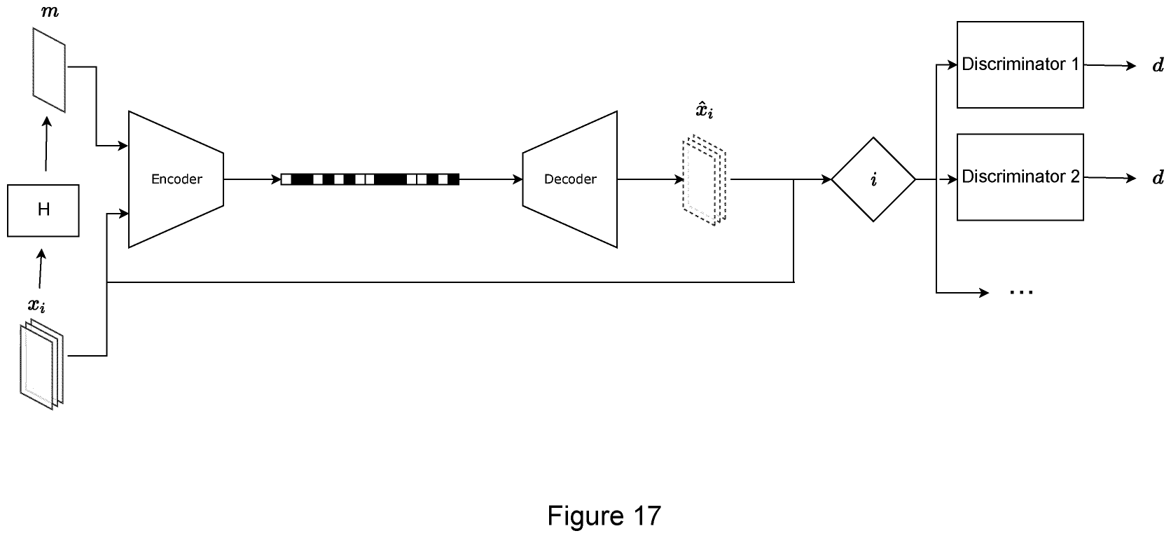

FIG. 17 illustrates a further example of an AI based compression pipeline.

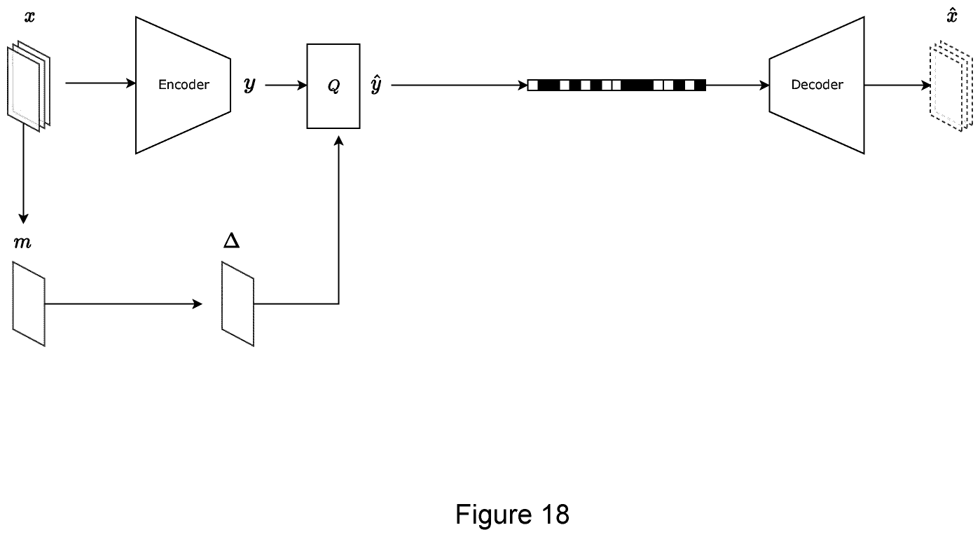

FIG. 18 illustrates an example of a proposed compression pipeline with a quantisation utilising a quantisation map

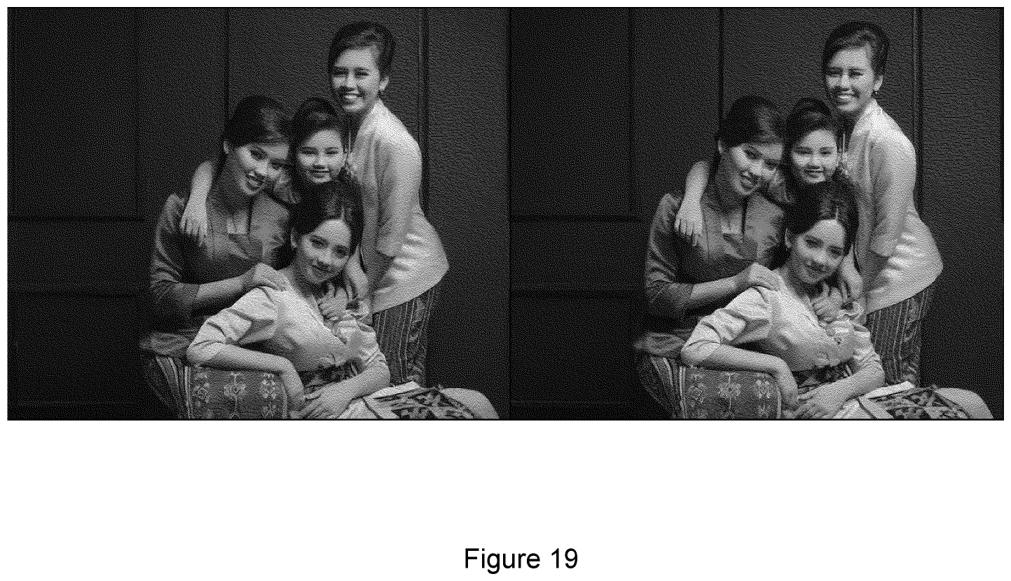

FIG. 19 illustrates an example of the result of implementing a pipeline with a face detector used for identifying regions of interest.

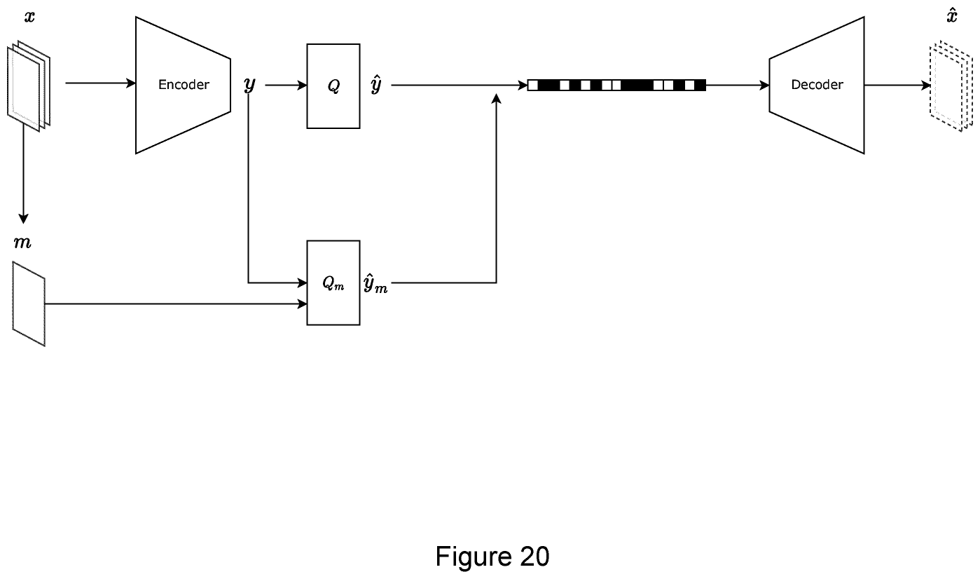

FIG. 20 illustrates a different quantisation function Q, for areas identified with ROI detection network H(x).

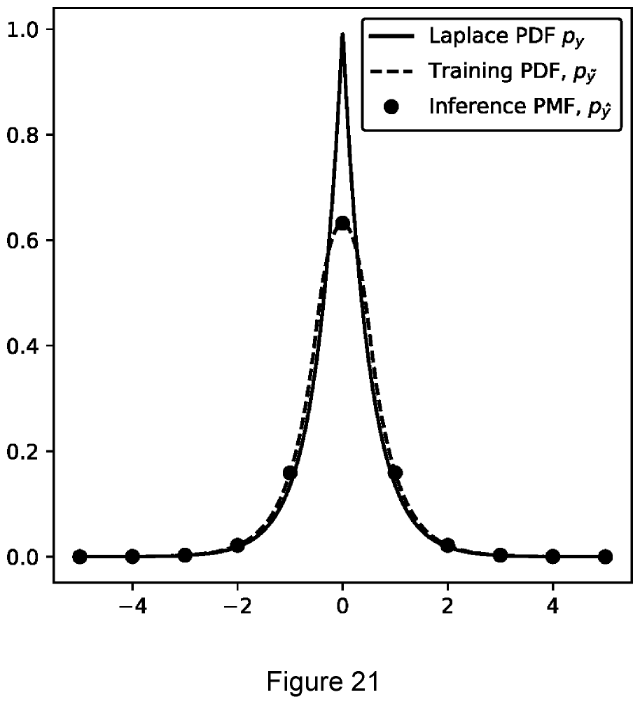

FIG. 21 illustrates an example of the three typical one-dimensional distributions that may be used in training an AI-based compression pipeline.

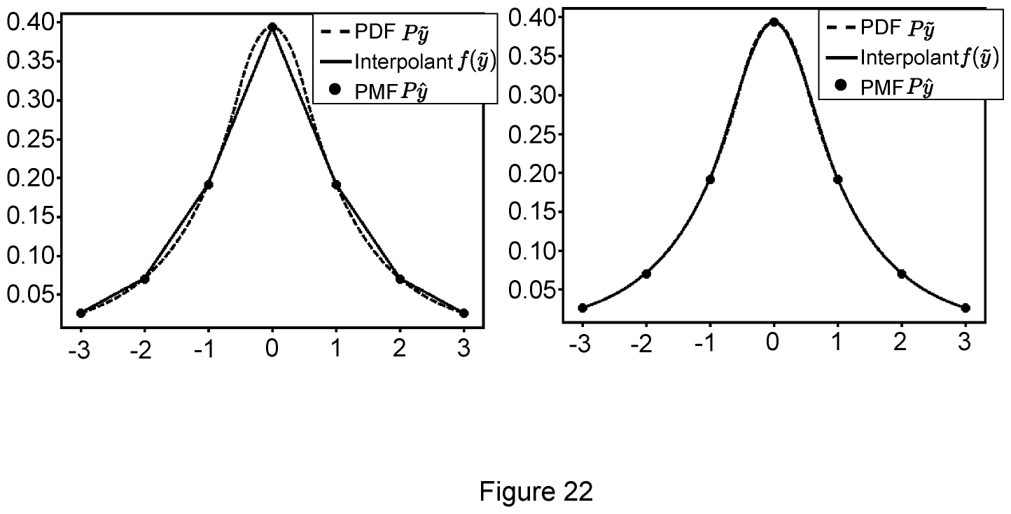

FIG. 22 illustrates a comparison between piecewise linear interpolation and piecewise cubic hermite interpolation.

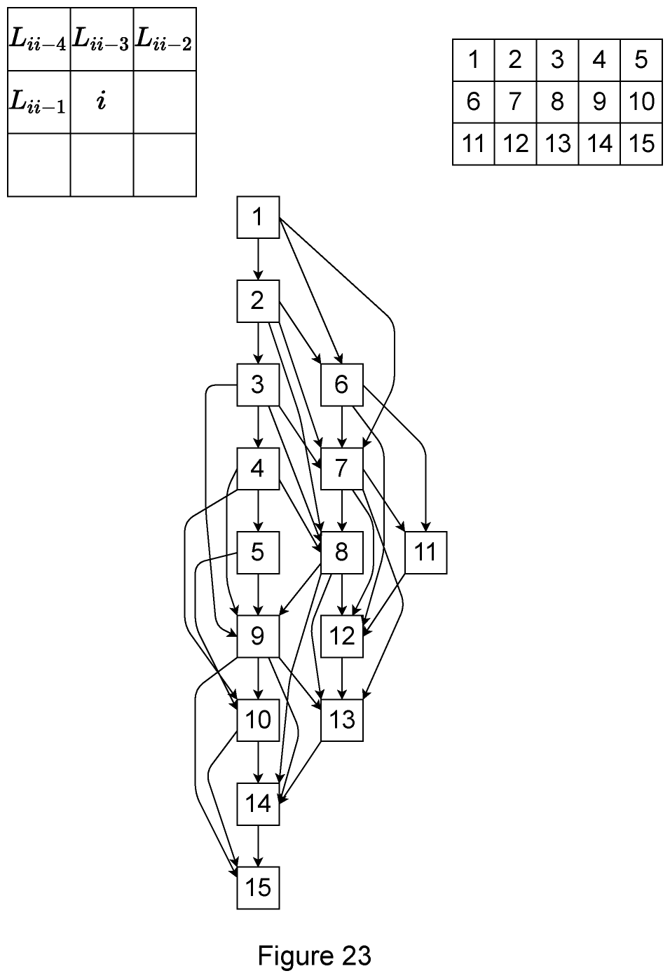

FIG. 23 illustrates an example of the autoregressive structure defined by a sparse context matrix L being exploited to parallelize components of a serial decoding pass.

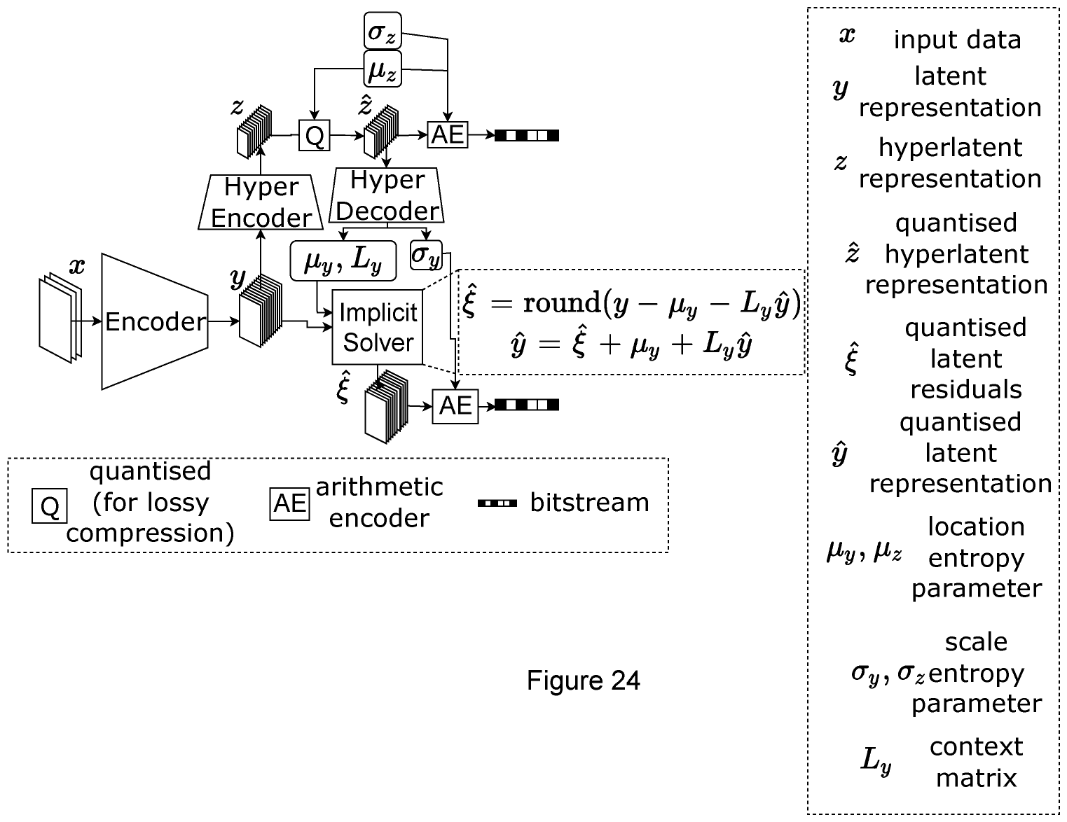

FIG. 24 illustrates an encoding process with predicted context matrix L_{y} in an example AI-based compression pipeline.

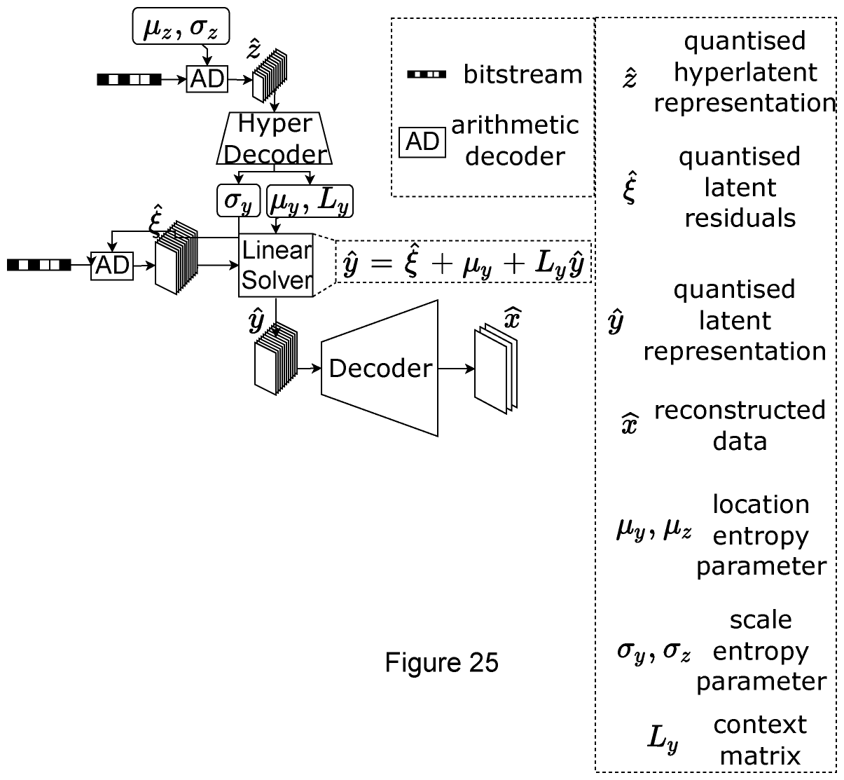

FIG. 25 illustrates a decoding process with predicted context matrix L_{y} in an example AI-based compression pipeline.

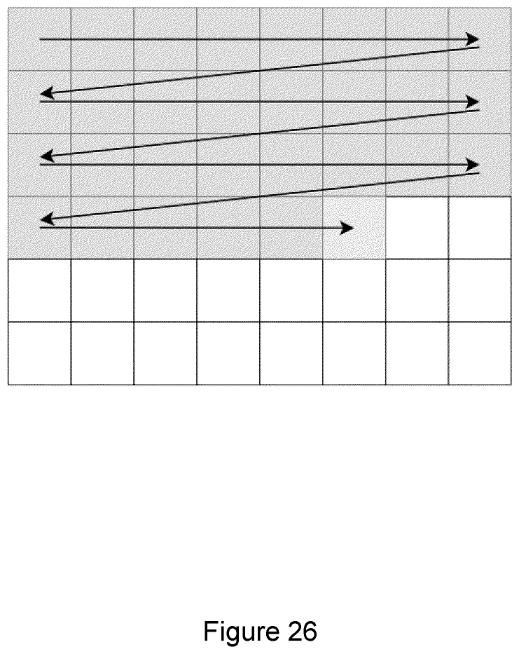

FIG. 26 illustrates an example of raster scan ordering for a single-channel image.

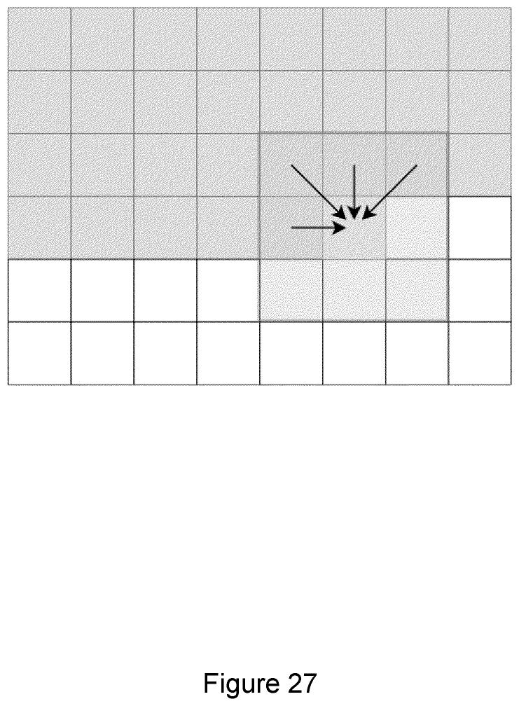

FIG. 27 illustrates a 3×3 receptive field where the next pixel is conditioned on local variables instead of all preceding variables.

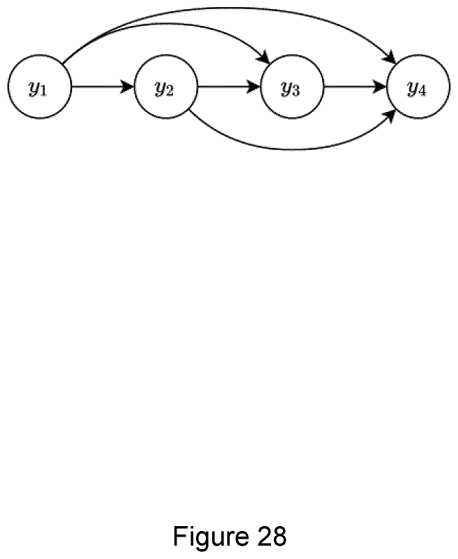

FIG. 28 illustrates an example of a DAG that describes the joint distribution of the four variables {y₁, y₂, y₃, y₄}.

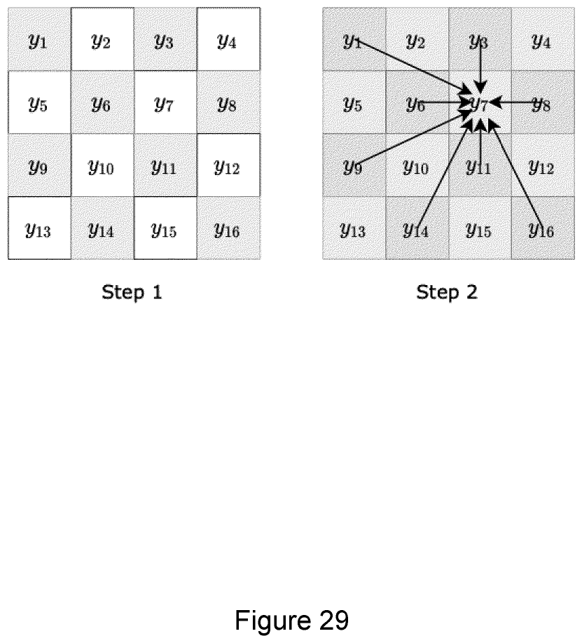

FIG. 29 illustrates an example of a 2-step AO where the current variables in each step are all conditionally independent and can be evaluated in parallel.

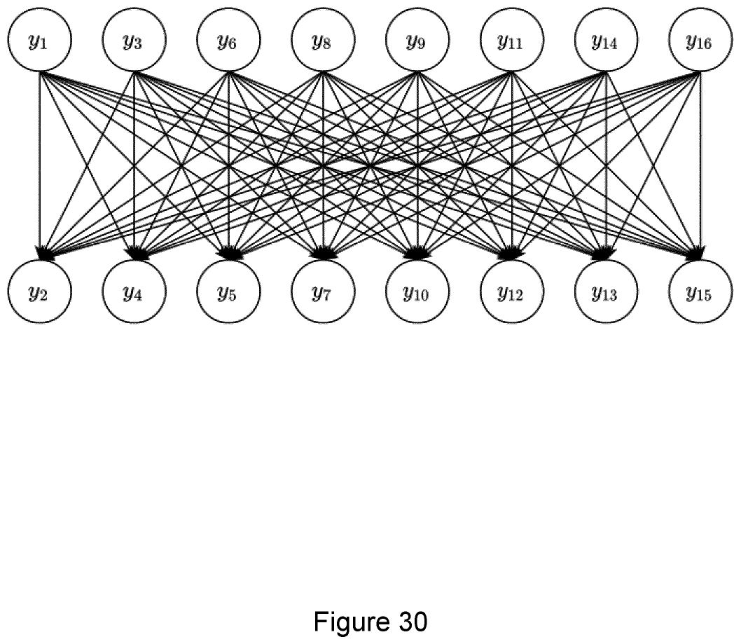

FIG. 30 illustrates a corresponding directed graph to the AO of FIG. 29.

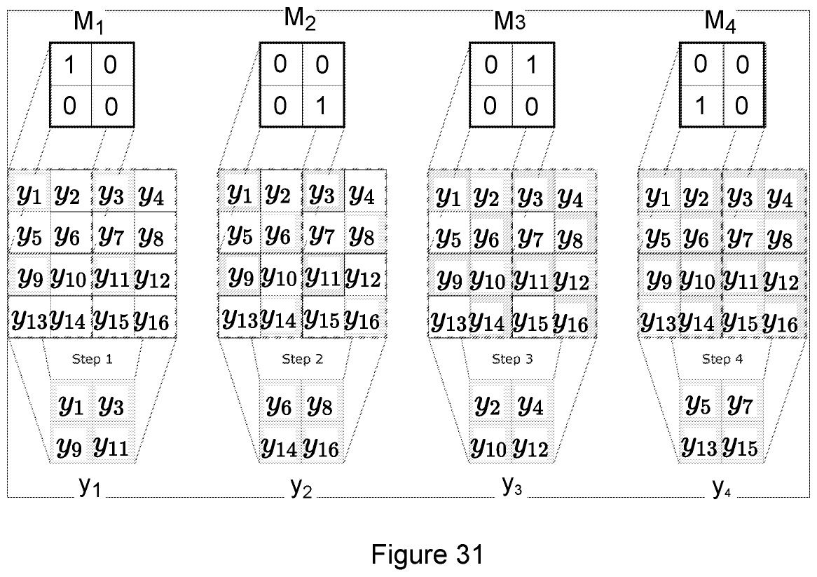

FIG. 31 illustrates an example of how 2×2 binary mask kernels complying with constraints (61) and (62) produce 4 subimages.

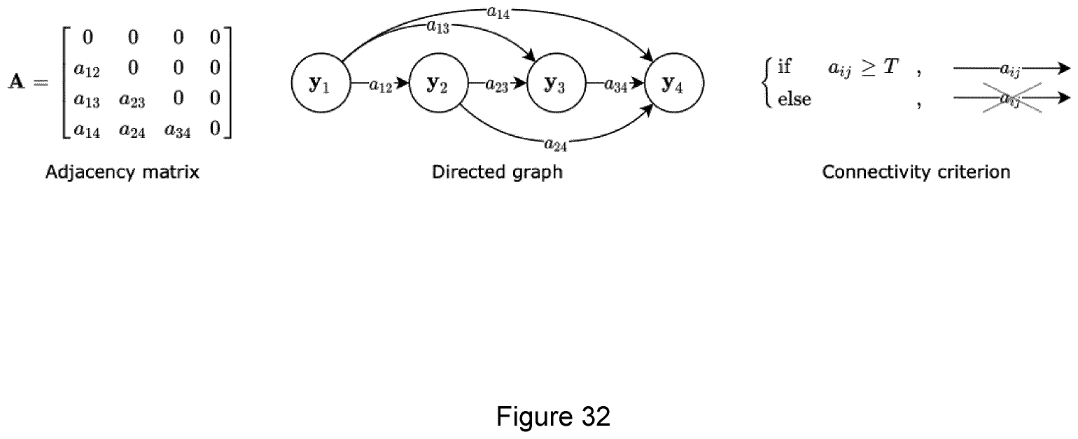

FIG. 32 illustrates an example of an adjacency matrix A that determines the graph connectivity for an AO defined by a binary mask kernel framework.

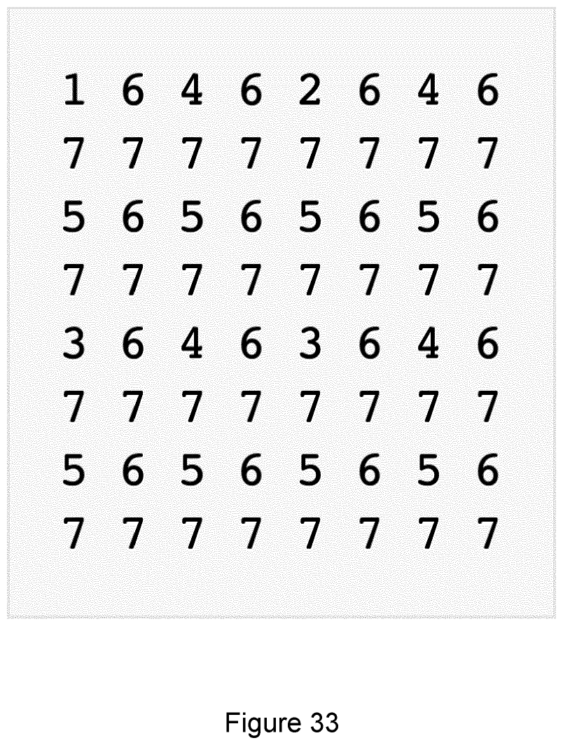

FIG. 33 illustrates an indexing of an Adam7 interlacing scheme.

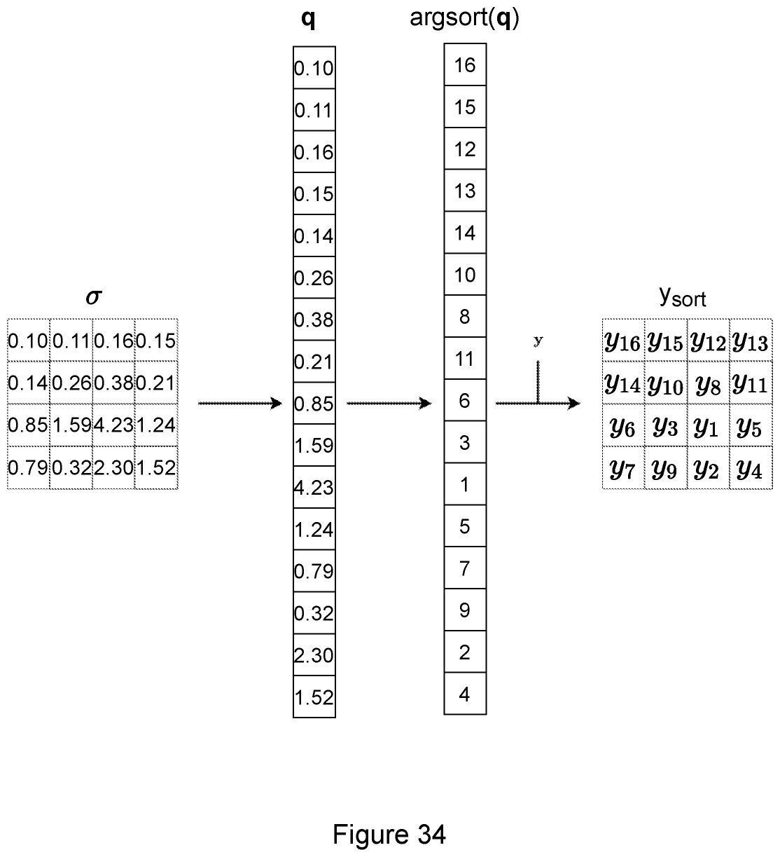

FIG. 34 illustrates an example visualisation of the scale parameter σ where the AO is defined as y₁, y₂, . . . Y₁₆.

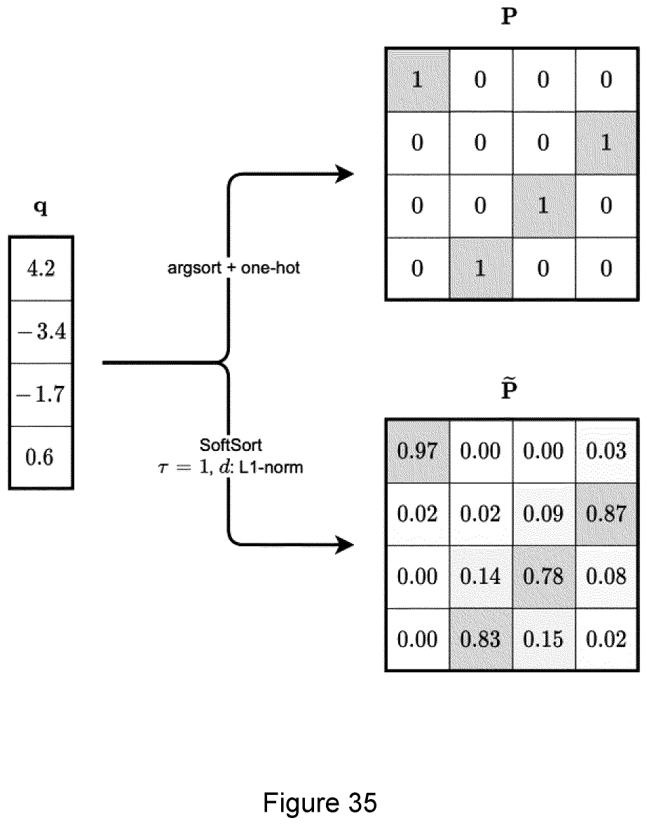

FIG. 35 illustrates an example of a permutation matrix representation.

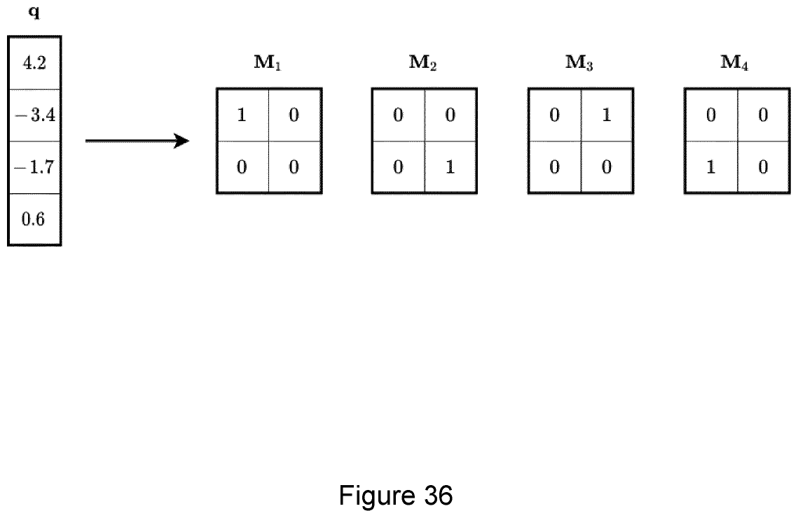

FIG. 36 illustrates an example of the ranking table concept applied to a binary mask kernel framework.

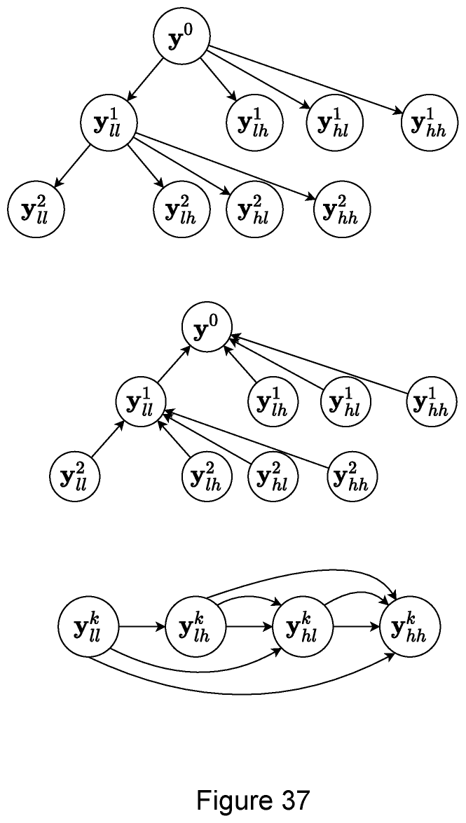

FIG. 37 illustrates an example of a hierarchical autoregressive ordering based on a wavelet transform.

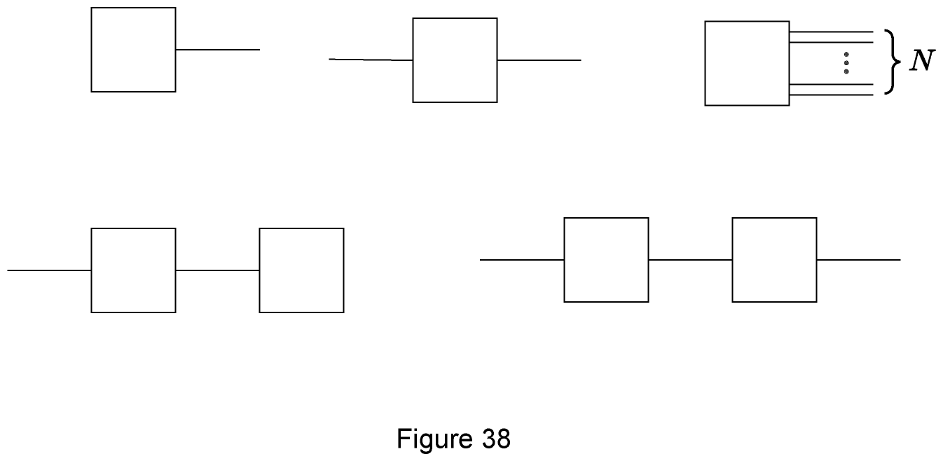

FIG. 38 illustrates various tensor and tensor products in diagrammatic notation.

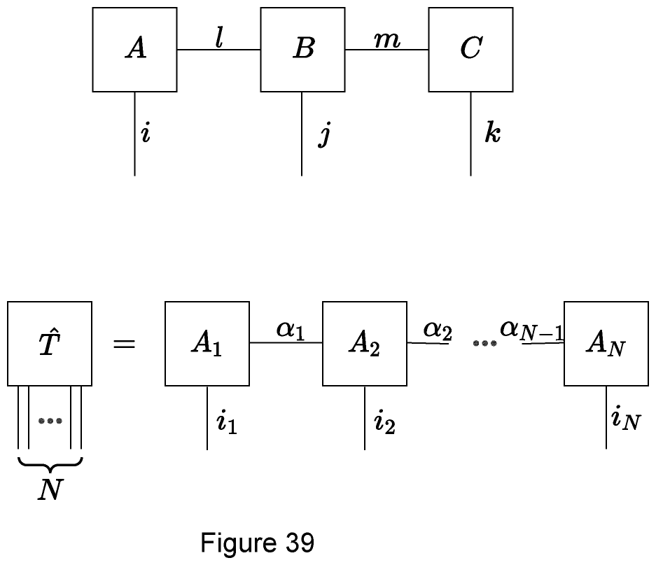

FIG. 39 illustrates an example of a 3-tensor decomposition and a Matrix Product State in diagrammatic notation.

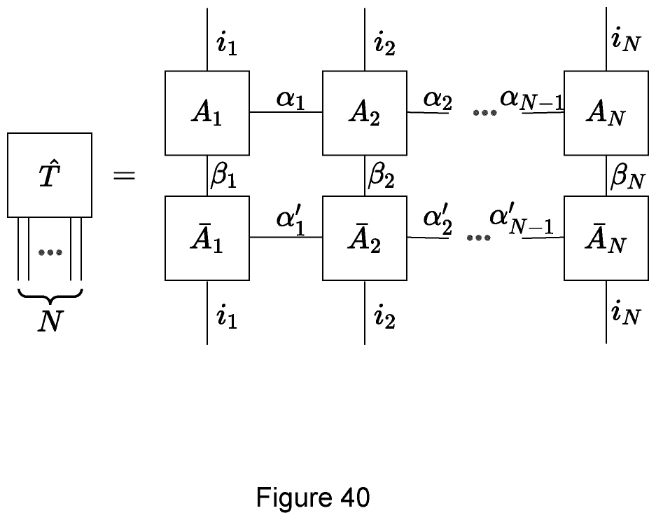

FIG. 40 illustrates an example of a Locally Purified State in diagrammatic notation.

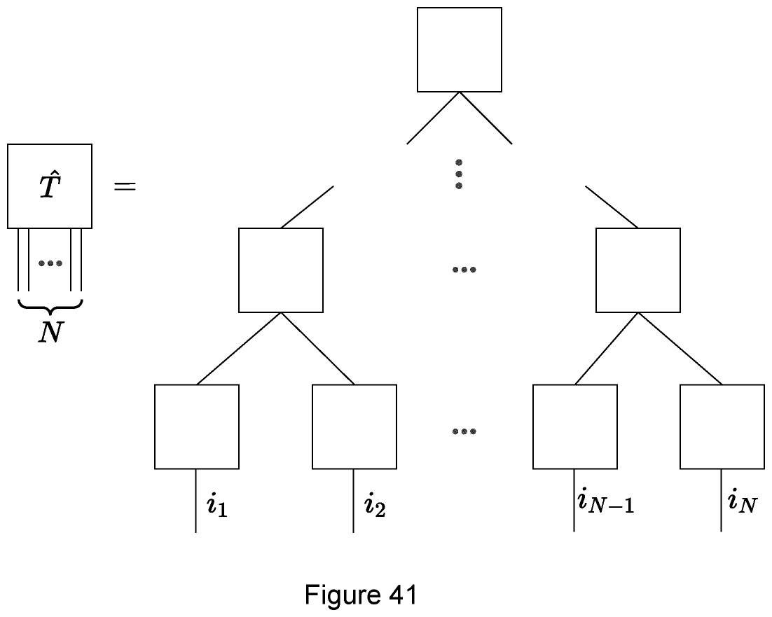

FIG. 41 illustrates an example of a Tensor Tree in diagrammatic notation.

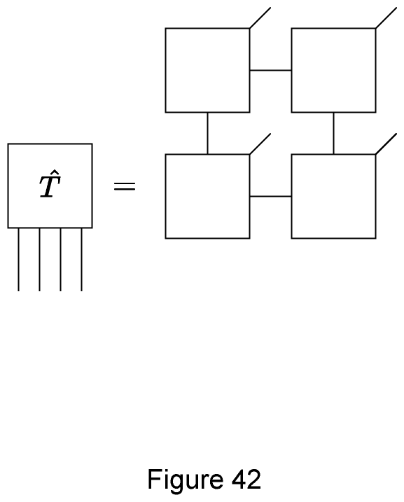

FIG. 42 illustrates an example of a 2×2 Projected Entangled Pair State in diagrammatic notation.

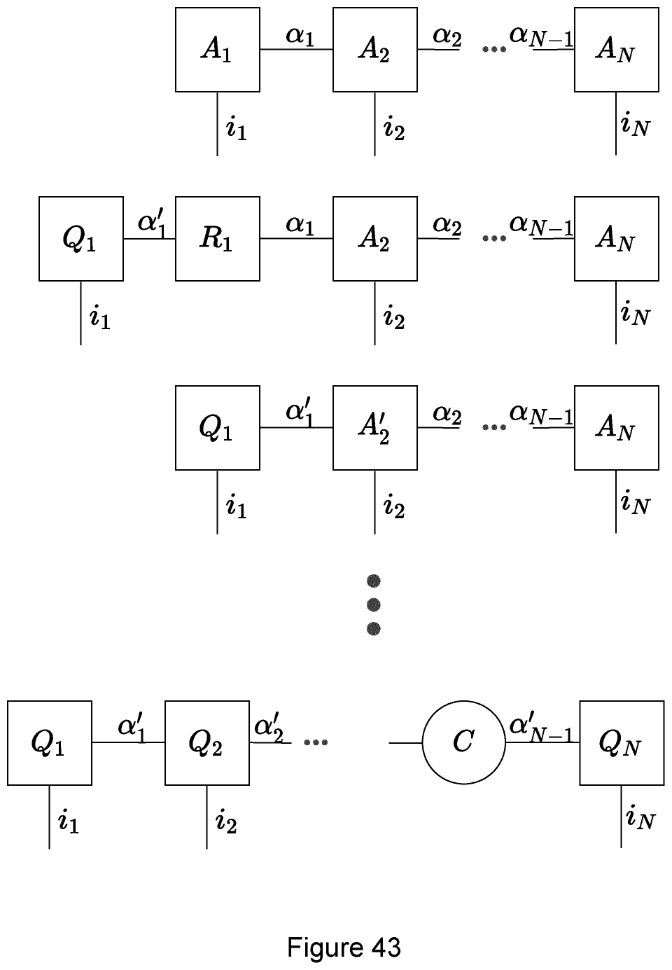

FIG. 43 illustrates an example of the procedure for transforming a Matrix Product State into canonical form in diagrammatic notation.

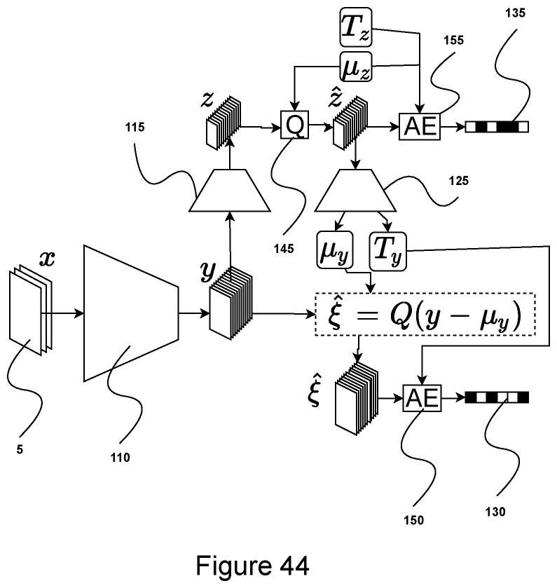

FIG. 44 illustrates an example of an image or video compression pipeline with a tensor network predicted by a hyper-encoder/hyper-decoder.

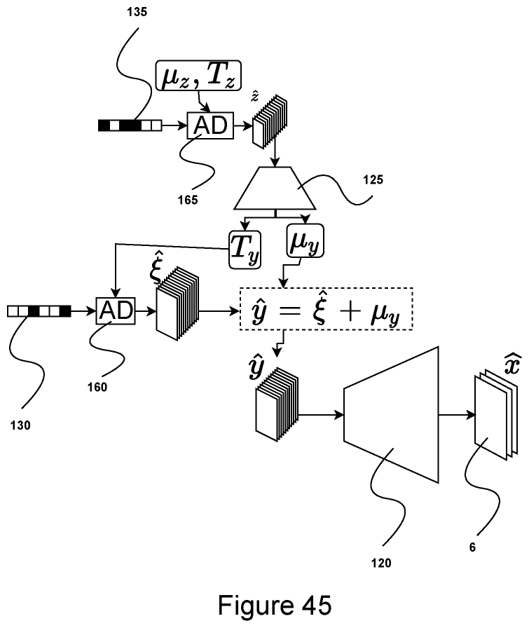

FIG. 45 illustrates an example of an image or video decompression pipeline with a tensor network predicted by a hyper-decoder.

Compression processes may be applied to any form of information to reduce the amount of data, or file size, required to store that information. Image and video information is an example of information that may be compressed. The file size required to store the information, particularly during a compression process when referring to the compressed file, may be referred to as the rate. In general, compression can be lossless or lossy. In both forms of compression, the file size is reduced. However, in lossless compression, no information is lost when the information is compressed and subsequently decompressed. This means that the original file storing the information is fully reconstructed during the decompression process. In contrast to this, in lossy compression information may be lost in the compression and decompression process and the reconstructed file may differ from the original file. Image and video files containing image and video data are common targets for compression. JPEG, JPEG2000, AVC, HEVC and AVI are examples of compression processes for image and/or video files.

In a compression process involving an image, the input image may be represented as x. The data representing the image may be stored in a tensor of dimensions H×W×C, where H represents the height of the image, W represents the width of the image and C represents the number of channels of the image. Each H×W data point of the image represents a pixel value of the image at the corresponding location. Each channel C of the image represents a different component of the image for each pixel which are combined when the image file is displayed by a device. For example, an image file may have 3 channels with the channels representing the red, green and blue component of the image respectively. In this case, the image information is stored in the RGB colour space, which may also be referred to as a model or a format. Other examples of colour spaces or formats include the CMKY and the YCbCr colour models. However, the channels of an image file are not limited to storing colour information and other information may be represented in the channels. As a video may be considered a series of images in sequence, any compression process that may be applied to an image may also be applied to a video. Each image making up a video may be referred to as a frame of the video.

The frames of a video may be labelled depending on the nature of the frame. For example, frames of a video may be labeled as I-frames and P-frames. I-frames may be the first frame of a new section of a video. For example, the first frame after a scene transition may be labeled an I-frame. P-frames may be subsequent frames after an I-frame. For example, the background or objects present of a P-frame may not change from the I-frame proceeding the P-frame. The changes in a P-frame compared to the I-frame proceeding the P-frame may be described by motion of the objects present in the frame or by motion of the perspective of the frame.

The output image may differ from the input image and may be represented by x. The difference between the input image and the output image may be referred to as distortion or a difference in image quality. The distortion can be measured using any distortion function which receives the input image and the output image and provides an output which represents the difference between input image and the output image in a numerical way. An example of such a method is using the mean square error (MSE) between the pixels of the input image and the output image, but there are many other ways of measuring distortion, as will be known to the person skilled in the art. The distortion function may comprise a trained neural network.

Typically, the rate and distortion of a lossy compression process are related. An increase in the rate may result in a decrease in the distortion, and a decrease in the rate may result in an increase in the distortion. Changes to the distortion may affect the rate in a corresponding manner. A relation between these quantities for a given compression technique may be defined by a rate-distortion equation.

AI based compression processes may involve the use of neural networks. A neural network is an operation that can be performed on an input to produce an output. A neural network may be made up of a plurality of layers. The first layer of the network receives the input. One or more operations may be performed on the input by the layer to produce an output of the first layer. The output of the first layer is then passed to the next layer of the network which may perform one or more operations in a similar way. The output of the final layer is the output of the neural network.

Each layer of the neural network may be divided into nodes. Each node may receive at least part of the input from the previous layer and provide an output to one or more nodes in a subsequent layer. Each node of a layer may perform the one or more operations of the layer on at least part of the input to the layer. For example, a node may receive an input from one or more nodes of the previous layer. The one or more operations may include a convolution, a weight, a bias and an activation function. Convolution operations are used in convolutional neural networks. When a convolution operation is present, the convolution may be performed across the entire input to a layer. Alternatively, the convolution may be performed on at least part of the input to the layer.

Each of the one or more operations is defined by one or more parameters that are associated with each operation. For example, the weight operation may be defined by a weight matrix defining the weight to be applied to each input from each node in the previous layer to each node in the present layer. In this example, each of the values in the weight matrix is a parameter of the neural network. The convolution may be defined by a convolution matrix, also known as a kernel. In this example, one or more of the values in the convolution matrix may be a parameter of the neural network. The activation function may also be defined by values which may be parameters of the neural network. The parameters of the network may be varied during training of the network.

Other features of the neural network may be predetermined and therefore not varied during training of the network. For example, the number of layers of the network, the number of nodes of the network, the one or more operations performed in each layer and the connections between the layers may be predetermined and therefore fixed before the training process takes place. These features that are predetermined may be referred to as the hyperparameters of the network. These features are sometimes referred to as the architecture of the network.

To train the neural network, a training set of inputs may be used for which the expected output, sometimes referred to as the ground truth, is known. The initial parameters of the neural network are randomized and the first training input is provided to the network. The output of the network is compared to the expected output, and based on a difference between the output and the expected output the parameters of the network are varied such that the difference between the output of the network and the expected output is reduced. This process is then repeated for a plurality of training inputs to train the network. The difference between the output of the network and the expected output may be defined by a loss function. The result of the loss function may be calculated using the difference between the output of the network and the expected output to determine the gradient of the loss function. Back-propagation of the gradient descent of the loss function may be used to update the parameters of the neural network using the gradients dL/dy of the loss function. A plurality of neural networks in a system may be trained simultaneously through back-propagation of the gradient of the loss function to each network.

In the case of AI based image or video compression, the loss function may be defined by the rate distortion equation. The rate distortion equation may be represented by Loss=D+λ*R, where D is the distortion function, λ is a weighting factor, and R is the rate loss. A may be referred to as a lagrange multiplier. The langrange multiplier provides as weight for a particular term of the loss function in relation to each other term and can be used to control which terms of the loss function are favoured when training the network.

In the case of AI based image or video compression, a training set of input images may be used. An example training set of input images is the KODAK image set (for example at www.cs.albany.edu/xypan/research/snr/Kodak.html). An example training set of input images is the IMAX image set. An example training set of input images is the Imagenet dataset (for example at www.image-net.org/download). An example training set of input images is the CLIC Training Dataset P (“professional”) and M (“mobile”) (for example at http://challenge.compression.cc/tasks/).

An example of an AI based compression process 100 is shown in FIG. 1. As a first step in the AI based compression process, an input image 5 is provided. The input image 5 is provided to a trained neural network 110 characterized by a function f_{θ} acting as an encoder. The encoder neural network 110 produces an output based on the input image. This output is referred to as a latent representation of the input image 5. In a second step, the latent representation is quantised in a quantisation process 140 characterised by the operation Q, resulting in a quantized latent. The quantisation process transforms the continuous latent representation into a discrete quantized latent. An example of a quantization process is a rounding function.

In a third step, the quantized latent is entropy encoded in an entropy encoding process 150 to produce a bitstream 130. The entropy encoding process may be for example, range or arithmetic encoding. In a fourth step, the bitstream 130 may be transmitted across a communication network.

In a fifth step, the bitstream is entropy decoded in an entropy decoding process 160. The quantized latent is provided to another trained neural network 120 characterized by a function go acting as a decoder, which decodes the quantized latent. The trained neural network 120 produces an output based on the quantized latent. The output may be the output image of the AI based compression process 100. The encoder-decoder system may be referred to as an autoencoder.

The system described above may be distributed across multiple locations and/or devices. For example, the encoder 110 may be located on a device such as a laptop computer, desktop computer, smart phone or server. The decoder 120 may be located on a separate device which may be referred to as a recipient device. The system used to encode, transmit and decode the input image 5 to obtain the output image 6 may be referred to as a compression pipeline.

The AI based compression process may further comprise a hyper-network 105 for the transmission of meta-information that improves the compression process. The hyper-network 105 comprises a trained neural network 115 acting as a hyper-encoder f_{θ}^{h} and a trained neural network 125 acting as a hyper-decoder g_{θ}^{h}. An example of such a system is shown in FIG. 2.

Components of the system not further discussed may be assumed to be the same as discussed above. The neural network 115 acting as a hyper-decoder receives the latent that is the output of the encoder 110. The hyper-encoder 115 produces an output based on the latent representation that may be referred to as a hyper-latent representation. The hyper-latent is then quantized in a quantization process 145 characterised by Q^{h} to produce a quantized hyper-latent. The quantization process 145 characterised by Q^{h} may be the same as the quantisation process 140 characterised by Q discussed above.

In a similar manner as discussed above for the quantized latent, the quantized hyper-latent is then entropy encoded in an entropy encoding process 155 to produce a bitstream 135. The bitstream 135 may be entropy decoded in an entropy decoding process 165 to retrieve the quantized hyper-latent. The quantized hyper-latent is then used as an input to trained neural network 125 acting as a hyper-decoder. However, in contrast to the compression pipeline 100, the output of the hyper-decoder may not be an approximation of the input to the hyper-decoder 115. Instead, the output of the hyper-decoder is used to provide parameters for use in the entropy encoding process 150 and entropy decoding process 160 in the main compression process 100. For example, the output of the hyper-decoder 125 can include one or more of the mean, standard deviation, variance or any other parameter used to describe a probability model for the entropy encoding process 150 and entropy decoding process 160 of the latent representation. In the example shown in FIG. 2, only a single entropy decoding process 165 and hyper-decoder 125 is shown for simplicity. However, in practice, as the decompression process usually takes place on a separate device, duplicates of these processes will be present on the device used for encoding to provide the parameters to be used in the entropy encoding process 150.

Further transformations may be applied to at least one of the latent and the hyper-latent at any stage in the AI based compression process 100. For example, at least one of the latent and the hyper latent may be converted to a residual value before the entropy encoding process 150, 155 is performed. The residual value may be determined by subtracting the mean value of the distribution of latents or hyper-latents from each latent or hyper latent. The residual values may also be normalised.

To perform training of the AI based compression process described above, a training set of input images may be used as described above. During the training process, the parameters of both the encoder 110 and the decoder 120 may be simultaneously updated in each training step. If a hyper-network 105 is also present, the parameters of both the hyper-encoder 115 and the hyper-decoder 125 may additionally be simultaneously updated in each training step

The training process may further include a generative adversarial network (GAN). When applied to an AI based compression process, in addition to the compression pipeline described above, an additional neutral network acting as a discriminator is included in the system. The discriminator receives an input and outputs a score based on the input providing an indication of whether the discriminator considers the input to be ground truth or fake. For example, the indicator may be a score, with a high score associated with a ground truth input and a low score associated with a fake input. For training of a discriminator, a loss function is used that maximizes the difference in the output indication between an input ground truth and input fake.

When a GAN is incorporated into the training of the compression process, the output image 6 may be provided to the discriminator. The output of the discriminator may then be used in the loss function of the compression process as a measure of the distortion of the compression process. Alternatively, the discriminator may receive both the input image 5 and the output image 6 and the difference in output indication may then be used in the loss function of the compression process as a measure of the distortion of the compression process. Training of the neural network acting as a discriminator and the other neutral networks in the compression process may be performed simultaneously. During use of the trained compression pipeline for the compression and transmission of images or video, the discriminator neural network is removed from the system and the output of the compression pipeline is the output image 6.

Incorporation of a GAN into the training process may cause the decoder 120 to perform hallucination. Hallucination is the process of adding information in the output image 6 that was not present in the input image 5. In an example, hallucination may add fine detail to the output image 6 that was not present in the input image 5 or received by the decoder 120. The hallucination performed may be based on information in the quantized latent received by decoder 120.

As discussed above, a video is made up of a series of images arranged in sequential order. AI based compression process 100 described above may be applied multiple times to perform compression, transmission and decompression of a video. For example, each frame of the video may be compressed, transmitted and decompressed individually. The received frames may then be grouped to obtain the original video.

A number of concepts related to the AI compression processes discussed above will now be described. Although each concept is described separately, one or more of the concepts desired below may be applied in an AI based compression process as described above.

### Learned Quantisation

Quantisation is a critical step in any AI-based compression pipeline. Typically, quantisation is achieved by rounding data to the nearest integer. This can be suboptimal, because some regions of images and video can tolerate higher information loss, while other regions require fine-grained detail. Below it is discussed how the size of quantisation bins can be learned, instead of fixed to nearest-integer rounding. We detail several architectures to achieve this, such as predicting bin sizes from hypernetworks, context modules, and additional neural networks. We also document the necessary changes to the loss function and quantisation procedure required for training AI-based compression pipelines with learned quantisation bin sizes, and show how to introduce Bayesian priors to control the distribution of bin sizes that are learned during training. We show how learned quantisation bins can be used both with or without split quantisation. This innovation also allows distortion gradients to flow through the decoder and to the hypernetwork. Finally, we give a detailed account of Generalised Quantisation Functions, which give performance and runtime improvements. In particular, this innovation allows us to include a context model in a compression pipeline's decoder, but without incurring runtime penalties from repeatedly running an arithmetic (or other lossless) decoding algorithm. Our methods for learning quantisation bins are compatible with all ways of transmitting metainformation, such as hyperpriors, autoregressive models, and implicit models.

The following discussion will outline the functionality, scope and future outlook of learned quantisation bins and generalised quantisation functions for usage in, but not limited to, AI-based image and video compression.

A compression algorithm may be broken into two phases: the encoding phase and the decoding phase. In the encoding phase, input data is transformed into a latent variable with a smaller representation (in bits) than the original input variable. In the decode phase, a reverse transform is applied to the latent variable, in which the original data (or an approximation of the original data) is recovered.

An AI-based compression system must be also be trained. This is the procedure of choosing parameters of the AI-based compression system that achieve good compression results (small file size and minimal distortion). During training, parts of the encoding and decoding algorithm are run, in order to decide how to adjust the parameters of the AI-based compression system.

To be precise, in AI-based compression, encoding typically takes the following form:

$$y = {f}_{e n c} ( x , θ ) \qquad ( 1 a )$$

$$\hat{y} = Q ( y ) \qquad ( 1 b )$$

$$bitstream = AE ( \hat{y} , p ( \hat{y} ) ) \qquad ( 1 c )$$

Here x is the data to be compressed (image or video), f_{enc} is the encoder, which is usually a neural network with parameters θ that are trained. The encoder transforms the input data x into a latent representation y, which is lower-dimensional and in an improved form for further compression.

To compress y further and transmit as a stream of bits, an established lossless encoding algorithm such as arithmetic encoding may be used. These lossless encoding algorithms may require y to be discrete, not continuous, and also may require knowledge of the probability distribution of the latent representation. To achieve this, a quantisation function Q (usually nearest integer rounding) is used to convert the continuous data into discrete values ŷ.

The necessary probability distribution p(ŷ) is found by fitting a probability distribution onto the latent space. The probability distribution can be directly learned, or as often is the case, is a parameteric distribution with parameters determined by a hyper-network consisting of a hyper-encoder and hyper-decoder. If using a hyper-network, an additional bitstream 2 (also known as “side information”) may be encoded, transmitted, and decoded:

$$z = {g}_{e n c} ( y , ϕ ) \qquad ( 2 a )$$

$$\hat{z} = Q ( z ) \qquad ( 2 b )$$

$$bitstream = AE ( \hat{z} , p ( \hat{z} ) ) \qquad ( 2 c )$$

$$\hat{z} = AD ( bitstream , p ( \hat{z} ) ) \qquad ( 2 d )$$

$${μ}_{y} , {σ}_{y} = {g}_{d e c} ( \hat{z} , ϕ ) \qquad ( 2 e )$$

where μ_{y}, σ_{ŷ} are the mean and scale parameters that determine the quantised latent distribution p(ŷ).

The encoding process (with a hyper-network) is depicted in FIG. 3, which shows a schematic of an example encoding phase of an AI-based compression algorithm, for video and image compression.

Decoding proceeds as follows:

$$\hat{y} = AD ( bistream , p ( \hat{y} ) ) \qquad ( 3 a )$$

$$\hat{x} = {f}_{d e c} ( \hat{y} , θ ) \qquad ( 3 b )$$

Summarising: the distribution of latents p(ŷ) is used in the arithmetic decoder (or other lossless decoding algorithm) to turn the bitstream into the quantised latents ŷ. Then a function f_{dec} transforms the quantised latents into a lossy reconstruction of the input data, denoted \hat{x}. In AI-based compression, f_{dec} is usually a neural network, depending on learned parameters θ.

If using a hyper-network, the side information bitstream is first decoded and then used to obtain the parameters needed to construct p(ŷ), which is needed for decoding the main bitstream. An example of the decoding process (with a hyper-network) is depicted in FIG. 4, which shows an example decoding phase of an AI-based compression algorithm, for video and image compression.

AI-based compression depends on learning parameters for the encoding and decoding neural networks, using typical optimisation techniques with a “loss function.” The loss function is chosen to balance the goals of compressing the image or video to small file sizes, while maximising reconstruction quality. Thus the loss function consists of two terms:

$$L = R ( p ( \hat{y} ) ) + λ D ( x , \hat{x} ) \qquad ( 4 )$$

Here R determines the cost of encoding the quantised latents according to the distribution p(ŷ), D measures the reconstructed image quality, and λ is a parameter that determines the tradeoff between low file size and reconstruction quality. A typical choice of R is the cross entropy

$$R = - {𝔼}_{x \sim p ( x )} [ log {p}_{\hat{y}} ( \hat{y} ) ] \qquad ( 5 a )$$

$${p}_{\hat{y}} ( \hat{y} ) = {P}_{y} ( \hat{y} + 1 / 2 ) - {P}_{y} ( \hat{y} - 1 / 2 ) \qquad ( 5 b )$$

The choice of p_{ŷ}(ŷ) is due to quantisation: the latents are rounded to the nearest integer, so the probability distribution of p(ŷ) is given by the integral of the (unquantised) latent distribution p(y) from ŷ−½ to ŷ+½, which is given in terms of the cumulative distribution function P(ŷ). The function D may be chosen to be the mean squared error, but can also be a combination of other metrics of perceptual quality, such as MS-SSIM, LPIPS, and/or adversarial loss (if using an adversarial neural network to enforce image quality).

If using a hyper-network, an additional term may be added to R to represent the cost of transmitting the additional side information:

$$R = R ( p ( \hat{y} ) ) + R ( p ( \hat{z} ) ) \qquad ( 6 )$$

Altogether, note that the loss function depends explicitly on the choice of quantisation scheme through the R term, and implicitly, because ŷ depends on the choice of quantisation scheme.

It will now be discussed how learned quantisation bins may be used in AI-based image and video compression. The steps discussed are:
Architectures needed to learn and predict quantisation bin sizes
Modifications to the standard quantisation function and encoding and decoding process to incorporate learned quantisation bins
Methods for training neural networks that use learned quantisation bins

A significant step in the typical AI-based image and video compression pipeline is “quantisation,” where the pixels of the latent representation are usually rounded to the nearest integer. This is required for the algorithms that losslessly encode the bitstream. However, the quantisation step introduces its own information loss, which impacts reconstruction quality.

It is possible to improve the quantisation function by training a neural network to predict the size of the quantisation bin that should be used for each latent pixel. Normally, the latents y are rounded to the nearest integer, which corresponds to a “bin size” of 1. That is, every possible value of ŷ in an interval of length 1 gets mapped to the same ŷ:

$$y ∈ [ round ( y ) - 1 / 2 , round ( y ) + 1 / 2 ) {⟶}^{Q} \hat{y} \qquad ( 7 )$$

However, this may not be the optimal choice of information loss: for some latent pixels, more information can be disregarded (equivalently: using bins larger than 1) without impacting reconstruction quality much. And for other latent pixels, the optimal bin size is smaller than 1.

This issue can be resolved by predicting the quantisation bin size, per image, per pixel. We do this with a tensor Δ∈ [symbol] ^{C}× [symbol] ^{H}× [symbol] ^{W}, which then modifies the quantisation function as follows:

$${\hat{ξ}}_{Y} = {Q}_{Δ} ( y ) = round ( \frac{y}{Δ} ) \qquad ( 8 )$$

We refer to ξ_{ŷ} the “quantised latent residuals.” Thus Equation 7 becomes:

$$y ∈ [ round ( y ) - Δ / 2 , round ( y ) + Δ / 2 ) {⟶}^{Q} {\hat{ξ}}_{Y} \qquad ( 9 )$$

indicating that values in an interval of length Δ get mapped to the same quantised latent value. FIG. 5 shows an example of a distribution of values for quantisation bin sizes that can be learned while training the AI-based compression pipeline.

FIG. 6 shows a heatmap indicating how the sizes of learned quantisation bins vary for a given image, across latent channels. Different pixels are predicted to benefit from larger or smaller quantisation bins, corresponding to larger or smaller information loss.

Note that because the learned quantisation bin sizes are incorporated into a modification of the quantisation function Q, any data that we wish to encode and transmit can make use of learned quantisation bin sizes. For example, if instead of encoding the latents ŷ, we wish to encode the mean-subtracted latents y−μ_{y}, this can be achieved:

$${\hat{ξ}}_{y} = {Q}_{Δ} ( y - {μ}_{y} ) = round ( \frac{y - {μ}_{y}}{Δ} ) \qquad ( 10 )$$

Similarly, hyperlatents, hyperhyperlatents, and other objects we might wish to quantise can all use the modified quantisation function Q_{Δ}, for an appropriately learned Δ.

Several architectures for predicting quantisation bin sizes will now be discussed. A possible architecture is predicting the quantisation bin sizes Δ using a hypernetwork. The bitstream is encoded as follows:

$${\hat{ξ}}_{y} = {Q}_{Δ} ( y ) = round ( \frac{y}{Δ} ) \qquad ( 11 a )$$

$$bitstream = AE ( {\hat{ξ}}_{y} ) \qquad ( 11 b )$$

where the division is element-wise. ξ_{y} is now the object that is losslessly encoded and sent as a bitstream (we refer to ξ_{y} as the quantised latent residuals).

An example of the modified encoding process using a hypernetwork is depicted in FIG. 7, which shows a schematic of an example encoding phase of an AI-based compression algorithm utilizing a hyperprior and learned quantisation bin sizes, for video and image compression.

When decoding, the bitstream is losslessly decoded as usual. We then use Δ to rescale ξ_{y} by multiplying the two element-wise. The result of this transformation is what is now denoted ŷ and passed to the decoder network as usual:

$${\hat{ξ}}_{y} = AD ( bitstream ) \qquad ( 12 a )$$

$$\hat{y} = Δ ⊙ {\hat{ξ}}_{y} \qquad ( 12 b )$$

$$\hat{x} = {f}_{d e c} ( \hat{y} , θ ) \qquad ( 12 c )$$

An example if the modified decoding process using a hypernetwork is depicted in FIG. 8, which shows a schematic of an example decoding phase of an AI-based compression algorithm utilizing a hyperprior and learned quantisation bin sizes, for video and image compression.

Applying the above techniques may lead to a 1.5 percent improvement in the rate of an AI based compression pipeline and and a 1.9 percent improvement in the distortion when measured by MSE. The performance of the AI based compression process is therefore improved.

We detail several variants of the above architectures which are of use:
Quantisation bins sizes for the hyperlatents can be learned parameters, or we can include a hyperhyper-network that predicts these variables.
Prediction of quantisation bin sizes can be augmented with a so-called “context module”—any function that uses neighboring pixels to improve predictions for a given pixel.
After obtaining the quantisation bin sizes Δ_{y} from the hyper decoder, this tensor can be processed further by an additional nonlinear function. This nonlinear function would in general be a neural network (but is not limited to this choice).

We also emphasise that our methods for learning quantisation bins are compatible with all ways of transmitting metainformation, such as hyperpriors, hyperhyperpriors, autoregressive models, and implicit models.

To train neural networks with learned quantisation bins for AI-based compression, we may modify the loss function. In particular, the cost of encoding data described Equation 5a may be modified as follows:

$$R = - {𝔼}_{x \sim p ( x )} [ log {p}_{\hat{y}} ( \hat{y} ) ] ⟶ {𝔼}_{x \sim p ( x )} [ log {p}_{{\hat{ξ}}_{y}} ( {\hat{ξ}}_{y} ) ] \qquad ( 13 a )$$

$${p}_{\hat{y}} ( \hat{y} ) = {P}_{y} ( \hat{y} + 1 / 2 ) - {P}_{y} ( \hat{y} - 1 / 2 ) ⟶ {P}_{{ξ}_{y}} ( {\hat{ξ}}_{y} + {Δ}_{y} / 2 ) - {P}_{{ξ}_{y}} ( {\hat{ξ}}_{y} - {Δ}_{y} / 2 ) \qquad ( 13 b )$$

The idea is that we need to integrate the probability distribution of latents from ξ_{y}−Δ_{y}/2 to ξ_{y}+Δ_{y}/2 instead of integrating over an interval of length 1.

Similarly, if using a hypernetwork, the term R_{Z}=− [symbol] _{x˜p(x)}[log p_{\hat{Z}}(\hat{Z})] corresponding to the cost of encoding the hyperlatents is modified in exactly the same way as the cost of encoding the latents is modified to incorporate learned quantisation bin sizes.

Neural networks are usually trained by variants of gradient descent, utilising backpropagation to update the learned parameters of the network. This requires computing gradients of all layers in the network, which in turn requires the layers of the network to be composed of differentiable functions. However, the quantisation function Q and its learned bins modification Q_{Δ} are not differentiable, because of the presence of the rounding function. In AI-based compression, one of two differentiable approximations to quantisation are used during training of the network to replace Q(y) (no approximation is used once the network is trained and used for inference):

$$Noise quantisation : {\tilde{y}}_{n o i s e} := y + ϵ , ϵ ∼ U ( - 1 / 2 , 1 / 2 ) , \qquad ( 14 a )$$

$$Straight - Through Estimator ( S T E ) quantisation : {\tilde{y}}_{STE} := round ( y ) , \qquad ( 14 b )$$

$$\frac{d \tilde{y}}{d y} = \frac{d y}{d y} = 1$$

When using learned quantisation bins, the approximations to quantisation during training are

$$Noise quantisation : {( {\tilde{ξ}}_{y} )}_{n o i s e} := y + Δ ⊙ ϵ , ϵ ∼ U ( - 1 / 2 , 1 / 2 ) , \qquad ( 15 a )$$

$$S T E quantisation : {( {\tilde{ξ}}_{y} )}_{STE} := round ( \frac{y}{Δ} ) , \frac{{d ( {\tilde{ξ}}_{y} )}_{STE}}{d y} = \frac{d}{d y} ( \frac{y}{Δ} ) \qquad ( 15 b )$$

Instead of choosing one of these differentiable approximations during training, AI-based compression pipelines can also be trained with “split quantisation,” where we use (\tilde{ξ}_{y})ₙₒᵢₛₑ when calculating the rate loss R, but we send (\tilde{ξ}_{y})_{STE} to the decoder in training. AI-based compression networks can be trained with both split quantisation and learned quantisation bins.

First, note that split quantisation comes in two flavours:
Hard Split Quantisation: Decoder receives (\tilde{ξ}_{y})_{STE}
Soft Split Quantisation: Decoder receives (\tilde{ξ}_{y})_{STE} in the forward pass, but (\tilde{ξ}_{y})ₙₒᵢₛₑ is used in the backward pass of backpropagation when calculating

$$\frac{d {\tilde{ξ}}_{y}}{d {ξ}_{y}}$$

Notice that with integer rounding quantisation, hard split and soft split quantisation are equivalent, because in the backward pass

$$\frac{d {\tilde{y}}_{n o i s e}}{d y} = \frac{d ( y + ϵ )}{d y} = 1 = \frac{d y}{d y} = \frac{d {\tilde{y}}_{S T B}}{d y} \qquad ( 16 )$$

However, hard split and soft split quantisation are not equivalent when using learned quantisation bins, because in the backward pass

$$\frac{{d ( {\tilde{ξ}}_{y} )}_{n o i s e}}{d y} = \frac{d ( y + Δ ⊙ ϵ )}{d y} = 1 + \frac{d Δ}{d y} ⊙ ϵ \neq \frac{1}{Δ} ( 1 - \frac{d Δ}{d y} ) = \frac{{d ( {\tilde{ξ}}_{y} )}_{S T E}}{d y} \qquad ( 17 a )$$

$$\frac{{d ( {\tilde{ξ}}_{y} )}_{n o i s e}}{d Δ} = \frac{d ( y + Δ ⊙ ϵ )}{d Δ} = ϵ \neq - \frac{1}{Δ} {ξ}_{y} = - \frac{y}{{Δ}^{2}} = \frac{{d ( {\tilde{ξ}}_{y} )}_{STE}}{d Δ} \qquad ( 17 b )$$

Now we examine loss function gradients in each quantisation scheme.

Rate gradients w.r.t. Δ are negative in every quantisation scheme:

$$\frac{d R}{d Δ} = \frac{\partial R}{\partial {\tilde{ξ}}_{y}} \frac{d {\tilde{ξ}}_{y}}{d Δ} + \frac{\partial R}{\partial Δ} \qquad ( 18 )$$

In every quantisation scheme, the rate term receives \tilde{ξ}ₙₒᵢₛₑ, so

$$\frac{d {\tilde{ξ}}_{y}}{d Δ} = ϵ .$$

Then we have

$$\begin{matrix}\frac{d R}{d Δ} & = - \frac{1}{{p}_{{\tilde{ξ}}_{y}} ( {\tilde{ξ}}_{y} ) σ} ( {p}_{ξ} ( \frac{{\tilde{ξ}}_{y} + Δ / 2}{σ} ) ( ϵ + 1 / 2 ) + {p}_{ξ} ( \frac{{\tilde{ξ}}_{y} - Δ / 2}{σ} ) ( 1 / 2 - ϵ ) ) & ( 19 a ) \\ & < 0 & ( 19 b )\end{matrix} \begin{matrix} & \end{matrix}$$

because ½−∈>0 always. So the rate gradients always Δ to increase Δ. Distortion gradients w.r.t. Δ differ by quantisation scheme. The gradients are

$$\frac{d D}{d Δ} = \frac{\partial D}{\partial {f}_{dec} ( {\tilde{ξ}}_{y} )} \frac{\partial {f}_{d e c} ( {\tilde{ξ}}_{y} )}{\partial {\tilde{ξ}}_{y}} \frac{\partial {\tilde{ξ}}_{y}}{\partial Δ} \qquad ( 20 )$$

In soft split quantisation,

$$\frac{\partial {\tilde{ξ}}_{y}}{\partial Δ} = ϵ$$

and E[\tilde{ξ}_{y}∈]=E[\tilde{ξ}_{y}]E[∈], because the random noise ∈ in the backward pass is independent of the STE rounding that makes \tilde{ξ}ŷ in the forward pass. This means that

$$\begin{matrix}E [ \frac{d D}{d Δ} ] & = E [ \frac{\partial D}{\partial {f}_{dec} ( {\tilde{ξ}}_{y} )} \frac{\partial {f}_{dec} ( {\tilde{ξ}}_{y} )}{\partial {\tilde{ξ}}_{y}} ϵ ] & ( 21 a ) \\ & = E [ \frac{\partial D}{\partial {f}_{dec} ( {\tilde{ξ}}_{y} )} \frac{\partial {f}_{d e c} ( {\tilde{ξ}}_{y} )}{\partial {\tilde{ξ}}_{y}} ] E [ ϵ ] & ( 21 b ) \\ & = 0 & ( 21 c )\end{matrix}$$

Therefore, in soft split quantisation, rate gradients drive Δ larger, while distortion gradients are on average 0, so overall Δ→∞ and training the network is not possible.

Conversely, in hard split quantisation

$$E [ \frac{\partial D}{\partial {f}_{dec} ( {\tilde{ξ}}_{y} )} \frac{\partial {f}_{dec} ( {\tilde{ξ}}_{y} )}{\partial {\tilde{ξ}}_{y}} \frac{\partial {\tilde{ξ}}_{y}}{\partial Δ} ] \neq E [ \frac{\partial D}{\partial {f}_{dec} ( {\tilde{ξ}}_{y} )} \frac{\partial {f}_{dec} ( {\tilde{ξ}}_{y} )}{\partial {\tilde{ξ}}_{y}} ] E [ \frac{\partial {\tilde{ξ}}_{y}}{\partial Δ} ] \qquad ( 22 )$$

because \tilde{ξ}_{ŷ} is not independent of

$$\frac{{d ( {\tilde{ξ}}_{y} )}_{STE}}{d Δ} .$$

Altogether, if using split quantisation with learned quantisation bins, we use hard split quantisation and not soft split quantisation.

The nontrivial distortion gradients that can be achieved with or without split quantisation mean that distortion gradients flow through the decoder and to the hypernetwork. This is normally not possible in models with a hypernetwork, but is a feature introduced by our methods for learning quantisation bin sizes.

In some compression pipelines it is important to control the distribution of values that are learned for the quantisation bin sizes (this is not always necessary). When needed, we achieve this by introducing an additional term into the loss function:

$$L = R + λ D + {F}_{Δ} \qquad ( 23 a )$$

$${F}_{Δ} = - {𝔼}_{x ∼ p ( x )} [ log {p}_{Δ} ( Δ ) ] \qquad ( 23 b )$$

F_{Δ} is characterised by the choice of distribution p_{Δ}(Δ), which we refer to as a “prior” on Δ, following terminology used in Bayesian statistics. Several choices can be made for the prior:
Any parametric probability distribution over positive numbers. In particular, the inverse gamma distribution, several examples of which are shown in FIG. 9. The distribution is shown for several values of its parameters. The parameters of the distribution can be fit from other models, chosen a priori, or learned during training.
A neural network that learns the prior distribution during training.

In the previous section, we give detailed descriptions of a simplistic quantisation function Q that makes use of a tensor of bin sizes Δ:

$${ξ}_{y} = round ( {Q}_{simple} ( y ) ) = round ( \frac{y}{Δ} ) \qquad ( 24 )$$

We can extend all of these methods to more generalised quantisation functions. In the general case Q is some invertible function of ŷ and Δ. Then encoding is given by:

$${ξ}_{y} = round ( {Q}_{g eneral} ( y , Δ ) ) \qquad ( 25 )$$

and decoding is achieved by

$$\hat{y} = {Q}_{g eneral}^{- 1} ( {ξ}_{y} , Δ ) \qquad ( 26 a )$$

$$\hat{x} = {f}_{dec} ( \hat{y} ) \qquad ( 26 b )$$

This quantisation function is more flexible than Equation 24, resulting in improved performance. The generalised quantisation function can also be made context-aware e.g. by incorporating quantisation parameters that use an auto-regressive context model.

All methods of the previous section are still compatible with the generalised quantisation function framework:
We predict the necessary parameters from hypernetworks, context modules, and implicit equations if needed.
We modify the loss function appropriately.
We employ hard split quantisation if using split quantisation.
We introduce Bayesian priors on A in the loss function to control its behaviour as necessary.

The more flexible generalised quantisation functions improve performance. In addition to this, the generalised quantisation function can depend on parameters that are determined auto-regressively, meaning that quantisation depends on pixels that have already been encoded/decoded:

$${\hat{ξ}}_{i} = Q ( {\hat{ξ}}_{j} , Δ ) , j < i \qquad ( 27 )$$

$${\hat{y}}_{i} = {Q}^{- 1} ( {\hat{y}}_{j} , Δ ) , j < i \qquad ( 28 )$$

In general, using auto-regressive context models improves AI-based compression performance.

Auto-regressive Generalised Quantisation Functions are additionally beneficial from a runtime perspective. Other standard auto-regressive models such as PixelCNN require executing the arithmetic decoder (or other lossless decoder) each time a pixel is being decoded using the context model. This is a severe performance hit in real-world applications of image and video compression. However, the Generalised Quantisation Function framework allows is to incorporate an auto-regressive context model into AI-based compression, without the runtime problems of e.g. PixelCNN. This is because Q⁻¹ acts auto-regressively on \tilde{ξ}, which is fully decoded from the bitstream. Thus the arithmetic decoder does not need to be run auto-regressively and the runtime problem is solved.

The generalised quantisation function can be any invertible function. For example:
Invertible Rational Functions: Q(·, Δ)=P(·, Δ)/Q(·, Δ), where P, Q are polynomials.
Functions of Logarithms, Exponentials, trigonometric functions, with suitably restricted domains so that these functions are invertible.
Invertible functions of matrices Q(·, Δ)
Invertible functions that include context parameters L predicted by the hyper-decoder: Q(·, Δ, L)

Furthermore, Q in general need not have a closed form, or be invertible. For example, we can define Q_{enc} (·, Δ) and Q_{dec} (·, Δ) where these functions are not necessarily inverses of each other and train the whole pipeline end-to-end. In this case, Q_{enc} and Q_{dec} could be neural networks, or modelled as specific processes such as Gaussian Processes, Probabilistic Graphical Models (simple example: Hidden Markov Models).

To train AI-based Compression pipelines that use Generalised Quantisation Functions, we use many of the same tools as described above:
Modify the loss function appropriately (in particular the rate term)
Use hard split quantisation if using split quantisation
Introduce Bayesian priors and/or regularisation terms (l₁, l₂, second moment penalties) into the loss function as necessary to control the distribution parameters A, and if needed, the distribution of context parameters L.

Depending on the choice of Generalised Quantisation Function, other tools become necessary for training the AI-based compression pipeline:
Techniques from Reinforcement Learning (Q-Learning, Monte Carlo Estimation, DQN, PPO, SAC, DDPG, TD3)
General Proximal Gradient Methods
Continuous Relaxations. Here the discrete Quantisation residuals are approximated by a continuous function. This function can have hyperparameters which control how smooth the function is, which are modified at various points in training to improve network training and final performance.

There are several possibilities for context modelling that are compatible with the Generalised Quantisation Function framework:
Q can be an auto-regressive neural network. The most common example of this that can be adapted to Q is a PixelCNN-style network, but other neural network building blocks such as Resnets, Transformers, Recurrent Neural Networks, and Fully-Connected networks can be used in an auto-regressive Q function.
Δ can be predicted as some linear combination of previously-decoded pixels:

$${Δ}_{i} = {\sum }_{j = 1}^{i - 1} {L}_{i j} {\hat{y}}_{j} \qquad ( 29 )$$

Here L is a matrix that can be given a particular structure depending on desired context. For example L could be banded, upper/lower triangular, sparse, only non-zero for n elements preceding the current position being decoded (in raster-scan order).

If we obtain important metainformation e.g. from an attention mechanism/focus mask we can incorporate this into Δ predictions. In this case, the size of quantisation bins adapts even more precisely to sensitive areas of images and videos, where knowledge of the sensitive regions is stored in this metainformation. In this way, less information is lost from perceptually important regions, while performs gains result from disregarding information from unimportant regions, in an enhanced way compared to AI-based compression pipelines that do not have adaptable bin sizes.

We further outline a connection between learned quantisation bins and variable rate models: one form of variable rate models trains an AI-based compression pipeline with a free hyperparameter δ controlling bin sizes. At inference time, δ is transmitted as metainformation to control the rate (cost in bits) of transmission−lower delta means small bins and larger transmission cost, but better reconstruction quality.

In the variable rate framework, δ is a global parameter in the sense that it controls all bin sizes simultaneously. In our innovation, we obtain the tensor of bin sizes Δ locally, that is predicted per pixel, which is an improvement. In addition, variable rate models that use δ to control the rate of transmission are compatible with our framework, because we can scale the local prediction element-wise by the global prediction as needed to control the rate during inference:

$${Δ}_{local + globa1} = δ Δ \qquad ( 30 )$$

### Dataset Bias

In this section we detail a collection of training procedures applied to the generative adversarial networks framework, which allows us to control the bit allocation for different areas in the images depending on what is depicted in them. This approach allows us to bias a generative compression model to any type of image data and control the quality of the resulting images based on the subject in the image.

General adversarial networks (GANs) have shown excellent results when applied to a variety of different generative tasks in the image, video and audio domains. The approach is inspired by the game theory in which two model, a generator and a critic, are pitted against each other, making both of them stronger as a result. The first model in GAN is a Generator G that takes a noise variable input z and outputs a synthetic data sample \hat{x}; the second model is a discriminator D that is trained to tell the difference between samples from the real data distribution and the data, generated by the generator. An example overview of the architecture of a GAN is shown in FIG. 10.

Let us denote pₓ as data distribution over real sample x; μ_{Z}−data distribution over the noise sample Z and p_{g}—the generators distribution over the data x.

Training a GAN is then presented as a minimax game where the following function is optimised:

$${min}_{G} {max}_{D} L ( D , {f}_{θ} ) = {E}_{x ∼ {p}_{x}} [ log ( D ( x ) ) ] + {E}_{z ∼ {p}_{z}} [ log ( 1 - D ( G ( z ) ) ] \qquad ( 31 )$$

Adapting the generative adversarial approach for the image compression task, we begin by considering an image x∈ [symbol] ^{C×H×W}, where C is the number of channels, H and W are height and width in pixels.

The Compression encoder pipeline based on an autoencoder consists of and Encoder function f_{θ}(x)=ŷ that encodes the image \hat{x} into latent representation

$$\hat{y} ∈ {ℝ}^{\frac{C}{4} \times \frac{H}{4} \times \frac{W}{4}} ;$$

Q is a quantisation function required for sending ŷ as a bitstream, and Decoder function g_{θ}(ŷ)=\hat{x} that decodes quantised latents ŷinto reconstructed image \hat{x}∈ [symbol] ^{C×H×W}:

$${f}_{θ} ( x ) = y \qquad ( 32 )$$

$$Q ( y ) = \hat{y}$$

$${g}_{θ} ( \hat{y} ) = \hat{x}$$

In this case, a combination of encoder f_{θ}, quantisation function Q and decoder g_{θ} can be thought of together as a generative network. For simplicity of notation we denote this generative network as G(x). The generative network is complemented with a discriminator network D that is training in conjunction with the generative network in a two-stage manner.

$$G ( x ) := {g}_{θ} ( Q ( {f}_{θ} ( x ) ) ) \qquad ( 33 )$$

$$\hat{x} = G ( x )$$

An example of a standard generative adversarial compression pipeline is shown in FIG. 11. Training is then performed using a standard compression rate-distortion loss function:

$${ℒ}_{comp} = {E}_{x ∼ {p}_{x}} [ {λ}_{rate} r ( \hat{y} ) + d ( x , G ( x ) ) ] , \qquad ( 34 )$$

where pₓ is a distribution of natural images, r(ŷ) is a rate measured using an entropy model, λᵣₐₜₑ is a Lagrangian multiplier controlling the balance between rate and distortion, and d(x, \hat{x}) is a distortion measure.

Complementing this learned compression network with a discriminator model may improve the perceptual quality of the output images. In this case, the compression encoder-decoder network can be viewed as a generative network and the two models can be then trained using a bi-level approach at each iteration. For the discriminator architecture, we chose to use a conditional discriminator shown to produce better quality reconstructed imaged. The discriminator d(x, ŷ), in this case, is conditioned on the quantised latent ŷ. We begin by training the discriminator with discriminator loss:

$${ℒ}_{disc} ( x , \hat{y} ) = {E}_{x ∼ {p}_{x}} [ - log ( 1 - D ( G ( x ) , \hat{y} ) ] + {E}_{x ∼ {p}_{x}} [ - log ( D ( x , \hat{y} ) ) ] . \qquad ( 35 )$$

To train the generative network in (32) we augment the rate-distortion loss in (36) by adding a adversarial “non-saturating” loss used for training generators in GAN:

$${ℒ}_{comp} ( x , \hat{y} ) = {E}_{x ∼ {p}_{x}} [ {λ}_{rate} r ( \hat{y} ) + d ( x , G ( {x}_{i} ) ) - {λ}_{adv} D ( G ( x ) , \hat{y} ) ] . \qquad ( 36 )$$

Adding adversarial loss into the rate-distortion loss encourages the network to produce natural-looking patterns and textures. Using the architecture that combines GANs with autoencoders allowed for excellent results in image compression with substantial improvements in the perceptual quality of the reconstructed images. However, despite the great overall results of such architectures, there is a number of notable failure modes. It has been observed that these models struggle compressing regions of high visual importance which include, but are not limited to, human faces or text. An example of such a failure mode is exhibited in FIG. 12, where the left image is an original image and the right image is a reconstructed image synthesised using a generative compression network. Note that the most distortions appear in human faces present in the image—areas of high visual information. To address this issue we propose a method that allows to bias the model on the particular type of images, such as faces, improving the perceptual quality of reconstructed images.

Under this framework we train the network on multiple datasets with a separate discriminator for each of them. We start by selecting N additional datasets X₁, . . . X_{N} on which the model is biased. A good example of one such dataset that helps with modelling faces would be a dataset that consists of portraits of people. For each dataset Xᵢ, we introduce a discriminator model Dᵢ. Each of the discriminator models Dᵢ is trained only on data from the dataset Xᵢ, while the Encoder-Decoder model is trained on images from all the datasets.

$${ℒ}_{{disc}_{i}} ( {x}_{i} , {\hat{y}}_{i} ) = {E}_{{x}_{i} ∼ {p}_{{x}_{i}}} [ - log ( 1 - {D}_{i} ( G ( {x}_{i} ) , {\hat{y}}_{i} ) ] + {E}_{{x}_{i} ∼ {p}_{{x}_{i}}} [ - log ( {D}_{i} ( {x}_{i} , {\hat{y}}_{i} ) ) ] \qquad ( 37 )$$

$${ℒ}_{{comp}_{i}} ( {x}_{i} , {\hat{y}}_{i} ) = {E}_{{x}_{i} ∼ {p}_{{x}_{i}}} [ {λ}_{rate} r ( \hat{{y}_{i}} ) + d ( {x}_{i} , G ( {x}_{i} ) ) - {λ}_{adv} {D}_{i} ( G ( {x}_{i} ) , {\hat{y}}_{i} ) ]$$

where xᵢ is an image from dataset Xᵢ, yᵢ—latent representation of the image xᵢ, G(xᵢ) is a reconstructed image and pₓ_{ᵢ}—a distribution of images in dataset Xᵢ.

An illustration of a compression pipeline with multi-discriminator cGAN training with dataset biasing is shown in FIG. 13. An image xᵢ from dataset Xᵢ is passed through an encoder, quantised and turned into a bitstream using a range coder. The decoder then decodes the bitstream and attempts to reconstruct \hat{x}ᵢ. The original image \hat{x} and the reconstruction \hat{x} are then passed to the discriminator that corresponds to the dataset i.

For illustration purposes, we focus our attention on the failure mode of faces, as previously demonstrated in FIG. 12. Note that all discussed techniques are applicable to arbitrarily many regions-of-interest in an image—for example, text or animal faces, eyes, lips, logos, cars, flowers and patterns.

As an example, consider a dataset biasing using just one extra dataset. In this case, X₁—general training dataset and X₂—dataset with portrait images only. Comparison between the reconstructions of the same generative model trained to the same bitrate with and without multi-discriminant dataset biasing scheme are presented in FIG. 14, where the left image is a reconstruction of an image synthesised by a standard generative compression network and the right image is a reconstruction of the same image synthesised by a the same generative network trained using multi-discriminator dataset biasing. Using the scheme results in higher perceptual quality of the human faces with no detriment to the quality of the rest of the image.

Algorithm 1 Pseudocode that outlines the training of the
compression pipeline with data biasing for specific case of biasing
the model with a dataset of face images. It assumes the existence
of 2 functions backpropagate and step. backpropagate will use
backpropagation to compute gradients of all parameters with
respect to the loss. step performs an optimization step with the
selected optimizer. T - number of training steps.

```
Inputs:
General dataset: X
Face dataset: X_{face}
Encoder Network: f_{θ}
Decoder Network: g_{θ}
Encoder-Decoder Optimizer: opt_{f}_{_{θ}}
Quantisation function: Q(y)
Face dataset Discriminator Network: D_{f}
General dataset Discriminator Network: D
General dataset Discriminator Optimizer: opt_{D}
Face dataset Discriminator Optimizers: opt_{D}_{_{f}}
Dataset bias Training:
for t = 1 : T :
  General dataset training:
draw sample x from dataset X
y ← f_{θ}(x)
ŷ ← Q(y)
\hat{x} ← g_{θ}(ŷ)
dᵣₑₐₗ ← D(x, ŷ)
d_{fake} ← D(\hat{x}, ŷ)
    General Discriminator Training:
L_{disc} ← [symbol]   _{disc} (dᵣₑₐₗ, d_{fake})
backpropagate (L_{disc})
step(opt_{D}_{_{f}})
    Generator Training:
d_{fake} ← D(\hat{x}, ŷ)
L_{f}_{_{θ}} ← [symbol]   _{distortion}(\hat{x}, x) + [symbol]   ᵣₐₜₑ(ŷ) + [symbol]   _{gen}(d_{fake})
backpropagate (L_{f}_{_{θ}})
step(opt_{f}_{_{θ}})
  Face dataset training:
draw sample x_{f} from dataset X_{face}
y ← f_{θ}(x_{f})
ŷ ← Q(y)
\hat{x} ← g_{θ}(ŷ)
dᵣₑₐₗ ← D_{f}(x, ŷ)
d_{fake} ← D_{f}(\hat{x}, ŷ)
Face Discriminator Training:
L_{disc} ← [symbol]   _{disc} (dᵣₑₐₗ, d_{fake})
backpropagate(L_{disc})
step(opt_{D}_{_{f}})
    Generator Training:
d_{fake} ← D_{f}(\hat{x}, ŷ)
L_{f}_{_{θ}} ← [symbol]   _{distortion}(x, \hat{x}) + [symbol]   ᵣₐₜₑ(ŷ) + [symbol]   _{gen}(d_{fake})
backpropagate (L_{f}_{_{θ}})
step(opt_{f}_{_{θ}})
```

Algorithm 2 Pseudocode that outlines the training of the compression
pipeline with data biasing. It assumes the existence of 2 functions
backpropagate and step. backpropagate will use backpropagation to
compute gradients of all parameters with respect to the loss. step
performs an optimization step with the selected optimizer. N - number
of datasets used for training biasing. T - number of training steps.

```
Inputs:
Number of datasets used for training biasing: N
Dataset: Xi, i = 1..N
Encoder Network: f_{θ}
Decoder Network: g_{θ}
Encoder-Decoder Optimizer: opt_{f}_{_{θ}}
Quantisation function: Q(y)
Discriminator Networks: Dᵢ, i = 1..N
Discriminator Optimizers: opt_{D}_{ᵢ}, i = 1..N
Dataset bias Training:
for t = 1 : T :
for i = 1 : N :
draw sample xᵢ from dataset Xᵢ
y ← f_{θ}(xᵢ)
ŷ ← Q(y)
\hat{x} ← g_{θ}(ŷ)
dᵣₑₐₗ ← Dᵢ(x, ŷ)
d_{fake} ← Dᵢ(\hat{x}, ŷ)
Discriminator Training:
L_{disc} ← [symbol]   _{disc}(dᵣₑₐₗ, d_{fake})
backpropagate(L_{disc})
step(opt_{D}_{ᵢ})
  Generator Training:
d_{fake} ← Dᵢ(\hat{x}, ŷ)
  L_{f}_{_{θ}} ← [symbol]   _{distortion}(x, \hat{x}) + [symbol]   ᵣₐₜₑ(ŷ) + [symbol]   _{gen}(d_{fake})
backpropagate(L_{f}_{_{θ}})
step(opt_{f}_{_{θ}})
```

The approach described above can also be used in an architecture where a single discriminator is used for all the datasets. Additionally, the discriminator Dᵢ for a specific dataset can be trained more often than the generator, increasing the effects of biasing on that datasets.

Given a generative compression network as described above, we now define architectural modifications that permit higher bit allocation, conditioned on image or frame context. To increase the effect of dataset biasing and change the perceptual quality of different areas of the image depending on the image's subject we propose a training procedure in which the Lagrangian coefficient that controls bitrate differs for each dataset Xᵢ. The generator changing the loss function in (37) to

$${ℒ}_{{comp}_{i}} ( x , \hat{y} ) = {E}_{x ∼ {p}_{x}} [ {λ}_{rate}^{i} r ( \hat{y} ) + d ( x , G ( {x}_{i} ) ) - {λ}_{adv} {D}_{i} ( G ( {x}_{i} ) , \hat{y} ) ] . \qquad ( 38 )$$

This approach trains the model in assigning a higher percentage of the bitstream for the face regions of the compressed images. The results of the bitrate adjusted dataset biasing can be observed in FIG. 15 that shows three images synthesised by the models trained with different λⁱᵣₐₜₑ for the background dataset, while maintaining the same λⁱᵣₐₜₑ for the face dataset. The left image was trained with a low bitrate for the background dataset, the middle image a medium bitrate and the right image a high bitrate.

Extending the method proposed above, we propose using different distortion functions d(x, \hat{x}) for different datasets used for biasing. This method allows us to adjust the focus of the model to each particular type of data. For example, we can use a linear combination of MSE, LPIPS and MS-SSIM metrics as our distortion function.

$${d}_{i} ( x , \hat{x} ) = {λ}_{MSE}^{i} MSE + {λ}_{LPIPS}^{i} LPIPS + {λ}_{MS - SSIM}^{i} MS - SSIM + … \qquad ( 39 )$$

Changing the coefficients λⁱ_{MSE}, λⁱ_{LPIPS}, λⁱ_{MS-SSIM} . . . of different components of the distortion function may change the perceptual quality of the resulting images allowing the generative compression model to reconstruct different areas of the image in different ways. Then, equation 37 can be modified by indexing the distortion function d(x, \hat{x}) for each of the datasets Xᵢ:

$${ℒ}_{{comp}_{i}} ( x , \hat{y} ) = {E}_{x ∼ {p}_{x}} [ {λ}_{rate}^{i} r ( \hat{y} ) + {d}_{i} ( x , G ( {x}_{i} ) ) - {λ}_{adv} {D}_{i} ( G ( {x}_{i} ) , \hat{y} ) ] . \qquad ( 40 )$$

We now discuss utilising salience (attention) masks to bias the generative compression model to the areas that are particularly important in the image. We propose generating these masks using a separate pre-trained network, the output of which can be used to further improve the performance of the compression model.

Begin by considering a network H that takes image \hat{x} as an input and outputs a binary mask m∈ [symbol] ^{H×W}:

$$H ( x ) = m . \qquad ( 41 )$$

Salient pixels in xᵢ are indicated by ones in m and zeros indicate areas that the network does not need to focus on. This binary mask can be used to further bias the compression network to the area. Examples of such important areas include, but not limited to, human facial features such as eyes and lips. Given m we can modify the input image \hat{x} so it prioritises these areas. The modified image x^{H} is then used as an input into the adversarial compression network. An example of such a compression pipeline is shown in FIG. 16.

Extending the approach proposed above we propose an architecture that makes use of the pre-trained network that produces salience mask to bias a compression pipeline. This approach allows for changing the bit-rate allocation to the various parts of the reconstructed images by changing the mask, without retraining the compression network. In this variation, the mask m from equation 41 is used as additional input to train the network to allocate more bits to the areas marked as salient (one) in m. At the inference stage, after the network is trained, bit-allocation can be adjusted by modifying the mask m. An example of such a compression pipeline is shown in FIG. 17.

We further propose a training scheme that ensures that the model is exposed to examples from a wide range of natural images. The training dataset is constructed out of images from N different classes, with each image being label accordingly. During training, the images are sampled from the datasets according to the class. By sampling equally from each class, the model may be exposed to underrepresented classes and is able to learn the whole distribution of natural images.

### Region Enhancement

Modern methods of learned image compression, such as VAE and GAN based architectures, allow for excellent compression with small bitrates and substantial improvements in the perceptual quality of the reconstructed images. However, despite the great overall results of such architectures, there is a number of notable failure modes as discussed above. It has been observed that these models struggle compressing regions of high visual importance, which include, but are not limited to, human faces or text. An example of such a failure mode is exhibited in FIG. 12, where the left image shows an original image and the right image shows a reconstructed image synthesised using a generative compression network. Note that the most distortions appear in human faces present in the image—areas of high visual importance.

We propose an approach that allows increasing the perceptual quality of a region of interest (ROI) by allocating more bits for in the bitstream by changing the quantisation bin in the ROI.

To encode the latent ŷ into a bitstream, we first may quantise it to ensure that it is discrete. We propose to use a quantisation parameter Δ to control the bpp allocated to the area. Δ is quantisation bin size or quantisation interval, which represents the coarseness of quantisation in our latent and hyperlatent space. The coarser the quantisation, the fewer bits are allocated to data.

Quantisation of the latent y is then achieved as follows:

$$\hat{y} = round ( \frac{y - μ}{Δ} ) Δ + μ . \qquad ( 42 )$$

We propose to utilise spatially varied delta to control the coarseness of the quantisation in the image. This allows us to control the number of allocated bits and the visual quality of different areas of the image. This proceeds as follows.

Begin by considering a function H, usually represented by a neural network, that detects the regions of interest. Function H(s) takes an image \hat{x} as an input and outputs a binary mask m∈ [symbol] ^{H×W}. A one in m indicates that the corresponding pixel of the image \hat{x} lies within a region of interest, and a zero correspond to the pixel lying outside of it.

In one instance, the network H(x) is trained prior to training the compression pipeline, and in another, it is trained in conjunction with the Encoder-Decoder. Map m is used for creating a quantisation map Δ where each pixel is assigned a quantisation parameter. If the value in m for a certain pixel is one, the corresponding value in Δ is small. Function Q, defined in eqn. 42 then uses the spatial map Δ to quantise y into ŷ before encoding it into bitstream. The result of such a quantisation scheme is a higher bitrate for the regions of interest compared to the rest of the image.

The proposed pipeline is illustrated in FIG. 18. FIG. 18 shows an illustration of a proposed compression pipeline with a quantisation utilising a quantisation map Δ that depends on the binary mask of ROI m. The result of implementing such pipeline with the face detector used for identifying regions of interest, network H(x) is demonstrated in FIG. 19, where the left image is a compressed image synthesised with the faces allocated as ROI in quantisation map Δ and the right image is a compressed image with the standard generative compression model.

In another instance, we may utilise a different quantisation function Qₘ for areas identified with ROI detection network H(x) from eqn. 41. An example of such an arrangement is shown in FIG. 20, which shows an illustration of a proposed compression pipeline with a quantisation function Q for the overall image and Qₘ for the region of interest.

### Discrete PMFS

Encoding and decoding a stream of discrete symbols (such as the latent pixels in an AI-based compression pipeline) into a binary bitstream may require access to a discrete probability mass function (PMF). However, it is widely believed that training such a discrete PMF in an AI-based compression pipeline is impossible, because training requires access to a continuous probability distribution function (PDF). As such, in training an AI-based compression pipeline, the de facto standard is to train a continuous PDF, and only after training is complete, approximate the continuous PDF with a discrete PMF, evaluated at a discrete number of quantization points.

Described below is a inversion of this procedure, in which a AI-based compression pipeline may be trained on a discrete PMF directly, by interpolating the discrete PMF to a continuous, real-valued space. The discrete PMF can be learned or predicted, and can also be parameterized.

The following description will outline the functionality, scope and future outlook of discrete probability mass functions and interpolation for usage in, but not limited to, AI-based image and video compression. The following provides a high-level description of discrete probability mass functions, a description of their use in inference and training AI-based compression algorithms, and methods of interpolating functions (such as discrete probability mass functions)

In the AI-based compression literature, the standard approach to creating entropy models is to start with a continuous probability density function (PDF) p_{y} (y) (such as the Laplace or Gaussian distributions). Now because Shannon entropy may be only defined on discrete variables ŷ (usually ŷ∈ [symbol] ), this PDF should be turned into a discrete probability mass function (PMF) p_{ŷ}(ŷ), for use, for example, by a lossless arithmetic encoder/decoder. This may be done by gathering up all the (continuous) mass inside a (unit) bin centred at ŷ:

$${p}_{\hat{y}} ( \hat{y} ) = {\int }_{\hat{y} - \frac{1}{2}}^{\hat{y} + \frac{1}{2}} p ( y ) dy \qquad ( 43 )$$

This is approach was first proposed in Johannes Ballè, Valero Laparra, and Eero P. Simoncelli. End-to-end optimized image compression. In 5th International Conference on Learning Representations, ICLR 2017, Toulon, France, Apr. 24-26, 2017, Conference Track Proceedings. OpenReview.net, 2017, which is hereby incorporated by reference. This function is not just defined on the integers ŷ∈ [symbol] and will accept any real-valued argument. This may be quite convenient during training, where a PDF over the continuous, real-valued latents outputted by the encoder is still needed. Therefore, a “new” function p_{\tilde{y}}(\tilde{y}):=p_{ŷ}(\tilde{y}), will be defined, which, by definition, perfectly agrees the PMF p_{ŷ} defined on the integers. This function p_{\tilde{y}} is the PMF that an end-to-end AI-based compression algorithm is actually trained with.

To summarize: a continuous real-valued PDF p_{y} (y∈ [symbol] ) is turned into a discrete PMF p_{ŷ} (ŷ∈ [symbol] ), which is then evaluated as a continuous PDF p_{\tilde{y}} during training (y∈ [symbol] ). FIG. 21 shows an example of the three typical one-dimensional distributions that may be used in training an AI-based compression pipeline. Note that in practice, the original PDF p_{y} is never explicitly used, neither during training nor in inference. Practically, the only two functions used are p_{ŷ}(used in inference) and p_{\tilde{y}}(used in training).

This thinking model may be reversed. Rather than starting from a PDF, instead it is possible to begin with a discrete PMF, and recover a continuous PDF (which only be used in in training), by interpolating the PMF.

Suppose we are given a PMF p_{ŷ}. We can represent this PMF using two vectors of length N, namely ŷᵢ, and \hat{p}ᵢ, where i=1 . . . N indexes the discrete points. In the old thinking model (when the PMF is defined through a function), we'd define \hat{p}ᵢ=p_{ŷ}(ŷᵢ). However in general the \hat{p}ᵢ's could be any non-negative vector that sums to one. The vector yᵢ should be sorted, in ascending order, and does not necessarily need to have integer-values.

Now, suppose we are given a query point \tilde{y}∈[ŷ₀, ŷ_{N}]. Note that the query point must be bounded by the extremes of the discrete points. To define (an approximate) training PDF f(\tilde{y}), we use an interpolation routine

$$f ( y ) = interp ( {\hat{y}}_{i} , {\hat{p}}_{i} , y ) \qquad ( 44 )$$

There are many different interpolation routines available. A non-exhaustive list of possible interpolating routines is:
piecewise constant interpolation (nearest-neighbour)
linear interpolation
polynomial interpolation
spline interpolation, such as piecewise cubic interpolation
Gaussian processes/Kriging

In general, the function so defined via interpolation may not exactly be a PDF. Depending on the interpolation routine used, the interpolated value may be negative or may not have unit mass. However, these problems can be mitigated by choosing a suitable routine. For example, piecewise linear interpolation may preserve mass and preserve positivity, which ensures the interpolated function is actually a PDF. Piecewise cubic Hermite interpolation can be constrained to be positive, if the interpolating points themselves are positive as discussed in Randall L Dougherty, Alan S Edelman, and James M Hyman. Nonnegativity-, monotonicity-, or convexity-preserving cubic and quintic hermite interpolation. Mathematics of Computation, 52(186):471-494, 1989, which is hereby incorporated by reference.

However, piecewise linear interpolation can suffer from other problems. Its derivatives are piecewise constant, and the interpolation error can be quite bad, for example as shown in the left image of FIG. 22. For example, when the PMF is generated using Ballè's approach, the interpolation error would be defined as ∥f(\tilde{y})−p_{\tilde{y}}(\tilde{y})∥. Other interpolation schemes, such as piecewise Cubic Hermite interpolation, have much smaller interpolation errors for example shown in the right image of FIG. 22.

A discrete PMF can be trained directly in an AI-based image and compression algorithm. To achieve this in training, the probability values of real-valued latent, outputted by an encoder, are interpolated using the discrete values of the PMF model. In training the PMF is learned by passing gradients from the rate (bitstream size) loss backwards through to the parameters of the PMF model.

The PMF model could be learned, or could be predicted. By learned, we mean that the PMF model and it's hyper-parameters could be independent of the input image. By predicted, we mean that the PMF model could conditionally depend on ‘side-information’ such as information stored hyper-latents. In this scenario, the parameters of the PMF could be predicted by a hyper-decoder. In addition, the PMF could conditionally depend on neighbouring latent pixels (in this case, we'd say the PMF is a discrete PMF context model). Irregardless of how the PMF is represented, during training the values of the PMF may be interpolated to provide estimates of the probability values at real-valued (non-quantized) points, which may be fed into the rate loss of the training objective function.

The PMF model could be parameterized in any one of the following ways (though this list is non-exhaustive):
the PMF could be a categorical distribution, where probability values of the categorical distribution correspond to a finite number of quantization points on the real line.
a categorical distribution could have it's values parameterized by a vector, the vector being projected onto the probability simplex. The projection could be done via a soft-max style projection, or any other projection onto the probability simplex.
the PMF could be parameterized via a few parameters. For example if the PMF is defined over N points, then only n (with n<N) parameters could be used to control the values of the PMF. For example, the PMF could be controlled by a mean and scale parameter. This could be done for example by collecting mass of a continuous valued one-dimensional distribution at a discrete number of quantization bins.
the PMF could be multivariate, in which case the PMF would be defined over a multi-dimensional set of quantization points.
for any of the previous items, the quantization points could for example be a number of integer values, or could be arbitrarily spaced. The spacing of the quantization bins could be predicted by an auxillary network such as a hyper-decoder, or be predicted from context (neighbouring latent pixels).
for any of the previous items, the parameters controlling the PMF could be fixed, or could be predicted by an auxillary network such as a hyper-decoder, or be predicted from context (neighbouring latent pixels).

This framework can be extended in any one of several ways. For instance, if the discrete PMF is multivariate (multi-dimensional), then a multivariate (multi-dimensional) interpolation scheme could be used to interpolate the values of the PMF to real vector-valued points. For instance, multi-linear interpolation could be used (bilinear in 2d; trilinear in 3d; etc). Alternately, multi-cubic interpolation could be used (bicubic in 2d; tricubic in 3d; etc).

This interpolation method is not constrained to only modeling discrete valued PMFs. Any discrete valued function can be interpolated, anywhere in the AI-based compression pipeline, and the techniques described here-in are not strictly limited to modeling probability mass/density functions.

### Context Models

In AI-based compression, autoregressive context models have powerful entropy modeling capabilities, yet suffer from very poor run-time, due to the fact that they must be run in serial.

This document describes a method for overcoming this difficulty, by predicting autoregressive modeling components from a hyper-decoder (and conditioning these components on “side” information). This technique yields an autoregressive system with impressive modeling capabilities, but which is able to run in real-time. This real-time capability is achieved by detaching the autoregressive system from the model needed by the lossless decoder. Instead, the autoregressive system reduces to solving a linear equation at decode time, which can be done extremely quickly using numerical linear algebra techniques. Encoding can be done quickly as well by solving a simple implicit equation.

This document outlines the functionality and scope of current and future utilization of autoregressive probability models with linear decoding systems for use in, but not limited to, image and video data compression based on AI and deep learning.

In AI-based image and video compression, an input image \hat{x} is mapped to a latent variable ŷ. It is this latent variable which is encoded to a bitstream, and set to a receiver who will decoded the bitstream back into the latent variable. The receiver then transforms the recovered latent back into a representation (reconstruction) \hat{x} of the original image.

To perform the step of transforming the latent into a bitstream, the latent variable may be quantized into an integer-valued representation ŷ. This quantized latent ŷ is transformed into the bitstream via a lossless encoding/decoding scheme, such as an arithmetic encoder/decoder or range encoder/decoder.

Lossless encoding/decoding schemes may require a model one-dimensional discrete probability mass function (PMF) for each element of the latent quantized variable. The optimal bitstream length (file-size) is achieved when this model PMF matches the true one-dimensional data-distribution of the latents.

Thus, file-size is intimately tied to the power of the model PMF to match the true data distribution. More powerful model PMFs yield smaller file-sizes, and better compression. As the case may be, this in turn yields better reconstruction errors (as for a given file-size, more information can be sent for reconstructing the original image). Hence, much effort has gone into developing powerful model PMFs (often called entropy models).

The typical approach for modeling one-dimensional PMFs in AI-based compression is to use a parametric one-dimensional distribution, P(Y=ŷᵢ|θ), where θ are the parameters of the one-dimensional PMF. For example a quantized Laplacian or quantized Gaussian could be used. In these two examples, θ comprises the location μ and scale σ parameters of the distribution. For example if a quantized Gaussian (Laplacian) was used, the PMF would be written

$$P ( Y = {\hat{y}}_{i} \vert μ , σ ) = {\int }_{{\hat{y}}_{i} - δ 2}^{{\hat{y}}_{i} + \frac{δ}{2}} p ( s \vert μ , σ ) ds \qquad ( 45 )$$

Here p(y|μ, σ) is the continuous Gaussian (Laplacian), and δ is the quantization bin size (typically δ=1).

More powerful models may be created by “conditioning” the parameters θ, such as location μ or scale σ, on other information stored in the bitstream. In other words, rather than statically fixing parameters of the PMF to be constant across all inputs of the AI-based compression system, the parameters can respond dynamically to the input.

This is commonly done in two ways. In the first, extra side-information \hat{z} is sent in the bitstream in addition to ŷ. The variable \hat{z} is often called a hyper-latent. It is decoded in its entirety prior to decoding ŷ, and so is available for use in encoding/decoding ŷ. Then, μ and σ can be made functions of \hat{z}, for example returning μ and σ through a neural network. The one-dimensional PMF is then said to be conditioned on \hat{z}, and is given by P(Y=ŷ|μ(\hat{z}), σ(\hat{z})).

Another approach is to use autoregressive probabilistic models. For example, PixelCNN as described in Aäron van den Oord, Nal Kalchbrenner, Lasse Espeholt, Koray Kavukcuoglu, Oriol Vinyals, and Alex Graves. Conditional image generation with pixelcnn decoders. In Daniel D. Lee, Masashi Sugiyama, Ulrike von Luxburg, Isabelle Guyon, and Roman Garnett, editors, Advances in Neural Information Processing Systems 29: Annual Conference on Neural Information Processing Systems 2016, Dec. 5-10, 2016, Barcelona, Spain, pages 4790-4798, 2016, which is hereby incorporated by reference, has been widely used in academic AI-based compression papers, as for instance done in David Minnen, Johannes Ballè, and George Toderici. Joint autoregressive and hierarchical priors for learned image compression. In Samy Bengio, Hanna M. Wallach, Hugo Larochelle, Kristen Grauman, Nicoló Cesa-Bianchi, and Roman Garnett, editors, Advances in Neural Information Processing Systems 31: Annual Conference on Neural Information Processing Systems 2018, NeurIPS 2018, December 3-8, 2018, Montrèal, Canada, pages 10794-10803, 2018, which is hereby incorporated by reference. In this framework, context pixels are used to condition the location μ and scale σ parameters of the PMF at the current pixel. These context pixels are previously decoded pixels neighbouring the current pixel. For example, suppose the previous k pixels have been decoded. Due to inherent spatial correlations in images, these pixels often contain relevant information about the current active pixel. Hence, these context pixels may be used to improve the location and scale predictions of the current pixel. The PMF for the current pixel would then be given by P(Y=ŷᵢ|μ(ŷᵢ₋₁, . . . , ŷᵢ₋ₖ), σ(ŷᵢ₋₁, . . . , ŷᵢ₋ₖ)), where now μ and σ are functions (usually convolutional neural networks) of the previous k variables.

These two approaches, conditioning via either hyper-latents or with autoregressive context models, both come with benefits and drawbacks.

One of the main benefits of conditioning via hyper-latents is that quantization can be location-shifted. In otherwords, quantization bins can be centred about the location parameter μ. Using integer valued bins, the quantization latent is given as

$$\hat{y} = ⌊ y - μ ⌉ + μ \qquad ( 46 )$$

where └·┐ is the rounding function. This may yield superior results to straight rounding, ŷ=└y┐. In addition, conditioning via hyper-latents can implemented relatively quickly, with (depending on the neural network architecture), real-time decoding speeds.

The main benefit of autoregressive context models is the use of contextual information—the neighbouring decoded pixels. Because images (and videos) are spatially highly correlated, these neighbouring pixels can provide very accurate and precise predictions about what the current pixel should be. Most state-of-the-art academic AI-based compression pipelines use autoregressive context models due to their impressive performance results, when measured in terms of bitstream length and reconstruction errors. However, despite their impressive relative performance, they suffer from two problems.

First, they must be run serially: the PMF of the current pixel depends on all previously decoded pixels. In addition, the location and scale functions μ(·) and σ(·) are usually large neural networks. These two facts mean that autoregressive context models cannot be run in real-time, taking many orders of magnitude longer than computing requirements necessitated by real-time performance on edge devices. Thus, in their current state, autoregressive context models are not commercially viable, despite the fact that they yield impressive compression performs

Second, due to the effects of cascading errors, autoregressive context models must use straight rounding (ŷ=└y┐). Location-shifted rounding (ŷ=└y−┐+μ) is not possible, for tiny floating point errors introduced early in the decoding pass can be amplified and magnified during the serial decoding pass, leading to vastly different predictions between the encoder and decoder. The lack of location-shifted rounding is problematic, and it is believed that all other components being equal, an autoregressive model with location-shifted rounding (if it were possible to construct) would outperform a straight rounding autoregressive model.

Thus, there is a need to develop a PMF modeling framework that combines the benefits of conditioning on hyper-latents (fast runtime; location-shifted rounding), with the impressive performance of autoregressive modeling (creating powerful predictions from prior decoded context pixels).

Described below is a technique to modify the hyper-decoder to additionally predict the parameters of an autoregressive model using a hyper-decoder. In other words, we will condition the parameters of the autoregressive model on the hyper-latent \hat{Z}. This is in contrast to the standard set-up in autoregressive modeling, where the autoregressive functions are static and unchanging, and do not change depending on the compression pipeline input.

We will primarily be concerned with the following quasi-linear setup (in the sense that the decode pass is linear; while encode is not linear). In addition to the μ and σ predictions, the hyper-decoder may also output a sparse matrix L, called the context matrix. This sparse matrix will be used for the autoregressive context modeling component of the PMF as follows. Given an ordering on the latent pixels (such as raster-scan order), suppose the previous k latent pixels have been encoded/decoded, and so are available for a autoregressive context modeling. An approach is to use the following modified location-shifted quantization: we quantize via

$${\hat{y}}_{i} = ⌊ {y}_{i} - {μ}_{i} - {\sum }_{j = i - k}^{i - 1} {L}_{ij} {\hat{y}}_{j} ⌉ + {μ}_{i} + {\sum }_{j = i - k}^{i - 1} {L}_{ij} {\hat{y}}_{j} \qquad ( 47 )$$

The probability model is then given by P Y=ŷᵢ|μᵢ+Σⱼ₌ᵢ₋ₖⁱ⁻ⁱLᵢⱼŷⱼ, σᵢ). In matrix-vector notation, we have that

$$\hat{y} = ⌊ y - μ - L \hat{y} ⌉ + μ + L \hat{y} \qquad ( 48 )$$

where here L is the sparse matrix outputted by the hyper-decoder. (Note that L need not be predicted, it could also be learned or static). Note that in the ordering of the latent pixels, L may be a strictly lower-triangular matrix. This hybrid autoregressive-hyper-latent context modeling approach may be called L-context.

Note that this is a form of autoregressive context modeling. This is because the one-dimensional PMF relies on previously decoded latent pixels. However we remark that only the location parameters may rely on previously decoded latent pixels, not the scale parameters.

Notice that the integer values which may be actually encoded by the arithmetic encoder/decoder are the quantization residuals

$${\hat{ξ}}_{i} = ⌊ {y}_{i} - {μ}_{i} - {\sum }_{j = i - k}^{i - 1} {L}_{ij} {\hat{y}}_{j} ⌉ \qquad ( 49 )$$

Therefore, in decode, the arithmetic encoder returns from the bitstream not ŷ but \tilde{ξ}. Then, ŷ may be recovered by solving the following linear system for ŷ

$$\hat{y} = \hat{ξ} + μ + L \hat{y} \qquad ( 50 )$$

or put another way, by setting ŷ=(I−L)⁻¹(\tilde{ξ}+μ).

Solving the system (50) is detached from the arithmetic decoding process. That is, whereas the arithmetic decoding process must be done serially as the bitstream is received, solving (50) is independent of this process and can be done using any numerical linear algebra algorithm. The decoding pass of the L-context modeling step may not be a serial procedure, and can be run in parallel.

Another way of viewing this result is to see that equivalently, the arithmetic encoder/decoder operates on \tilde{ξ}, which has location zero. That is, the arithmetic encoder operates not on the ŷ latents, but on the residuals \tilde{ξ}. In this view, the PMF is P(Ξ=\tilde{ξ}|0, σ). Only after \tilde{ξ} is recovered from the bitstream do we then recover ŷ. However, since recovering \tilde{ξ} from the bitstream may not be autoregressive (the only dependence being on σ, which has not been made context/autoregressive dependent), this procedure may be extremely fast. Then, ŷ can be recovered using highly optimized linear algebra routines to solve (50).

In both encoding, and the training of L-context system, we may solve (48) for the unknown variable ŷ-ŷ is not given explicitly, and must be determined. In fact, (48) is an implicit system. Here we outline several possible approaches to finding ŷ satisfying (48).
The first approach is to solve (48) serially, operating on the pixels according to the ordering of their dependencies in the autoregressive model. In this setting, we simply iterate through all pixels in their autoregressive ordering, and apply (47) at each iteration to retrieve the quantized latent at the current iteration.
Since (48) is an implicit equation, the second approach is to employ an implicit equation solver, which we call an Implicit Encode Solver. This could be an iterative solver, which seeks to find the fixed point solution of (48).
Finally, in certain special cases, the autoregressive structure defined by the sparse context matrix L can be exploited to parallelize components of the serial decoding pass. In this approach, first a dependency graph (a Directed Acyclic Graph) is created defining dependency relations between the latent pixels. This dependency graph can be constructed based on the sparsity structure of the L matrix. Then, we note that pixels in the same level of the DAG are conditionally independent of each other. Therefore, they can all be calculated in parallel, without impacting the calculations of any other pixels in their level. Thus, in encode (and training), the graph is iterated over by starting at the root node, and working through the levels of the DAG. At each level, all nodes are processed in parallel. This procedure yields drastic speed-ups over a naive serial implementation when a parallel computing environment is available (such as on a Graphic Processing Unit or a Neural Processing Unit). A pictorial depiction of this procedure is shown in FIG. 23. The left image of FIG. 23 shows the L-context parameters associated with the i-th pixel in the example. The neighbouring context pixels are those directly above the current pixel, and the left neighbour. The right image shows pixels enumerated in raster scan order. The bottom image shows a worked example of constructing a Directed Acyclic Graph (DAG) given dependencies generated by an L-context matrix. Pixels on the same level are conditionally independent of each other, and can be encoded/decoded in parallel.

Many of the techniques described in the previous section can be applied at decode time as well. In particular, the linear equation

$$\hat{y} = \hat{ξ} + μ + L \hat{y} \qquad ( 51 )$$

may be solved in any of the following ways.
Since the system is lower triangular, standard forward substitution may be used. This is analagous to the serial encoding step. For each pixel i in the decode ordering, the active pixel is given by

$${\hat{y}}_{i} = {\hat{ξ}}_{i} + {μ}_{i} + {\sum }_{j < i} {L}_{ij} {\hat{y}}_{j}$$

Alternately, any iterative numerical linear algebra routine may be used.
Finally, similar to in encode, a Directed Acyclic Graph may be constructed modeling dependencies between the latent pixels. The Directed Acyclic Graph can be constructed given the sparsity structure of the matrix L. Then, similar to encode, the latents ŷ are recovered from the residuals by iterating through the layers of the DAG and processing all pixels of the level in parallel, using the linear decode equations.

Below, we describe in detail an example of the L-context module inside an AI-based compression pipeline.

FIG. 24 shows the encoding process with predicted context matrix L_{y} in an example AI-based compression pipeline. In this diagram a generic implicit solver is depicted In encoding, an input image \hat{x} is fed through an Encoder function, such as a neural network. The encoder outputs a latent y. This latent is then fed through a hyper-encoder, returning a hyper-latent Z. The hyper-latent is quantized to \hat{Z} and sent to the bitstream via an arithmetic encoder using a 1D PMF dependent on learned location μ_{Z} and scale σ_{Z}, and a lossless encoder. Optionally (though not depicted in FIG. 24) a learned L-context module can also be employed in the entropy model on ŷ. The quantized hyper-latent is then fed through a hyper-decoder, which outputs parameters for the entropy model on y. These include location μ_{y}, scale σ_{y} and L-context matrix L_{y}. A residual is computed by solving the encoding equations using any one of the methods described above. This quantized residual \tilde{ξ} is sent to the bitstream using a PMF with zero-mean and scale parameter σ_{y}.

FIG. 25 shows the decoding process with predicted context matrix L_{y} in an example AI-based compression pipeline. In this diagram a linear equation solver is depicted. In decoding, first hyper-latents \hat{Z} are recovered from the bitstream using the one-dimensional PMF with learned location and scale parameters μ_{Z} and σ_{Z}, and a lossless decoder. Optionally (not depicted in the figure) an L-context module could also be employed, if it was used in encode. The hyper-latents are fed through the hyper-decoder, which outputs location μ_{y}, scale σ_{y} and spares context matrix L_{y}. The residual \tilde{ξ} is recovered from the bitstream using the lossless decoder, the zero-mean PMF and scale parameter σ_{y}. Then, the quantized latent is recovered by solving the linear decoding system, as described above. Finally, the reconstructed image is recovered by feeding the quantized latents ŷ through a Decoder function, such as another neural network.

In the previous sections, we have assumed L is lower-triangular, with respect to the decode ordering of the pixels. A generalization is to relax this assumption, to a general matrix A, not necessarily lower-triangular. In this case, the encoding equations would be to solve

$$\hat{y} = ⌊ y - μ - A \hat{y} ⌉ + μ + A \hat{y} \qquad ( 52 )$$

and send

$$\hat{ξ} = ⌊ y - μ - A \hat{y} ⌉ \qquad ( 53 )$$

to the bitstream, via the PMF P(Ξ=ξᵢ|0, σᵢ). At decode, after retrieving \tilde{ξ} for the bitstream, the rounded latent is recovered by solving the following linear system for ŷ:

$$\hat{y} = \hat{ξ} + μ + A \hat{y} \qquad ( 54 )$$

In general, the context functions could be non-linear. For example the encoding problem would be to solve

$$\hat{y} = ⌊ y - μ - f ( \hat{y} ) ⌉ + μ + f ( \hat{y} ) \qquad ( 55 )$$

where f is a non-linear function, which could be learned or predicted, such as a Neural Network with learned or predicted parameters. The rounded latent ŷ is a fixed point of (55). This equation can be solved with any non-linear equation solver. Then, during encode the residual latents

$$\hat{ξ} = ⌊ y - μ - f ( \hat{y} ) ⌉ \qquad ( 56 )$$

are sent to the bitstream, via the PMF P(Ξ=ξᵢ|0, σᵢ). At decode, the following non-linear equation is solved for ŷ

$$\hat{y} = \hat{ξ} + μ + f ( \hat{y} ) \qquad ( 57 )$$

One interpretation of this latter extension is as an implicit PixelCNN. For example, if f(·) has a triangular Jacobian (matrix of first derivatives), then (55) models an autoregressive system. However, (55) is more general than this interpretation, indeed it is capable of modelling not just autoregressive systems but any probabilistic system with both forward and backward conditional dependencies in the pixel ordering.

### Learned AR Order

In AI-based image and video compression, autoregressive modelling is a powerful technique for entropy modelling of the latent space. Context models that condition on previously decoded pixels used in a state-of-the-art AI-based compression pipeline. However, the autoregressive ordering in context models is often a predefined and rudimentary such as raster scan ordering, which may impose unwanted biases in the learning. To this end, we propose alternative autoregressive orderings in context models that are either fixed but non-raster scan, conditioned, learned or directly optimised for.

In mathematical terms, the goal of lossy AI-based compression is to infer a prior probability distribution, the entropy model, which matches as closely as possible to a latent distribution that generates the observed data. This can be achieved by training a neural network through an optimisation framework such as gradient descent. Entropy modelling underpins the entire AI-based compression pipeline, where better distribution matching corresponds to better compression performances, characterised by lower reconstruction losses and bitrates.

For image and video data, which exhibits large spatial and temporal redundancy, an autoregressive process termed context modelling can be very helpful to exploit this redundancy in the entropy modelling. In high level, the general idea is to condition the explanation of subsequent information with existing, available information. The process of conditioning on previous variables to realise the next variable implies an autoregressive information retrieval structure of a certain ordering. This concept has proven to be incredibly powerful in AI-based image and video compression and is commonly part of cutting-edge neural compression architectures.

However, the ordering of the autoregressive structure, the autoregressive ordering (or AO in short-hand) in AI-based image and video compression may be predetermined. These context models often adopt a so-called raster scan order, which follows naturally the data sequence in image data types (3-dimensional; height×width×channels, such as RGB), for example.

FIG. 26 shows an example of raster scan ordering for a single-channel image. Grey squares are available variables to condition on and the white squares are unavailable. However, the adoption of the raster scan order as the fundamental AO is arbitrary and possibly detrimental, since it is not possible to condition on information from the bottom and the right of the current variable (or pixel). This may cause inefficiencies or potential unwanted biases in the learning of the neural network.

Below, we describe a number of AOs that can be fixed or learned, along with a number of distinct frameworks through which these can be formulated. The AO of context modelling can be generalised through these frameworks, which can be optimised for finding the optimal AO of the latent variables. The following concepts are discussed:
(a) detail theoretical aspects of AI-based image and video compression and the purpose of autoregressive modelling in context models;
(b) describe and exemplify a number of conventional and non-conventional AOs that can be assigned to the context modelling, the latter of which forms the category of innovations proposed here by Deep Render;
(c) describe a number of frameworks under which the AO can be learned through network optimisation, either with gradient descent or reinforcement learning methods, which also is encompassed by the innovations proposed here by Deep Render.

An AI-based image and video compression pipeline usually follows an autoencoder structure, which is composed by convolutional neural networks (CNNs) that make up an encoding module and decoding module whose parameters can be optimised by training on a dataset of natural-looking images and video. The (observed) data is commonly denoted by \hat{x} and is assumed to be distributed according to a data distribution p(x). The feature representation after the encoder module is called the latents and is denoted by ŷ. This is what eventually gets entropy coded into a bitstream in encoding, and vice versa in decoding.

The true distribution of the latent space p(y|x) is practically unattainable. This is because the marginalisation of the joint distribution over y and x to compute the data distribution, p(x)=∫p(x|y)p(y)dy, is intractable. Hence, we can only find an approximate representation of this distribution, which is precisely what entropy modelling does.

The true latent distribution of y∈ [symbol] ^{M} can be expressed, without loss of generality, as a joint probability distribution with conditionally dependent variables

$$p ( 𝓎 ) ≡ p ( {y}_{1} , {y}_{2} , … , {y}_{M} ) \qquad ( 58 )$$

which models the probability density over all sets of realisations of y. Equally, a joint distribution can be factorised into a set of conditional distributions of each individual variable, with an assumed, fixed ordering from i∈{1, . . . , M}

$$p ( {y}_{1} , {y}_{2} , … , {y}_{M} ) ≡ p ( {y}_{1} ) \cdot p ( {y}_{2} \vert {y}_{1} ) \cdot p ( {y}_{3} \vert {y}_{1} , {y}_{2} ) \cdot … \cdot p ( {y}_{M} \vert {y}_{1} , … , {y}_{M - 1} ) = {\prod }_{i = 1}^{M} p ( {y}_{i} \vert \{ {𝓎}_{< i} \} ) \qquad ( 59 )$$

where y_{<i} denotes the vector of all latent variables preceding yᵢ, implying an AO that is executed serially from 1 to M (a M-step AO). However, M is often very large and therefore inferring p(yᵢ|{y_{<i}}) at each step is computationally cumbersome. To achieve speedups in the autoregressive process, we can
constrain each conditional distribution to condition on a few (local) variables, instead of all preceding ones;
assume a N-step AO, where N<M and evaluate multiple conditional distributions in parallel that are conditionally independent.

Applying any of the two concepts imposes constraints that invalidates the equivalence of the joint probability and the factorisation into conditional components as described in Equation (59), but is often done to trade off against modelling complexity. The first concept is almost always done in practice for high-dimensional data, for example in a PixelCNN-based context modelling where only local receptive field is considered. An example of this process is shown in FIG. 27, which shows a 3×3 receptive field where the next pixel is conditioned on local variables (where arrows originate) instead of all preceding variables. Though for the purposes of this paper, we will not consider the imposition of this constraint in the interest of generalising the innovations that are covered here.

The second concept includes the case of assuming a factorised entropy model (no conditioning on random variables, only on deterministic parameters and a hyperprior entropy model (latent variables are all conditionally independent due to conditioning on a set of hyperlatents, Z). Both of these cases have a 1-step AO, meaning the inference of the joint distribution is executed in a single step.

Below will be described three different frameworks which specify the AO for a serial execution of any autoregressive process for the application in AI-based image and video compression. This may include, but is not limited to, entropy modelling with a context model. Each framework offers a different way of (1) defining the AO and (2) formulating potential optimisation techniques for it.

The data may be assumed to be arranged in 2-D format (a single-channel image or a single-frame, single-channel video) with dimensionality M=H×W where H is the height dimension and W is the width dimension. The concepts presented herein are equally applicable for data with multiple channels and multiple frames.

Graphical models, or more specifically directed acyclic graphs (DAGs), are very useful for describing probability distributions and their conditional dependency structure. A graph is made up by nodes, corresponding to the variables of the distribution, and directed links (arrows), indicating the conditional dependency (the variable at the head of the arrow is conditioned on the variable at the tail). For a visual example, the joint distribution that describes the example in FIG. 28 is:

$$p ( {y}_{1} , {y}_{2} , {y}_{3} , {y}_{4} ) = p ( {y}_{1} ) p ( {y}_{2} \vert {y}_{1} ) p ( {y}_{3} \vert {y}_{1} , {y}_{2} ) p ( {y}_{4} \vert {y}_{1} , {y}_{2} , {y}_{3} ) \qquad ( 60 )$$

The main constraint for a directed graph to properly describe a joint probability is that it cannot contain any directed cycles. This means there should be no path that starts at any given node on that path and ends on the same node, hence directed acyclic graphs. The raster scan ordering follows exactly the same structure shown in FIG. 28, which shows an example of a DAG that describes the joint distribution of the four variables {y₁, y₂, y₃, y₄}, and Equation (60) if the variables were organised from 1 to N in a raster scan pattern. Given our assumptions, this is an M-step AO which means it requires M passes or executions of the context model in order to evaluate the full joint distribution.

A different AO that is less than M-step is the checkerboard ordering. The ordering is visualised for a simple example in FIG. 29, which illustrates a 2-step AO where the current variables in each step are all conditionally independent and can be evaluated in parallel. In FIG. 29, in step 1 the distribution of the current pixels are inferred in parallel, without conditioning, in step 2 the distribution of the current pixels inferred in parallel and conditioned on all the pixels from the previous step. At each step, all current variables are all conditionally independent. The corresponding directed graph is shown in FIG. 30. As shown in FIG. 30, step 1 is evaluating the nodes on the top row, whilst step 2 is represented by the nodes on the bottom row with incoming arrows signifying conditioning.

Binary mask kernels for autoregressive modelling are a useful framework to specify AOs that is N-step where N<<M. Given the data y, the binary mask kernel technique entails dividing it up into N lower-resolution subimages {y₁, . . . , y_{N}}. Note that whilst previously we defined each pixel as a variable yᵢ, here we define yᵢ∈ [symbol] ^{K} as a group of K pixels or variables that are conditionally independent (and are conditioned on jointly for future steps).

A subimage yᵢ is extracted by convolving the data with a binary mask kernel Mᵢϵ{0, 1}^{k}^{_{H}}^{×k}^{_{w}},∀i∈[1, . . . , N], containing elements M_{i,pq}, with a stride of k_{H}×k_{W}. In order for this to define a valid AO, the binary mask kernels must comply with the following constraints:

$${\sum }_{p = 1}^{{k}_{H}} {\sum }_{q = 1}^{{k}_{W}} {M}_{i , pq} = 1 , ∀ i ∈ [ 1 , … , N ] \qquad ( 61 )$$

$${\sum }_{i = 1}^{N} {M}_{i} = {1}_{{k}_{H} , {k}_{W}} \qquad ( 62 )$$

Here, 1ₖ_{_{H}},k_{W} is a matrix of ones of size k_{H}×k_{W}. In other words, each mask must be unique and only have a single entry of 1 (with the rest of the elements being 0). These are sufficient conditions to ensure that the AO is exhaustive and follows the logical conditional order. To enforce the constraints (61) and (62) whilst establishing the AO, we can learn k_{H}k_{W} logits, one for each position (p, q) in the kernel, and order the autoregressive process by ranking the logits from highest to lowest, for example. We could also apply the Gumbel-softmax trick to enforce an eventual one-hot encoding whilst the temperature is being lowered.

FIG. 31 illustrates an example of how 2×2 binary mask kernels complying with constraints (61) and (62) produce 4 subimages, which are then conditioned following the graphical model described in FIG. 28 (but for vector variables rather than scalars). This example should be familiar as the checkerboard AO visited in the previous section, but with a couple of additional intermediate steps. Indeed, it is possible to define the AO with binary mask kernels such that it reflects precisely the previous checkerboard AO, by not imposing the conditioning between y₁ and y₂ and between y₃ and y₄. The choice of whether or not to condition on any previous subimage yᵢ can be determined by an adjacency matrix A, which is strictly lower triangular, and a thresholding condition T. In this case, A should be of the much more practical dimensionality k_{H}k_{W}×k_{H}k_{W}. Following the previous example, FIG. 32 illustrates how this would be possible. FIG. 32 shows an example of an adjacency matrix A that determines the graph connectivity for an AO defined by a binary mask kernel framework. If for any link the associated adjacency term is less than the threshold T, the link is ignored. If any links are ignored, conditional independence structures may appear such that the autoregressive process can comprise fewer steps.

It is also possible to represent traditional interlacing schemes with binary mask kernels, such as Adam7 used in PNG. FIG. 33 shows an indexing of an Adam7 interlacing scheme. Note that this notation is used as indication how the kernels would be arranged and grouped, not actually directly used within the model. For example, the 1 would correspond to a single mask with the one at the top left position. The 2 would correspond to another single mask with the one at the same position. The 3's would correspond to two masks, grouped together, each having their one at the respective positions as the 3's in the indexing. The same principle applies for the rest of the indices. The kernel size would be 8×8, yielding 64 masks kernels, with groupings indexed as shown in FIG. 33 such that there are seven resulting subimages (and thus is a 7-step AO). This shows that the binary mask kernel framework is adapted to handle common interlacing algorithms which exploits low-resolution information to generate high-resolution data.

Raster scan order could also be defined within the binary mask kernel framework, where the kernel size would be H×W; This would mean that it is a H×W=N-step AO, with N binary mask kernels of H×W that are organised such that the ones are ordered in raster scan.

In summary, binary mask kernels may lend themselves better to gradient descent-based learning techniques, and are related to further concepts regarding autoregressive ordering in frequency space as discussed below.

The ranking table is a third framework for characterising AOs, and under a fixed ranking it is especially effective in describing M-step AOs without the representational complexity of binary mask kernels. The concept of a ranking table is simple: given a quantity q∈ [symbol] ^{M} (flattened and corresponding to the total number of variables), each the AO is determined on the basis of a ranking system of the elements of q, qᵢ, such that the index with largest qᵢ gets assigned as y₁, the index with the second largest qᵢ gets assigned as y₂ and so on. The indexing can be performed using the argsort operator and the ranking can be either in descending or ascending order, depending on the interpretation of q.

q can be a pre-existing quantity that relays certain information about the source data y, such as the entropy parameters of y (either learned or predicted by a hyperprior), for example the scale parameter σ. In this particular case, we can define an AO by variables that have scale parameters of descending order. This comes with the interpretation that high-uncertainty regions, associated with variables with large scale parameters σᵢⱼ, should be unconditional since they carry information not easily retrievable by context. An example visualisation of this process, where the AO is defined as y₁, y₂, . . . y₁₆, can be seen in FIG. 34. FIG. 34 shows an example visualisation of the scale parameter σ which, after flattening to q, defines a ranking table by the argsort operator, organising the variables by magnitude of their respective scale parameter in descending order

q can also be derived from pre-existing quantities, such as the first-order or second-order derivative of the location parameter μ. Both of these can be obtained by applying finite-difference methods to obtain gradient vectors (for first-order derivatives) or Hessian matrices (for second-order derivatives), and would be obtained before computing q and argsort(q). The ranking can then be established by the norm of the gradient vector, or norm of the eigenvalues of the Hessian matrix, or any measure of the curvature of the latent image. Alternatively, for second-order derivatives, the ranking can be based on the magnitude of the Laplacian, which is equivalent to the trace of the Hessian matrix.

Lastly, q can also be a separate entity altogether. A fixed q can be arbitrarily pre-defined before training and remain either static or dynamic throughout training, much like a hyperparameter. Alternatively, it can be learned and optimised through gradient descent, or parametrised by a hypernetwork.

The way we access elements of y depends on whether or not we want gradients to flow through the ranking operator:
If gradients are not required: access elements by sorting q in ascending/descending order, and access elements of ŷ based on the ordering;
If gradients are required: represent the ordering either as a discrete permutation matrix P or a continuous relaxation of it \tilde{P}, and matrix-multiply with y to be sorted:

yₛₒᵣₜ=Py.

In the case that the ranking table is optimised through gradient descent-based methods, indexing operators such as argsort or argmax may not be differentiable. Hence, a continuous relaxation of a permutation matrix \tilde{P} must be used, which can be implemented with the SoftSort operator:

$$\tilde{P} = softmax ( \frac{- d ( sort ( q ) {1}_{M}^{T} , {1}_{M} {q}^{T} )}{τ} ) \qquad ( 63 )$$

where d is an arbitrary distance metric such as the L1-norm, d(x, y)=|x−y|, 1_{M} is a vector of ones of length M, τ>0 is a temperature parameter controlling the degree of continuity (where lim_{τ→0} \tilde{P}=P, i.e. approaches the true argsort operator when τ approaches zero. The softmax operator is applied per row, such that each row sums up to one. An example of this is shown in FIG. 35, which shows an example of a permutation matrix representation, both discrete P (through an argsort operator and a one-hot representation) and a continuous relaxation \tilde{P} (through the SoftSort operator), of a ranking table defined by q. As an alternative to gradient descent, reinforcement learning-based optimisation techniques can also be used.

The ranking table concept can be extended to work with binary mask kernels as well. The matrix q will be of the same dimensionality as the mask kernels themselves, and the AO will be specified based on the ranking of the elements in q. FIG. 36 visualises an example of the ranking table concept applied to the binary mask kernel framework.

Another possible autoregressive model is one which is defined on a hierarchical transformation of the latent space. In this perspective, the latent is transformed into a hierarchy of variables, and now where lower hierarchical levels are conditioned on higher hierarchical levels.

This concept can best be illustrated using Wavelet decompositions. In a wavelet decomposition, a signal is decomposed into high frequency and low frequency components. This is done via a Wavelet operator W. Let us denote a latent image as y⁰, of size H×W pixels. We use the superscript 0 to mark that the latent image is at the lowest (or root) level of the hierarchy. Using one application of a Wavelet transform, the latent image can be transformed into a set of 4 smaller images yₗₗ¹, yₗₕ¹ yₕₗ¹, and yₕₕ¹, each of size H//2×W//2. The letters H and L denote high frequency and low frequency components respectively. The first letter in the tuple corresponds to the first spatial dimension (say height) of the image, and the second letter corresponds to the second dimension (say width). So for example yₕₗ¹ is the Wavelet component of the latent image y⁰ corresponding to high frequencies in the height dimension, and low frequencies in the width dimension.

In matrix notation we have

$$[ \begin{matrix}{y}_{l l}^{1} \\ {y}_{h l}^{1} \\ {y}_{l h}^{1} \\ {y}_{h h}^{1}\end{matrix} ] = W {y}^{0} \qquad ( 64 )$$

So one can see that W is a block matrix, comprising of 4 rectangular blocks, a block for each of the corresponding frequency decompositions.

Now this procedure can be applied again, recursively on the low-frequency blocks, which constructs a hierarchical tree of decompositions. FIG. 37 for an example of the procedure with two levels of hierarchy. FIG. 37 shows a hierarchical autoregressive ordering based on the Wavelet transform. The top images shows the forward wavelet transform creates a hierarchy of variables, in this case with two levels. The middle image shows the transform can be reversed to recover the low frequency element of the preceding level. The bottom image shows an autoregressive model defined by an example DAG between elements at one level of the hierarchy. The wavelet transform can thus be used to create a many-leveled tree of hierarchies.

Crucially, if the transform matrix W is invertible (and indeed in the case of the wavelet transform W⁻¹=W^{T}), then the entire procedure can be inverted. Given the last level of the hierarchy, the preceding level's low frequency component can easily be recovered just by applying the inverse transform on the last level. Then, having recovered the next level's low-frequency components, the inverse transform is applied to the second-last level, and so on, until the original image is recovered.

Now, how can this hierarchical structure be used to construct an autoregressive ordering? In each hierarchical level, an autoregressive ordering is defined between the elements of that level. For example, refer to the bottom image of FIG. 37, where low frequency components lie at the root of the DAG at that level. We remark that an autoregressive model can also be applied on the constituent elements (pixels) of each variable in the hierarchy. The remaining variables in the level are conditioned on prior elements of the level. Then, having described all conditional dependencies of the level, the inverse wavelet transform is used to recover the preceding level's lowest frequency component.

Another DAG is defined between the elements of the next lowest level, and the autoregressive process is applied recursively, until the original latent variable is recovered.

Thus, an autoregressive ordering is defined on the variables given by the levels of the Wavelet transform of an image, using a DAG between elements of the levels of the tree, and the inverse Wavelet transform.

We remark that this procedure can be generalized in several ways:
any invertible transform can be used, not necessarily the Wavelet transform. This includes
   permutation matrices, for example those defined by a binary mask
   other orthonormal transforms, such as the Fast Fourier Transform
   learned invertible matrices
   predicted invertible matrices, for example by a hyperprior
the hierarchical decomposition can be applied to video as well. In this case, each level of the tree has 8 components, corresponding to lll, hll, lhl, hhl, llh, lhh, hhh, hlh, where now the first letter denotes a temporal component.

### Augmented Lagrangian

Example techniques for constrained optimization and rate-distortion annealing are set out in international patent application PCT/GB2021/052770, which is hereby incorporated by reference.

An AI-based compression pipeline tries to minimize the rate (R) and distortion (D). The objective function is:

$$min {λ}_{R} R + {λ}_{D} D \qquad ( 65 )$$

where minimization is taken over a set of compression algorithms, and AR and AD are the scalar coefficients controlling the relative importance of respectively the rate and the distortion to the overall objective.

In international patent application PCT/GB2021/052770, this problem is reformulated as a constrained optimization problem. A method for solving this constrained optimization problem is the Augmented Lagrangian technique as described in PCT/GB2021/052770. The constrained optimization problem is to solve:

$$min D \qquad ( 66 )$$

$$such that R = c \qquad ( 67 )$$

where c is a target compression rate. Note that D and R are averaged over the entire data distribution. Note also that an inequality constraint could also be used. Furthermore, the roles of R and D could be reversed: instead we could minimize rate subject to a distortion constraint (which may be a system of constraint equations).

Typically the constrained optimization problem will be solved using stochastic first-order optimization methods. That is, the objective function will be calculated on a small batch of training samples (not the entire dataset), after which a gradient will be computed. An update step will then be performed, modifying the parameters of the compression algorithm, and possibly other parameters related to the constrained optimization, such as Lagrange Multipliers. This process may be iterated many thousands of times, until a suitable convergence criteria has been reached. For example, the following steps may be performed:
Take one optimiser step with e.g. SGD, mini-batch SGD, Adam (or any other optimisation algorithm used in training neural networks), with loss

$$L = D + λ ( R - {r}_{0} ) + \frac{μ}{2} {( R - {r}_{0} )}^{2}$$

Update the Lagrange multiplier: λ←λ+ϵμ(R−r₀), where ϵ is chosen to be small.
Repeat the above two steps until the Lagrange multiplier has converged based on the target rate r₀

However, there are several issues encountered while training a constrained optimization problem in a stochastic small-batch first-order optimization setting. First and foremost, the constraint cannot be computed on the entire dataset at each iteration, and will typically only be computed on the small-batch of training samples used at each iteration. Using such small number of training samples in each batch can make updates to the constrained optimization parameters (such as the Lagrangian Multipliers in the Augmented Lagrangian) extremely dependent of the current batch, leading to high variance of training updates, suboptimal solutions, or even an unstable optimization routine.

An aggregated average constraint value (such as the average rate) can be computed over N of the previous iteration steps. This has the meritorious effect of expanding constraint information of the last many optimization iteration steps, so as to be applied to the current optimization step, especially in regards to updating parameters related to the constraint optimization algorithm (such as the update to the Lagrange Multipliers in the Augmented Lagrangian). A non-exhaustive list of ways to calculate this average over the last N iterations, and apply it in the optimization algorithm, is:
Keep a buffer of the constraint value over the last N training samples. This buffer can then be used to update, for example the Augmented Lagrange Multiplier λ at iteration t as

$${λ}^{t + 1} ← {λ}^{t} + \frac{μ}{2} avg ( buffer ) ,$$

where avg is a generic averaging operator. Examples of an averaging operator are:
arithmetic mean (often just called “the average”)
the median
geometric mean
harmonic mean
exponential moving average
smoothed moving average
linear weighted moving average although any averaging operator may be used.
At each training step instead of calculating gradients and immediately apply them to the model weights, we accumulate them for N iterations, then using an averaging function to do a single training step after N iterations.

Regardless, the aggregated constraint value is computed over many of the N previous iterations, and is used to update parameters of the training optimization algorithm, such as the Lagrange Multipliers.

A second problem with stochastic first-order optimization algorithms is that the dataset will contain images with extremely large or extremely small constraint values (such as having either very small or very large rate R). When we have outliers present on a dataset they will force the function we are learning to take them into account, and may create a poor fit for the more common samples. For instance, the update to the parameters of the optimization algorithm (such as the Lagrange Multipliers) may have high variance and cause non-optimal training when there are many outliers.

Some of these outliers may be removed from the computation of the constraint average detailed above. Some possible methods for filtering (removing) these outliers would be
When accumulating the training samples, the mean can be replaced with a trimmed mean. The difference between a trimmed mean and a normal mean is that with the trimmed version the \hat{x} % of the top and bottom values are not taken into account for the mean calculation. For example one could trim 5% of the top and bottom samples (in sorted order).
It may not be necessary to trim throughout the entire training procedure, and a regular average (without trimming) could be used later in the training procedure. For instance the trimmed mean may be turned off after 1 million iterations.
An outlier detector could be fitted every N iterations, to allow the model to either eliminate those samples from the mean completely or weight them down.

Using a constrained optimization algorithm such as the Augmented Lagrangian we are able to target a specific average constraint (such as rate) target c on the training data set. However, converging to that target constraint on the training set does not guarantee that we will have the same constraint value on the validation set. This may be caused for example by changes between the quantization function used in training, and the one used in inference (test/validation). For example it is common to quantize using uniform noise during training, but use rounding in inference (called ‘STE’). Ideally the constraint would be satisfied in inference, however this can be difficult to achieve.

The following methods may be performed:
at each training step, compute the constraint target value using a detach operator, where the in the forward pass the inference value is used, but in the backward pass (gradient computation), the training gradient is used. For instance, when discussing a rate constraint, the value R_{noisy}+(R_{STE}−R_{noisy}).detach( ) could be used, where ‘detach’ denotes detaching the value from the automatic differentiation graph.
updating the constraint algorithm's parameter's on a ‘hold out set’ of images, under which the model is evaluated using the same settings as in inference.

The techniques described above and set out in international patent application PC-T/GB2021/052770 may also be applied in the AI based compression of video. In this case, a Lagrange multiplier may be applied to the rate and distortion associated with each of the frames of the video used for each training step. One or more of these Lagrange multipliers may be optimized using the techniques discussed above. Alternatively, the multipliers may be averaged over a plurality of frames during the training process.

The target value for the Lagrange multipliers may be set to an equal value for each of the frames of the input video used in the training step. Alternatively, different values may be used. For example, a different target may be used for I-frames of the video to P-frames of the video. A higher target rate may be used for the I-frames compared to the P-frames. The same techniques may also be applied to B-frames.

In a similar manner to image compression, the target rate may initially be set to zero for one or more frames of the video used in training. When a target value is set for distortion, the target value may be set so that the initial weighting is at maximum for the distortion (for example, the target rate may be set at 1).

### Tensor Networks

AI-based compression relies on modeling discrete probability mass functions (PMFs). These PMFs can appear deceptively simple. Our usual mental model begins with one discrete variable X, which can take on D possible values X₁, . . . , X_{D}. Then, constructing a PMF P(X) is done simply by making a table where the entries are defined Pᵢ=P(Xᵢ). Of course the Pᵢ's have to be non-negative and sum to 1, but this can be done by for example using the softmax

| | | | |
|---|---|---|---|
| X₁ | X₂ | . . . | X_{D} |
| P₁ | P₂ | . . . | P_{D} |

function. For modeling purposes, it doesn't seem that hard to learn each of the Pᵢ's in this table that would fit a particular data distribution.

What about a PMF over two variables, X and Y, each of which can take on N possible values? This again still seems manageable, in that a 2d table would be needed, with entries Pᵢⱼ=P(Xᵢ, Yⱼ) This is slightly more involved; now the table has D² entries, but still

| | Y₁ | Y₂ | . . . | Y_{D} |
|---|---|---|---|---|
| X₁ | P₁₁ | P₁₂ | . . . | P_{1D} |
| . | | | | |
| . | | | | |
| . | | | | |
| X_{D} | P_{D1} | P_{D2} | . . . | P_{DD} |

manageable, provided D is not too big. Continuing on, with three variables, a 3d table would be needed, where entries Pᵢⱼₖ indexed by a 3-tuple.

However this naive “build a table” approach may quickly becomes unmanageable, as soon as we attempt to model any more than a handful of discrete variables. For example, think of modeling a PMF over the space of RGB 1024×1024 images: each can take on 256³ possible values (each color channel has 256 possible values, and we have 3 color channels). Then the lookup table we'd need has 256^{3·1024}^{²} entries. In base 10 that's about 10¹⁰^{⁷}. There are many approaches to dealing with this problem and the textbook approach in discrete modeling is to use probabilistic graphical models.

In an alternative approach, PMFs may be modelled as tensors. A tensor is simply another word for a giant table (but with some extra algebraic properties, not discussed herein). A discrete PMF can always be described as a tensor. For example, a 2-tensor (alternatively referred to as a matrix) is an array with two indices, ie a 2d table. So the above PMF Pᵢⱼ=P(Xᵢ, Yⱼ) over two discrete variables X and Y is a 2-tensor. An N-tensor Tᵢ_{₁}, . . . , ᵢ_{_{N}} is an array with N indices, and if the entries of T are positive and sum to 1, this is a PMF over N discrete variables. Table 1 presents a comparison of the standard way of viewing PMFs with the tensorial viewpoint, for some probabilistic concepts.

The main appeal of this viewpoint is that massive tensors may be modelled using the framework of tensor networks. Tensor networks may be used to approximate a very high dimensional tensor with contractions of several low dimensional (ie. tractable) tensors. That is, tensor networks may be used to perform a low-rank approximations of otherwise intractable tensors.

TABLE 1
Comparison of several probabilistic concepts with a tensorial viewpoint

| Functional picture | Tensorial picture |
|---|---|
| Discrete function P(X₁, . . . , X_{N}) on N random | Tensor with N indices Tᵢ_{₁}_{, . . . , i}_{_{N}} |
| variables | |
| Each random variable takes on D possible | Each index takes on D possible integer values: |
| values | iⱼ = 1, . . . , D |
| Normalization: 1 = Σᵢ_{₁}_{, . . . , i}_{_{N}} | Normalization: 1 = Σᵢ_{₁}_{, . . . , i}_{_{N}} Tᵢ_{₁}, . . . , i_{N} |
| P(X₁ = xᵢ_{₁}, . . . , X_{N} = xᵢ_{_{N}}) | |
| Marginalize over a random variable: P(Y) = | Marginalize over a random variable: Tⱼ = |
| Σᵢ P(X = xᵢ, Y) | Σᵢ Tᵢⱼ |
| Independent random variables: P(X, Y) = | Tᵢⱼ is rank 1: Tᵢⱼ = ν ⊗ w |
| P(X)P(Y) | |

For example, if we view matrices as 2-tensors, standard low-rank approximations (such as singular value decomposition (SVD) and principle component analysis (PCA)) are tensor network factorizations. Tensor networks are generalizations of the low-rank approximations used in linear algebra to multilinear maps. An example of the use of tensor networks in probabilistic modeling for machine learning is shown in in “Ivan Glasser, Ryan Sweke, Nicola Pancotti, Jens Eisert, and J Ignacio Cirac. Expressive power of tensor-network factorizations for probabilistic modeling, with applications from hidden markov models to quantum machine learning. arXiv preprint, arXiv:1907.03741, 2019”, which is hereby incorporated by reference.

Tensor networks may be considered an alternative to a graphical model. There is a correspondence between tensor networks and graphical models: any probabilistic graphical model can be recast as a tensor network, however the reverse is not true. There exist tensor networks for joint density modelling that cannot be recast as probabilistic graphical models, yet have strong performance guarantees, and are computationally tractable. In many circumstances tensor networks are more expressive than traditional probabilistic graphical models like HMMs:
Given a fixed number of parameters, experimentally the tensor networks outperform HMMs.
Moreover, for a fixed low-rank approximation, the tensor networks may theoretically again outperform HMMs.

All other modeling assumptions being equal, tensor networks may be preferred over HMMs.

An intuitive explanation for this result is that probabilistic graphical factor the joint via their conditional probabilities, which are usually constrained to be positive by only considering exponential maps p (X=xᵢ|Y)∝exp(−f(xᵢ)). This amounts to modeling the joint as a Boltzmann/Gibbs distribution. This may in fact be a restrictive modeling assumption. A completely alternative approach offered by tensor networks is to model the joint as an inner product: p(X)∝<X, HX> for some Hermitian positive (semi-)definite operator H. (This modeling approach is inspired by the Born rule of quantum systems.) The operator H can be written as a giant tensor (or tensor network). Crucially, the entries of H can be complex. It is not at all obvious how (or even if) this could be translated into a graphical model. It does however present a completely different modeling perspective, otherwise unavailable.

Let us illustrate what a tensor network decomposition is through a simple example. Suppose we have a large D×D matrix T (a 2-tensor), with entries Tᵢⱼ, and we want to make a low-rank approximation of T—say a rank-r approximation, with r<D. One way to do this is to find an approximation \hat{T}, with entries

$${\hat{T}}_{ij} = {\sum }_{k} {A}_{i k} {B}_{k j} \qquad ( 68 )$$

In other words, we're saying \hat{T}=AB, where A is an D×r matrix and B is an r×D matrix. We have introduced a hidden dimension, shared between A and B, which is to be summed over. This can be quite useful in modeling: rather than dealing with a giant D×D matrix, if we set r very small, we can save on a large amount of computing time or power by going from D² parameters to 2Dr parameters. Moreover, in many modeling situations, r can be very small while still yielding a “good enough” approximation of T.

Let's now model a 3-tensor, following the same approach. Suppose we're given a D×D×D tensor T, with entries Tᵢⱼₖ. One way to approximate T is with the following decomposition

$${\hat{T}}_{ijk} = {\sum }_{l , m} {A}_{il} {B}_{jlm} {C}_{k m} \qquad ( 69 )$$

Here A and C are low-rank matrices, and B is a low-rank 3-tensor. There are now two hidden dimensions to be summed over: one between A and B, and one between B and C. In tensor network parlance, these hidden dimensions may be called the bond dimension. Summing over a dimension may be called a contraction.

This example can be continued, approximating a 4-tensor as a product of lower dimensional tensors, but the indexing notation quickly becomes cumbersome to write down. Instead, we will use tensor network diagrams, a concise way of diagrammatically conveying the same calculations.

In a tensor network diagram, tensors are represented by blocks, and each indexing dimension is represented as an arm, as shown in FIG. 38. The dimensionality of the tensor is seen by simply counting the number of free (dangling) arms. The top row of FIG. 38 shows from left to right a vector, a matrix and an N-tensor. Tensor-products (summing/contracting along a particular index dimension) are represented by connecting two tensor arms together. We can see diagrammatically in FIG. 38 that the matrix-vector product on the bottom left has one dangling arm, and so the resulting product is a 1-tensor, ie. a vector, as we'd expect. Similarly the matrix-matrix product on the bottom right has two dangling arms, and so its result is a matrix, as we'd expect.

We can represent the tensor decomposition of the 3-tensor \hat{T} given by equation (69) diagrammatically, as seen in the top row of FIG. 39, which is much simpler to comprehend than equation (69) Now suppose we want to access a particular element \hat{T}ᵢⱼₖ of \hat{T}. We just fix the free indices to the desired values, and then perform the necessary contractions.

Armed with this notation, we can now delve into some possible tensor-network factorizations used for probabilistic modeling. The key idea is that the true joint distribution for a high-dimensional PMF is intractable. We must approximate it, and will do so using tensor-network factorizations. These tensor network factorizations can then be learned to fit training data. Not all tensor network factorizations will be appropriate. It may be necessary to constrain entries of the tensor network to be non-negative and to sum to 1.

An example if an approach is the use of a Matrix Product State (MPS) (sometimes also called a Tensor Train). Suppose we want to model a PMF P(X₁, . . . , X_{N}) as a tensor \hat{T}ᵢ_{₁}, . . . ᵢ_{_{N}}. An MPS decomposes this tensor into a long chain of 2- and 3-tensors

$${\hat{T}}_{{i}_{1} , {i}_{2} , … , {i}_{N}} = {\sum }_{{α}_{1} , … , {α}_{N - 1}} {A}_{1 {i}_{1}}^{{α}_{1}} {A}_{2 {i}_{2}}^{{α}_{1} , {α}_{2}} … {A}_{{Ni}_{N}}^{{α}_{N - 1}} \qquad ( 70 )$$

Graphically as a tensor network diagram, this can be seen in the bottom row of FIG. 39. To ensure \hat{T} only has positive entries, each of the constituent Aⱼ tensors is constrained to have only positive values. This could be done say by element-wise exponentiating a parameter matrix, A=exp(B).

To ensure the entries sum to 1, a normalization constant is computed by summing over all possible states. Though computing this normalization constant for a general N-tensor may be impractical, conveniently for an MPS, due to its linear nature, the normalization constant can be computed in O(N) time. Here by “linear nature” we mean, the tensor products can be performed sequentially one-by-one, operating down the line of the tensor train. (Both tensors and their tensor network approximations are multilinear functions.)

An MPS appears quite a lot like Hidden Markov Model (HMM). In fact, there is indeed a correspondence: An MPS with positive entries corresponds exactly to an HMM.

Further examples of tensor network models are Born Machines and Locally Purified States (LPS). Both are inspired by models arising in quantum systems. Quantum systems assume the Born rule, which says that the probability of an event X occurring is proportional to it's squared norm under an inner product <·, H·>, with some positive (semi-)definite Hermitian operator H. In other words, the joint probability is a quadratic function. This is a powerful probabilistic modeling framework that has no obvious connection to graphical models.

Locally Purified State (LPS) takes the form depicted in FIG. 40 In an LPS, there is no constraint on the sign of the constituent Aₖ tensors—they can be positive or negative. In fact, the Aₖ's can have complex values. In this case, Ā is the tensor made of taking the complex conjugate of the entries in A. The αₖ dimensions may be called bond dimensions, and the βₖ dimensions may be called purification dimensions.

The elements of \hat{T} are guaranteed to be positive, by virtue of the fact that contraction along the purification dimension yields positive values (for a complex number z, zz̅≥0). If we view {i₁, . . . , i_{N}} as one giant multi-index [symbol] , we can see that the LPS is the diagonal of a giant matrix (after contracting all the hidden dimensions), and evaluating the LPS is equivalent to an inner product operating on the state space.

As in the MPS, computing the normalization constant of an LPS is fast and can be done in [symbol] N time. A Born Machine is a special case of LPS, when the size of the purification dimensions is one.

Tensor trees are another example type of tensor network. At the leaves of the tree, dangling arms are to be contracted with data. However, the hidden dimensions are arranged in a tree, where nodes of the tree store tensors. Edges of the tree are dimensions of the tensors to be contracted. A simple Tensor Tree is depicted in FIG. 41. Nodes of the tree store tensors and edges depict contractions between tensors. At the leaves of the tree are indices to be contracted with data. Tensor trees can be used for multi-resolution and/or multi-scale modeling of the probability distribution.

Note that a tensor tree can be combined with the framework of the Locally Purified State: a purification dimension could be added to each tensor node, to be contracted with the complex conjugate of that node. This would then define an inner product according to some Hermitian operator given by the tensor tree and it's complex conjugate.

Another example tensor network is the Projected Entangled Pair States (PEPS). In this tensor network, tensor nodes are arranged in a regular grid, and are contracted with their immediate neighbours. Each tensor has an additional dangling arm (free index) which is to be contracted with data (such as latent pixel values). In a certain sense, PEPS draws a similarity to Markov Random Fields and the Ising Model. A simple example of PEPS on a 2×2 image patch is given in FIG. 42.

Tensor network calculations (such as computing the joint probability of a PMF, conditional probabilities, marginal probabilities, or calculating the entropy of a PMF) can be massively simplified, and greatly sped up, by putting a tensor into canonical form, as discussed in greater detail below. All of the tensors networks discussed above can be placed into a canonical form.

Because the basis in which hidden dimensions are represented is not fixed (so called gauge-freedom), we can simply change the basis in which these tensors are represented. For example, when a tensor network is placed in canonical form, almost all the tensors can be transformed into orthonormal (unitary) matrices.

This can be done by performing a sequential set of decompositions on the tensors in the tensor network. These decompositions include the QR decomposition (and it's variants, RQ, QL, and LQ), the SVD decomposition, and the spectral decomposition (if it is available), the Schur decomposition, the QZ decomposition, Takagi's decomposition, among others. The procedure of writing a tensor network in canonical form works by decomposing each of the tensors into an orthonormal (unitary) component, and an other factor. The other factor is contracted with a neighbouring tensor, modifying the neighbouring tensor. Then, the same procedure is applied to the neighbouring tensor and it's neighbours, and so on, until all but one of the tensors is orthonormal (unitary).

The remaining tensor which is not orthonormal (unitary) may be called the core tensor. The core tensor is analagous to the diagonal matrix of singular values in an SVD decomposition, and contains spectral information about the tensor network. The core tensor can be uses to calculate for instance normalizing constants of the tensor network, or the entropy of the tensor network.

FIG. 43 shows, from top to bottom, an example of the procedure for transforming a MPS into canonical form. Sequentially core tensors are decomposed via a QR decomposition. The R tensor is contracting with the next tensor in the chain. The procedure is repeated until all but a core tensor C is in an orthonormal form.

The use of tensor networks for probabilistic modeling in AI-based image and video compression will now be discussed in more detail. As discussed above, in an AI-based compression pipeline, an input image (or video) x is mapped to a latent variable y, via an encoding function (typically a neural network). The latent variable y is quantized to integer values ŷ, using a quantization function Q. These quantized latents are converted to a bitstream using a lossless encoding method such as entropy encoding as discussed above. Arithmetic encoding or decoding is an example of such an encoding process and will be used as an example in further discussion.

This lossless encoding process is where the probabilistic model is required: the arithmetic encoder/decoder requires a probability mass function q(ŷ) to convert integer values into the bitstream. On decode, similarly the PMF is used to turn the bitstream back into quantized latents, which are then fed through a decoder function (also typically a neural network), which returns the reconstructed image \hat{x}.

The size of the bitstream (the compression rate) is determined largely by the quality of the probability (entropy) model. A better, more powerful, probability model results in smaller bitstreams for the same quality of reconstructed image.

The arithmetic encoder typically operates on one-dimensional PMFs. To incorporate this modeling constraint, typically the joint PMF q(ŷ) is assumed to be independent, so that each of the pixels ŷⁱ is modeled by a one-dimensional probability distribution q (ŷⁱ|θⁱ). Then the joint density is modeled as

$$q ( \hat{y} ) = {\prod }_{i = 1}^{M} q ( {\hat{y}}^{i} \vert {θ}^{i} ) \qquad ( 71 )$$

where M is the number of pixels. The parameters θᵢ control the one-dimensional distribution at pixel i. As discussed above, often the parameters θ may be predicted by a hyper-network (containing a hyper-encoder and hyper-decoder). Alternately or additionally, the parameters may be predicted by a context-model, which uses previously decoded pixels as an input.

Either way, fundamentally this modeling approach assumes a one-dimensional distribution on each of the ŷⁱ pixels. This may be restrictive. A superior approach can be to model the joint distribution entirely. Then, when encoding or decoding the bitstream, the necessary one-dimensional distributions needed for the arithmetic encoder/decoder can be computed as conditional probabilities.

Tensor networks may be used for modeling the joint distribution. This can be done as follows. Suppose we are given a quantized latent ŷ={ŷ¹, ŷ², . . . , ŷ^{M}}. Each latent pixel will be embedded (or lifted) into a high dimensional space. In this high dimensional space, integers are represented by vectors lying on the vertex of a probability simplex. For example, suppose we quantize yⁱ to D possible integer values {−D//2, −D//2+1, . . . , 1, 0, 1, . . . , D//2−1, D//2}. The embedding maps ŷⁱ to a D-dimensional one-hot vector, with a one in the slot corresponding to the integer value, and zeros everywhere else.

For example, suppose each ŷ¹ can take on values {−3, −2, −1, 0, 1, 2, 3}, and ŷⁱ=−1. Then the embedding is e(ŷⁱ)=(0, 0, 1, 0, 0, 0, 0).

Thus, the embedding maps ŷ={ŷ¹, ŷ², . . . , ŷ^{M}} to e(ŷ)={e(ŷ¹), e(ŷ²), . . . , e(ŷ^{M})}. In effect this takes ŷ living in a M-dimensional space, and maps it to a D^{M} dimensional space.

Now, each of these entries in the embedding can be viewed as dimensions indexing a high-dimensional tensor. Thus, the approach we will take is model the joint probability density via a tensor network \hat{T}. For example, we could model the joint density as

$$q ( \hat{y} ) = 〈 e ( \hat{y} ) , He ( \hat{y} ) 〉 \qquad ( 72 )$$

where H is a Hermitian operator modeled via a tensor network (as described above. Really any tensor network with tractable inference can be used here, such as Tensor Trees, Locally Purified States, Born Machines, Matrix Product States, or Projected Entangled Pair States, or any other tensor network.

At encode/decode, the joint probability cannot be used by the arithmetic encoder/decoder. Instead, one-dimensional distributions must be used. To calculate the one-dimensional distribution, conditional probabilities may be used.

Conveniently, conditional probabilities are easily computed by marginalizing out hidden variables, fixing prior conditional variables, and normalizing. All of these can be done tractably using tensor networks.

For example, suppose we encode/decode in raster-scan order. Then, pixel-by-pixel, we will need the following conditional probabilities: q(ŷ¹) q(ŷ²|y¹), . . . , q(ŷ^{M}|ŷM⁻¹, . . . , ŷ¹) Each of these conditional probabilities can be computed tractably by contracting the tensor network over the hidden (unseen) variables, fixing the index of the conditioning variable, and normalizing by an appropriate normalization constant.

If the tensor network is in canonical form, this is an especially fast procedure, for in this case contraction along the hidden dimension is equivalent to multiplication with the identity.

The tensor network can be applied to joint probabilistic modeling of the PMF across all latent pixels, or patches of latent pixels, or modeling joint probabilities across channels of the latent representation, or any combination thereof.

Joint probabilistic modeling with a tensor network can be readily incorporated into an AI-based compression pipeline, as follows. The tensor network could be learned during end-to-end training, and then fixed post-training. Alternately, the tensor network, or components thereof, could be predicted by a hyper-network. A tensor network may additionally or alternatively be used for entropy encoding and decoding the hyper-latent in the hyper network. In this case, the parameter of the tensor network used for entropy encoding and decoding the hyper-latent could be learned during end-to-end training, and then fixed post-training.

For instance, a hyper-network could predict the core tensor of a tensor network, on a patch-by-patch basis. In this scenario, the core tensor varies across pixel-patches, but the remaining tensors are learned and fixed across pixel patches. For example, see FIG. 44 showing a AI-based compression encoder with a Tensor Network predicted by a hyper-encoder/hyper-decoder and FIG. 45 showing an AI-based compression decoder with a Tensor Network predicted by a hyper-decoder for the use of a tensor network in an AI-based compression pipeline. Corresponding features to those shown in FIGS. 1 and 2 may be assumed to be the same as discussed above. In these example, it is the residual ξ=y−μ which is quantized, encoded, and decoded, using the tensor network probability model. The tensor network parameters are represented by T_{y} in this case. In the example shown in FIGS. 44 and 45, the quantized hyperlatent \hat{Z} is additionally encoded and decoded using a tensor network probability model with parameters represented by T_{Z}.

Rather than (or possibly in conjunction with) using a hyper-network to predict tensor network components, parts of the tensor network may be predicted using a context module which uses previously decoded latent pixels.

During training of the AI-based compression pipeline with a tensor network probability model, the tensor network can be trained on non-integer valued latents (y rather than ŷ=Q(y), where Q is a quantization function). To do so, the embedding functions e can be defined on non-integer values. For example, the embedding function could comprise of tent functions, which take on the value of 1 at the appropriate integer value, zero at all other integers, and linearly interpolating between. This then performs multi-linear interpolation. Any other real-valued extension to the embedding scheme could be used, so long as the extension agrees with original embedding on integer valued points.

The performance of the tensor network entropy model may be enhanced by some forms of regularization during training. For example, entropy regularization could be used. In this case, the entropy H(q) of the tensor network could be calculated, and a multiple of this could be added or subtracted to the training loss function. Note that the entropy of a tensor network in canonical form can be easily calculated by computing the entropy of the core tensor.

### HyperHyperNetwork

The functionality and scope of current and utilization of training techniques for an auxiliary hyperhyper prior, for use in, but not limited to, image and video data compression based on AI and deep learning will be discussed below.

A commonly adopted network configuration for AI-based image and video compression is the autoencoder. It consists of an encoder module that transforms the input data into “latents” (y), an alternative representation of the input data and often modelled as a set of pixels, and a decoder module that takes the set of latents and intends to transform it back to the input data (or as closely resembling as possible). Because of the high-dimensional nature of the “latent space”, where each latent pixel represents a dimension, we “fit” a parametric distribution onto the latent space with a so-called “entropy model” p(ŷ). The entropy model is used to convert ŷ into a bitstream using a lossless arithmetic encoder. The parameters for the entropy model (“entropy parameters”) are learned internally within the network. The entropy model can either be learned directly or predicted via a hyperprior structure. An illustration of this structure can be found in FIG. 1.

The entropy parameters are most commonly comprised by a location parameter and a scale parameter (which is often expressed as a positive real value), such as (but not limited to) the mean μ and standard deviation σ for a Gaussian distribution, and the mean μ and scale b for a Laplacian distribution. Naturally, there exist many more distribution types, both parametric and non-parametric, with a large variety of parameter types.

A hyperprior structure (FIG. 2), introduces an extra set of “latents” (Z) which through a set of transformations which predict the entropy parameters. If we assume y is modelled by a Gaussian distribution, a hyperprior model can be defined by:

$$\begin{matrix}{p}_{\hat{y} \vert \hat{z}} ( \hat{y} \vert \hat{z} , θ ) = {\prod }_{i} 𝒩 ( Q ( y ) \vert {μ}_{i} , {σ}_{i}^{2} ) * {\hat{y}}_{i} \\ with {μ}_{y} , {σ}_{y} = {h}_{D} ( \hat{z} , θ )\end{matrix} \qquad ( 73 )$$

where all symbols with a ∧ represent the quantized versions of the original, Q is a quantization function, h_{D} are the set of transformations, θ represents the parameters of said transformation, \hat{Z}˜p(Z|μ_{Z}, σ_{Z}). This structure is used to help the entropy model capture dependencies it can't by itself. Since a hyperprior predicts the parameters of an entropy model, thus we now can learn the model of the hyperprior, which can be comprised of the same types of parametric distributions as the entropy model. Just as we add a hyperprior to the entropy model, we can add a hyperprior, with latents w, to the hyperprior to predict its parameters, referred to as a hyperhyperprior. So instead of \hat{Z}˜p(Z|μ_{Z}, σ_{Z}), now we have \hat{Z}˜p(Z|μ_{Z}(Ŵ), (σ_{Z}(Ŵ)). Further hyperpriors can be added to the model.

A hyperhyperprior can be added to an already trained model with a hyperprior, which may be referred to as an auxiliary hyperhyperprior. This technique is applied in particular, but not exclusively, to improve the model capacity to capture low frequency features, thus improve performance on “low-rate” images. Low frequency features are present in an image if there aren't abrupt color changes through their axis′. Thus, an image with a high amount of low frequency features would have only one color throughout the image. We can find out the amount of low frequency features an image has by extracting the power spectrum of an image.

Hyperhyperpriors may be trained jointly with the hyperprior and the entropy parameters. However using a hyperhyperprior on all images may be computationally expensive. In order to maintain performance on non-low-rate images, but still give the network the capacity to model low frequency features, we may adopt an auxiliary hyperhyperprior which is used when an image fits a predetermined feature, such as being low-rate. An example of a low-rate image is if the bits-per-pixel (bpp) is roughly below 0.1. An example of this is shown in Algorithm 3.

The auxiliary hyperhyperprior framework allows the model to be adjusted only when required. Once trained, we can encode into a bitstream a flag signaling that this specific image needs a hyperhyperprior. This approach can be generalized to infinite components of the entropy model, such as a hyperhyperhyperprior.

Algorithm 3 Auxiliary Hyperhyperprior Pseudocode

y, μ_{y}, σ_{y}, rate_{z} = Encode-with-hyperprior(x) ŷ = Quantize(y, μ_{y}, σ_{y})
rate = Calculate-rate(ŷ, μ_{y}, σ_{y}, rate_{z})
if low-rate then y, μ_{y}, σ_{y}, rate_{z}, rate_{w} = Encode-with-
hyperhyperprior(x) ŷ = Quantize(y, μ_{y}, σ_{y}) \hat{x} = Decode(ŷ) return \hat{x}

The most direct way of training our hyperhyperprior is to “freeze” the existing pre-trained hyperprior network, including the encoder and decoder, and only optimize the weights of the hyperhyper modules. In this document when we refer to “freeze”, it means that the weights of the modules being freezing do are not trained and do not accumulate gradients to train the non-frozen modules. By freezing the existing entropy model, the hyperhyperprior may modify the hyperprior's parameters, like μ and σ in the case of a normal distribution, in such a way that it is more biased towards low-rate images.

Using this training scheme provides several benefits:
Since a lower number of parameters have to calculate and store gradients, the training time and memory consumption may scale better to image size.
An infinite iterative process of training hyperpriors may be used, freezing and training another hyperprior on top.

A possible implementation is to initially let the hyperprior network train for N iterations. Once N iterations are reached, we may freeze the entropy model and switch to the hyperhyperprior if an image has a low-rate. This allows the hyperprior model to specialize on the images it already does great at, while the hyperhyperprior works as intended. Algorithm 4 illustrates the training scheme. This training can be used as well to train only on low-frequency regions of an image, if it has them, by splitting the image into K blocks of size N×N, then applying this scheme on those blocks.

Another possibility is not to wait N iterations to start training the hyperhyperprior, as shown in Algorithm 5.

Algorithm 4 Switch Training Pseudocode

while training not done do y, μ_{y}, σ_{y}, rate_{z} = Encode-with-
hyperprior(x) ŷ = Quantize(y, μ_{y}, σ_{y}) rate = Calculate-
rate(ŷ, μ_{y}, σ_{y}, rate_{z})
if low-rate and c > N then y, μ_{y}, σ_{y}, rate_{z}, rate_{w} = Encode-with-
hyperhyperprior(x) ŷ = Quantize(y, μ_{y}, σ_{y}) rate = Calculate-
rate(ŷ, μ_{y}, σ_{y}, rate_{z}, rate_{w}) \hat{x} = Decode(ŷ) loss = Calculate-
loss(rate, \hat{x}, x) train-step(loss)

Algorithm 5 Joint Switch Training Pseudocode

while training not done do y, μ_{y}, σ_{y}, rate_{z} = Encode-with-
hyperprior(x) ŷ = Quantize(y, μ_{y}, σ_{y}) rate = Calculate-
rate(ŷ, μ_{y}, σ_{y}, rate_{z})
if low-rate then y, μ_{y}, σ_{y}, rate_{z}, rate_{w} = Encode-with-
hyperhyperprior(x) ŷ = Quantize(y, μ_{y}, σ_{y}) rate =
Calculate-rate(ŷ, μ_{y}, σ_{y}, rate_{z}, rate_{w}) \hat{x} = Decode(ŷ) loss =
Calculate-loss(rate, \hat{x}, x) train-step(loss)

There are different criteria to choose from to classify an image as low-rate, including: using the rate calculated with the distribution we chose as a prior, using the mean or median value of the power spectrum of an image, median or mean value of frequency obtained by a fast Fourier transform.

Data augmentation can be used to create more samples with low frequency features that are related to low-rate images to create sufficient data. There are different ways images can be modified:
Upsampling all images to a fixed size N×N.
Use a constant upsampling factor.
Randomly sample an upsampling factor from a distribution. The chosen distribution can be any of the following: uniform, gaussian, gumbel, laplacian, gaussian mixture, geometric, student's t, non-parametric, chi², beta, gamma, pareto, cauchy.
Use a smoothing filter on the image. Any of the following filters work: average, weighted average, median, gaussian, bilateral.
Use the real image size, unless it is smaller than certain threshold N, then upsample either to a fixed size, use a constant upsampling factor or sample from a distribution an upsampling factor just as stated before.

In addition to upsampling or blurring the images, a random crop may also be performed.

1-96.

97. A method of training one or more neural networks, the one or more neural networks being for use in lossy image or video encoding, transmission and decoding, the method comprising the steps of:
receiving an input image at a first computer system;
encoding the input image using a first neural network to produce a latent representation; entropy encoding the latent representation;
transmitting the entropy encoded latent representation to a second computer system; entropy decoding the entropy encoded latent representation; and
decoding the latent representation using a second neural network to produce an output image, wherein the output image is an approximation of the input image;
determining a quantity based on a difference between the output image and the input image;
updating the parameters of the first neural network and the second neural network based on the determined quantity; and
repeating the above steps using a first set of input images to produce a first trained neural network and a second trained neural network;
wherein the entropy decoding of the entropy encoded latent representation is performed pixel by pixel; and
the order of the pixel by pixel decoding is additionally updated based on the determined quantity.

98. The method of claim 97, wherein the order of the pixel by pixel decoding is based on the latent representation.

99. The method of claim 97, wherein the entropy decoding of the entropy encoded latent comprises an operation based on previously decoded pixels.

100. The method of claim 97, wherein the determining of the order of the pixel by pixel decoding comprises ordering a plurality of the pixels of the latent representation in a directed acyclic graph.

101. The method of claim 97, wherein the determining of the order of the pixel by pixel decoding comprises operating on the latent representation with a plurality of adjacency matrices.

102. The method of claim 97, wherein the determining of the order of the pixel by pixel decoding comprises dividing the latent representation into a plurality of sub-images.

103. The method of claim 102, wherein the plurality of sub-images are obtained by convolving the latent representation with a plurality of binary mask kernels.

104. The method of claim 97, wherein the determining of the order of the pixel by pixel decoding comprises ranking a plurality of pixels of the latent representation based on the magnitude of a quantity associated with each pixel.

105. The method of claim 104, wherein the quantity associated with each pixel is the location or scale parameter associated with that pixel.

106. The method of claim 104, wherein the quantity associated with each pixel is additionally updated based on the evaluated difference.

107. The method of claim 97, wherein the determining of the order of the pixel by pixel decoding comprises a wavelet decomposition of a plurality of pixels of the latent representation.

108. The method of claim 107, wherein the order of the pixel by pixel decoding is based on the frequency components of the wavelet decomposition associated with the plurality of pixels.

109. The method of claim 97, further comprising the steps of:
encoding the latent representation using a fourth trained neural network to produce a hyper-latent representation;
transmitting the hyper-latent to the second computer system; and
decoding the hyper-latent using a fifth trained neural network, wherein the order of the pixel by pixel decoding is based on the output of the fifth trained neural network.

110. A method for lossy image and video encoding, transmission and decoding, the method comprising the steps of:
receiving an input image at a first computer system;
encoding the input image using a first trained neural network to produce a latent representation;
entropy encoding the latent representation;
transmitting the entropy encoded latent representation to a second computer system; entropy decoding the entropy encoded latent representation; and
decoding the latent representation using a second trained neural network to produce an output image, wherein the output image is an approximation of the input image;
wherein the first trained neural network and the second trained neural network have been trained according to the method of claim 97.

111. A method for lossy image or video encoding and transmission, the method comprising the steps of:
receiving an input image at a first computer system;
encoding the input image using a first trained neural network to produce a latent representation;
entropy encoding the latent representation; and
transmitting the entropy encoded latent representation;
wherein the first trained neural network has been trained according to the method of claim 97.

112. (canceled)

113. A data processing system configured to perform the method of claim 97.

114-177.
